(19) United States
(12) Patent Application Publication
(10) Pub. No.: US 2026/0311254 A1
(43) Pub. Date: Oct. 8, 2026

(54) Systems, Apparatus, and Methods for Maintaining Order Book Price Level Data Using Balanced Search Trees

(71) Applicant: Jake Jin Seok Yoon, Elmwood Park, NJ (US)

(72) Inventor: Jake Jin Seok Yoon, Elmwood Park, NJ (US)

(21) Appl. No.: 19/334,857

(22) Filed: Sep. 20, 2025

Related U.S. Application Data
(63) Continuation-in-part of application No. 19/260,613, filed on Jul. 7, 2025, now Pat. No. 12,541,795.
Application No. 19/260,613 is a continuation-in-part of application No. 19/080,927, filed on Mar. 16, 2025, now Pat. No. 12,462,304.

(51) Int. Cl. G06Q 40/04; G06F 16/22

(52) U.S. Cl. CPC G06Q 40/043; G06F 16/2246

(57) ABSTRACT

Apparatuses and methods maintain order-book price-level metadata in contiguous fixed-slot storage using an embedding/quotient-morphism balanced search tree (EQ-BST). Each price-level record stores at least price (or tick index) and aggregate quantity and maintains predecessor/successor neighbor links. New prices are inserted by splicing at the unique parent location determined from in-order neighbors; deletions graft the in-order successor (or predecessor), both realized as a bounded, constant number of single-word reference writes confined to a single ancestor path, followed by local rebalancing transforms. Best-bid/ask extrema references enable constant-time top-of-book access, and duplicate prices coalesce by updating an existing record. Embodiments include a software implementation and an order-book accelerator with multi-banked descriptor memory that stores no order objects, neighbor-aware insertion/deletion pipelines, tick-indexed comparators parameterized by base price and tick size, coherency/hazard handling, and a host interface for price-level updates and snapshots. Non-transitory media and configuration images implement the foregoing.

### CROSS-REFERENCE TO RELATED APPLICATIONS

This application is a continuation-in-part of U.S. Non-Provisional application Ser. No. 19/260,613, filed Jul. 7, 2025, which itself is a continuation-in-part of U.S. Non-Provisional application Ser. No. 19/080,927, filed Mar. 16, 2025. All subject matter of the parent applications is incorporated herein by reference in its entirety to the extent such subject matter is not inconsistent with the present disclosure.

### FIELD OF THE INVENTION

This invention relates to electronic trading systems and, more specifically, to a high-speed matching engine designed for processing large volumes of trade orders with ultra-low latency. The invention addresses the significant challenges of order congestion and unpredictable latency spikes caused by micro-bursts in modern financial markets.

### BACKGROUND OF THE INVENTION AND PRIOR ART

Modern electronic trading platforms rely on matching engines to rapidly pair buy and sell orders and execute trades. These systems must maintain predictable low latency to ensure fair market operations and mitigate financial risks associated with execution delays. However, traditional matching engines are often overwhelmed by micro-bursts—short, intense spikes in order flow generated by advanced high-frequency trading algorithms. Such bursts can temporarily exceed the processing capacity of conventional systems, leading to increased latency, wider bid-ask spreads, and reduced order book depth. Studies have shown that nearly 20% of transactions across major exchanges occur during these micro-bursts, adversely affecting market makers, liquidity providers, and overall market quality (see Aquilina, Matteo; Budish, Eric B.; and O'Neill, Peter, Quantifying the High-Frequency Trading “Arms Race”, July 2021). This problem has been further exacerbated by the advent of sophisticated artificial intelligence-based trading bots and the continued growth of computational resources.

Existing solutions—including intentional speed bumps, periodic batch auctions, randomized order processing delays, and delayed market data dissemination—have been introduced to mitigate the effects of micro-bursts. However, these measures have failed to resolve the underlying throughput limitations of current matching engines. For instance, in 2017, NYSE American implemented a 350-microsecond “speed bump” designed to allow market makers sufficient time to update their quotes before high-frequency trading bots could exploit stale quotes. The measure, however, resulted in wider spreads (+40%), lower trading volume (−8%), and reduced market share, ultimately prompting its removal in 2019.

The core matching process is designed to operate in a single-threaded mode for each symbol, ensuring strict enforcement of order time priority. While it is technically feasible to run multiple order books concurrently for the same symbol, merging different symbols into one order book is not advisable because each symbol represents a distinct asset. According to Amdahl's law, the portion of work that cannot be parallelized becomes the bottleneck, regardless of how many computational resources are available. Consequently, the overall throughput of the matching engine is ultimately limited by the latency of the core match process, since the core match throughput is essentially the inverse of its processing latency.

The discussion of background systems and publications is provided solely to place embodiments in context. No admission is made that any reference, system, or technique is prior art under any statute or that it forms part of the knowledge of persons of ordinary skill.

### SUMMARY OF THE PROBLEM

The core issue with prior art matching engine technologies is its inability to efficiently scale throughput during periods of extreme order flow. One of the world's largest exchanges—Eurex (Deutsche Börse group)—typically achieves a throughput of about 200,000 orders per second per symbol based on their July 2024 technical publication. During micro-bursts, however, the surge in order volume far exceeds this capacity, leading to severe latency spikes. This limitation forces market makers to adopt more defensive quoting strategies, since they are unable to quickly change the quote due to the overwhelmed matching engine and thus their orders being sniped by “faster” opportunistic high-frequency trading bots, which increases bid-ask spread and ultimately reduces revenue for exchanges.

### SUMMARY OF THE INVENTION

In general terms, the invention provides a high-speed matching-engine architecture that integrates several coordinated technical features which, in combination, overcome throughput and tail-latency limitations of conventional electronic trading systems under extreme order-flow micro-bursts. The features include, without limitation:
(a) slot-based Data Holder Nodes that store orders contiguously in fixed-capacity, cache-line-aligned arrays;
(b) bounded-direction relocation cascades (Push Back and Push Forward) that maintain dense node population while bounding worst-case insertion or prepend cost;
(c) a flexible, depth-aware node-capacity function that monotonically decreases with distance from the book head;
(d) bitmask abstractions that encode per-slot head/tail priority and permit branch-free, constant-time metadata updates;
(e) core-local, huge-page memory pools for Data Holder Nodes and Price Level Descriptors;
(f) lock-free, cache-aligned queues supporting zero-copy and copy-optimized SIMD block moves;
(g) neighbor-aware balanced-search-tree operations for price level indexing with constant-time splice/graft when in-order neighbors are known, followed by bounded rebalancing; and
(h) an optional order-book price-level accelerator (OBA) that realizes the price-level index in reconfigurable or application-specific logic using contiguous descriptor memory and neighbor-aware insertion/deletion pipelines that perform splice and successor-graft updates with a constant-bounded number of reference writes followed by single-path, local-transform rebalancing. The OBA maintains price-level metadata only (no order objects), exposes best-of-book registers for constant-time top-of-book reads, and provides a memory-mapped or message-based host interface; one accelerator instance services one symbol to preserve price-time priority, and multiple instances may operate in parallel.

Illustrative Performance (non-limiting)—In one measured deployment on a latest generation (2025) AWS bare-metal instance, a single-threaded core matching unit sustained throughput of up to 30 million order messages per second when tested by benchmark data based on SEC-reported market-activity distributions, including bursts exceeding 2 million consecutive messages without inter-message gaps. Latency remained deterministic and sub-microsecond during the harshest micro-burst events, and no specialized hardware was required. These figures are representative of one configuration and workload and are provided solely to illustrate the behavior of embodiments described herein; actual performance may vary with implementation choices and operating conditions.

In one aspect, the system comprises:
(a) a memory-management subsystem that allocates per-core memory pools on large contiguous pages and pre-constructs Data Holder Nodes and Price Level Descriptors;
(b) an order book structure in which each Data Holder Node provides fixed-capacity, contiguously addressable slots for up to a predetermined maximum number (C) of order objects, and maintains priority-tracking metadata comprising per-slot indicators corresponding to the contiguously addressable slots, an indicator at a slot signifying that the order stored in the corresponding slot is the highest-priority and/or lowest-priority order at its price level;
(c) one or more single-threaded core-match units that receive incoming orders, execute matches according to a selected policy (e.g., price-time), and update nodes, masks, and descriptors;
(d) bounded-direction Push Back/Push Forward cascades that relocate at most a fixed number of orders in one direction to free capacity while preserving priority; and
(e) in certain embodiments, the order-book price-level accelerator (OBA) operably coupled to the core-match unit via the lock-free queues, configured to maintain the balanced-search-tree representation of active price levels in descriptor memory and to provide constant-time access to best-bid and best-ask via dedicated extrema registers.

In another aspect, the transport layer employs lock-free, cache-aligned ring buffers (SPSC, SPMC, MPSC, or MPMC). The layer supports zero-copy placement (e.g., NIC-to-core DMA rings, shared-memory mailboxes, RDMA writes) and copy-optimized payload movement that transfers exactly one cache line per message via vector instructions (e.g., AVX/AVX-512, NEON/SVE), with optional non-temporal stores and NUMA-aware placement.

In a further aspect, a balanced search tree (e.g., red-black, AVL, B/B+-tree, or other embedding/quotient-morphism balanced structure) indexes price levels. Each Price Level Descriptor records the price, aggregate quantity, and a reference to the node holding the highest-priority and/or lowest-priority order at that level. When in-order predecessor and successor are known, insertion (splice) and deletion (successor graft) proceed in constant time at the identified parent slot, followed by a rebalancing walk bounded to a single root-to-leaf path. In hardware embodiments, the OBA implements this tree logic and fix-up sequencing directly over a contiguous, multi-banked descriptor memory, with predecessor/successor neighbor links and atomic single-word updates of child/parent references, as well as tick-indexed comparators parameterized by base price and tick size; a coherency module optionally arbitrates hazards when limited overlap is allowed. The OBA's observable behavior is functionally equivalent to the software procedures and produces isomorphic trees and top-of-book outcomes for the same event stream.

In certain embodiments, the node-capacity function is learned and adjusted online from live telemetry by a lightweight controller that periodically recomputes an optimal node size per depth (or per node), applies rate-limited updates between batches, and resizes node classes within the per-core pools without violating latency bounds; static policies may be substituted where desired.

The foregoing is a simplified overview intended to introduce representative features that are described in greater detail below. It is not intended to identify key or essential features of the claimed subject matter, nor to limit the scope of any claims.

### BRIEF DESCRIPTION OF DRAWINGS

The present invention is described in detail through non-limiting examples with reference to the accompanying drawings.

FIG. 1 is a schematic diagram illustrating a general overview of the core matching process.

FIG. 2 is a high-level diagram illustrating Data Holder Nodes, which store orders and Price Level Pointers (pointer-based embodiment), along with the relevant operations performed on them.

FIG. 3 is an illustration showing the alignment of Price Level Descriptors in a tree-like structure.

FIG. 4 is a high-level overview of the specially designed memory pool.

FIG. 5 is a schematic of a conventional computer-memory hierarchy (context diagram).

FIG. 6 is a flowchart outlining the matching process between an incoming order and existing orders in the order book.

FIG. 7 is a flowchart illustrating the process of inserting an incoming order into the order book.

FIG. 8 is a schematic diagram showing the object structure of the order book.

FIG. 9 is an illustration depicting the relationship between orders and Price Level Pointers (pointer-based embodiment) within a Data Holder Node.

FIG. 10 is an illustration of a procedural overview of order execution within a Data Holder Node.

FIG. 11 is an illustration of the Append operation within a Data Holder Node.

FIG. 12 is an illustration of the Prepend operation within a Data Holder Node.

FIG. 13 is an illustration of the Push Back operation within a Data Holder Node.

FIG. 14 is an illustration of the Push Forward operation within a Data Holder Node.

FIG. 15 is an illustration depicting the relationship between orders and bit-values in a bitmask within a Data Holder Node.

FIG. 16 is an illustration of a procedural overview of order execution with bitmask abstraction.

FIG. 17 is an illustration of the Append operation with bitmask abstraction.

FIG. 18 is an illustration of the Prepend operation with bitmask abstraction.

FIG. 19 is an illustration of the Push Back operation with bitmask abstraction.

FIG. 20 is an illustration of the Push Forward operation with bitmask abstraction.

FIG. 21 is an illustration of the accelerator top-level block diagram (descriptor memory, pipelines, fix-up sequencer, coherency, host interface).

FIG. 22 is an illustration of the Price Level Record layout.

FIG. 23 is an illustration of the insertion/deletion pipelines.

FIG. 24 is an illustration of the tick-comparator and configuration registers.

### BEST MODE FOR CARRYING OUT THE INVENTION

The present best mode for implementing this invention involves using a low-level language such as C or C++, which allows direct memory control. When used with a garbage-collected language, it is recommended to disable the garbage collector to prevent any interferences from the garbage collector. For optimal data movement, the hardware should support at least 128-bit SIMD instructions, with 256-bit or 512-bit instructions being ideal. A major source of processing latency arises from storing each incoming order's unique identifier in a hash map, so the choice of hash map should match the hardware architecture. A linear, closed-hashing approach is generally recommended.

### DETAILED DESCRIPTION

The continuation-in-part Ser. No. 19/260,613 expands or clarifies the following subject matter relative to U.S. application Ser. No. 19/080,927 (filed 16 Mar. 2025):
(a) additional implementation detail for the optional dual-lookup path that combines a balanced price level tree with an auxiliary hash map (the basic concept is disclosed in the parent application); and
(b) additional implementation detail for SIMD-based prefetch algorithms used for in-node realignment (the underlying approach is disclosed in the parent application); and
(c) an exemplary implementation on the Linux operating system, detailing the use of sched_setaffinity( ) to pin threads to specific CPU cores, set_mempolicy( ) to bind memory to a NUMA node, and mmap( ) to allocate tailored huge-page sizes for optimizing TLB coverage and minimizing cross-core lock contention.
   Except for the foregoing additions and editorial clarifications, the portions reproduced from the application Ser. No. 19/080,927 are repeated without substantive change.

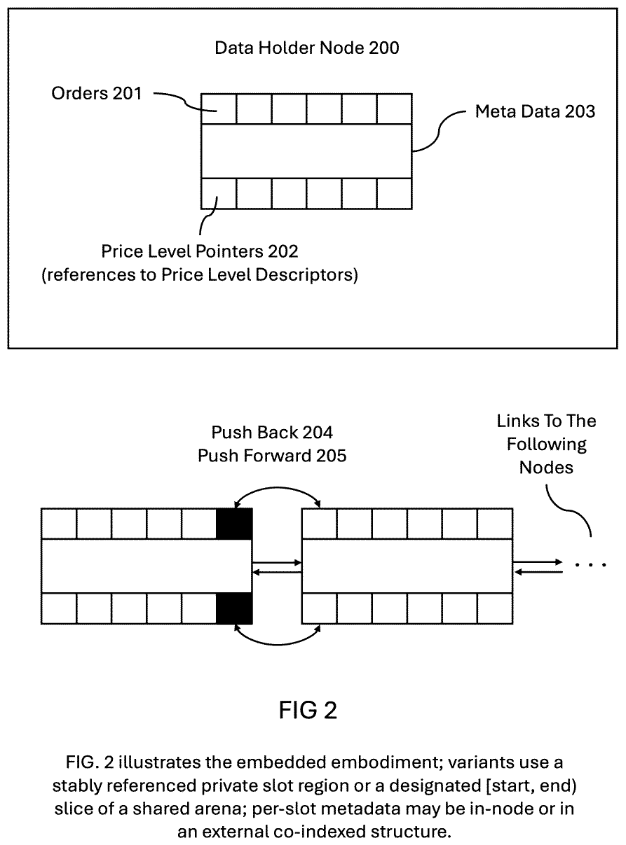

The present continuation-in-part expands or clarifies the following subject matter relative to U.S. application Ser. No. 19/260,613 (filed 7 Jul. 2025):
(a) Complete producer/consumer matrix—Consistent with the parent applications' disclosure of lock-free, cache-aligned queues that operate with single or multiple producers and consumers, this application consolidates and harmonizes the terminology by setting out explicit, uniform definitions and invariants for the canonical configurations SPSC, SPMC, MPSC, and MPMC, together with illustrative embodiments.
(b) Transport-layer modes—The queue transport is generalized and formalized into two modes:
   (i) zero-copy channels (e.g., direct NIC-to-core DMA ring, shared-memory mailbox localized to a socket's last-level cache, on-chip inter-core fabric, or RDMA write window); and
   (ii) copy-optimized channels that move messages with vector instructions (SIMD_COPY).
The parent disclosed lock-free, cache-aligned rings and a SIMD-based copy; the present application enumerates the zero-copy endpoints and codifies both modes as first-class options.
(c) Consolidated cache/NUMA guidance—Memory-placement guidance (cache-line-aligned payload slots, NUMA-aware placement, and optional non-temporal stores) is consolidated and applied across ingress and egress paths as transport-layer policy; the parent discussed these techniques within specific queue implementations.
(d) Generalized balanced-search-tree model—While the parent permitted “any balanced tree,” this application formalizes an embedding/quotient-morphism balanced search tree (EQ-BST) framework that explicitly covers both binary and multi-way (e.g., B/B+-tree) structures and, in the expected-case sense, randomized variants; it also specifies neighbor-aware splice (insertion) and successor-graft (deletion) with a constant-bounded number of reference writes followed by a single-path local rebalancing walk.
(e) Order-Book Accelerator (OBA)—A new hardware embodiment that maintains price-level metadata only (no order objects), with multi-banked contiguous descriptor memory, insertion/deletion pipelines, a fix-up micro-sequencer, tick-indexed comparators parameterized by base price and tick size, coherency/hazard handling, best-of-book registers and snapshot semantics, and a memory-mapped or message-based host interface. Corresponding apparatus/method/media claims and configuration-image claims are added, and hardware behavior is specified to be observationally equivalent to the software procedures.
(f) Contiguously addressable slots (terminology harmonization)—Building on the parent's contiguous, embedded order-slot layout, this application harmonizes and generalizes the definition of array of slots/slot table to encompass all of the following, while preserving the same base/stride invariants:
   (i) a physically embedded contiguous array within the node's region;
   (ii) a stably referenced private contiguous allocation whose base address and per-slot stride remain invariant during normal operation (e.g., a pinned-capacity vector); and
   (iii) a designated contiguous section [start, end) of a shared slot arena maintained for multiple nodes.
In each case, the slot region defines a single logical index space for order objects with a predetermined maximum slot capacity C; the runtime size may vary within that bound (0≤size≤C) without relocation. Contiguously addressable means that consecutive slot indices map to fixed-offset locations (e.g., base+i-stride), including across adjacent sub-arrays or, in the shared-arena case, relative to the node's own [start, end) section (with optional ring semantics). This terminology update applies to the order-slot region; Price Level Descriptor objects remain externally allocated and referenced (genus: “reference”) as described elsewhere. See [0049], [0051] and the FIG. 2 caption; alignment/SIMD transport considerations are reflected in [0054].
   Except for the foregoing additions and editorial clarifications, the portions reproduced from the application Ser. No. 19/260,613 are repeated without substantive change.

The disclosed embodiments relate to a method for constructing a high-speed matching engine by integrating the unique techniques described herein, resulting in one of the fastest known core matching engine architectures to date.

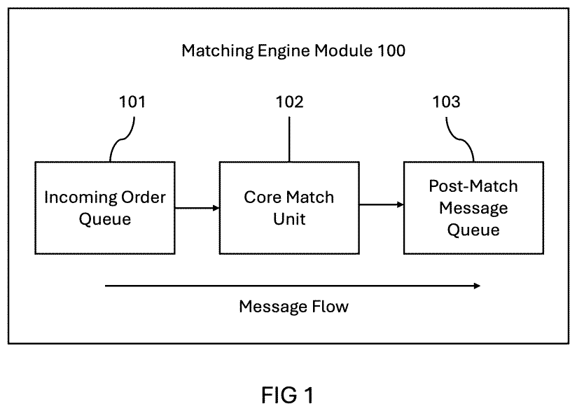

As used herein, a “matching engine” refers to the matching-engine module 100 illustrated in FIG. 1. The module consists of an incoming-order queue 101, a core match unit 102, and a post-processing message queue 103 arranged sequentially so that messages flow from the order queue, through the core match unit, to the message queue.

Terminology—“reference.” For clarity, throughout this specification and the claims, the term “reference” is used in a genus sense and expressly includes a pointer; a pointer is one non-limiting species of a “reference.” Non-limiting examples of a “reference” include a handle, index, offset, identifier, tuple (e.g., {node-id, slot-id}), or any other datum sufficient to locate or retrieve the addressed object. As used herein, a Price Level Pointer is a reference to the Price Level Descriptor for a level.

The three modules introduced above—the inbound order queue 101, the core match unit 102, and the post-processing message queue 103—may be interconnected by any lock-free data-transport topology suitable for deployment constraints. Exemplary queue categories include SPSC, SPMC, MPSC, and MPMC as defined below. For exposition, a “ticket” denotes a conceptual, monotonically increasing identifier associated with each enqueue; implementations may realize tickets via index counters, per-cell sequence fields, or other mechanisms.
(a) Single Producer, Single Consumer (SPSC);
As used herein, an SPSC queue is a bounded queue of capacity C with exactly one producer thread and one consumer thread, that is lock-free (arbitrary delay of either thread does not prevent the other from making progress) and satisfies:
   (i) a payload becomes readable only after the producer publishes it via a store that establishes visibility to the consumer (e.g., release→acquire);
   (ii) a slot is eligible for reuse only after the consumer publishes its release; and
   (iii) operations appear in FIFO order with respect to enqueued items.
This definition does not require a particular publication scheme and encompasses head/tail index schemes, per-cell sequence schemes, or other logic that satisfies these invariants.
(b) Single Producer, Multi Consumer (SPMC);
An SPMC queue has exactly one producer and one or more consumers; it is bounded and lock-free in that arbitrary delay of any single consumer does not prevent the producer or at least one other consumer from making progress. It satisfies:
   (i) publish/observe and reuse invariants as above;
   (ii) at-most-once consumption—each enqueued item is consumed by no more than one consumer; and
   (iii) a total order consistent with enqueue tickets for the logical queue.
This definition encompasses per-cell sequence gating with atomic consumer claims, sharded SPSC rings (one per consumer) with deterministic dispatch together with a global ticket source or merge policy that preserves the logical order, or other logic satisfying these invariants.
(c) Multi Producer, Single Consumer (MPSC);
An MPSC queue has two or more producers and exactly one consumer; it is bounded and lock-free in that arbitrary delay of any single producer does not prevent the consumer or other producers from making progress. It satisfies:
   (i) publish/observe and reuse invariants as above;
   (ii) unique-slot acquisition for enqueues (no two producers publish to the same slot for the same ticket); and
   (iii) FIFO order as observed by the single consumer.
This definition encompasses per-cell sequence schemes with a shared atomic enqueue ticket (e.g., fetch_add on a tail counter), per-producer SPSC rings combined by a fair combiner, or other logic satisfying these invariants.
(d) Multi Producer, Multi Consumer (MPMC).
An MPMC queue has two or more producers and two or more consumers; it is bounded and lock-free such that arbitrary delay of any single thread does not prevent system-wide progress. It satisfies:
   (i) publish/observe and reuse invariants as above;
   (ii) unique-slot acquisition for enqueues and at-most-once consumption for dequeues; and
   (iii) a total order consistent with enqueue tickets for the logical queue.
This definition encompasses per-cell sequence schemes with atomic enqueue/dequeue tickets, or sharded MPSC/SPMC fabrics with deterministic hashing plus a global ticket source or merge policy that preserves the logical order, or other logic satisfying these invariants.
(e) Non-limiting note.
The foregoing are genus-level definitions aimed at external semantics. Specific algorithms are exemplary only; unless expressly stated, these terms do not exclude other implementations that satisfy the stated invariants.

In addition, the transport layer may be implemented using either (a) zero-copy channels or (b) copy-optimized channels, selected according to deployment constraints. Non-limiting examples of zero-copy channels include: (i) direct NIC-to-core DMA ring buffers; (ii) shared-memory mailboxes localized to a socket's last-level cache within a NUMA node; (iii) on-chip message-passing fabrics; and (iv) RDMA write queues. In a copy-optimized configuration, each payload is moved with cache-aligned, vector-instruction copy operations (e.g., AVX, NEON, or other SIMD-based block moves), as illustrated by SIMD_COPY in [0054]. In all cases, the transport preserves lock-free queue semantics (see [0046]) and is configured to reduce cache invalidation traffic and thrashing. Regardless of the chosen combination, the system routes each incoming order to its designated core match unit 102 and returns acknowledgments and trade confirmations to queue 103, using cache-line-aligned slots, NUMA-aware memory placement, and, where applicable, non-temporal stores to reduce latency and contention.

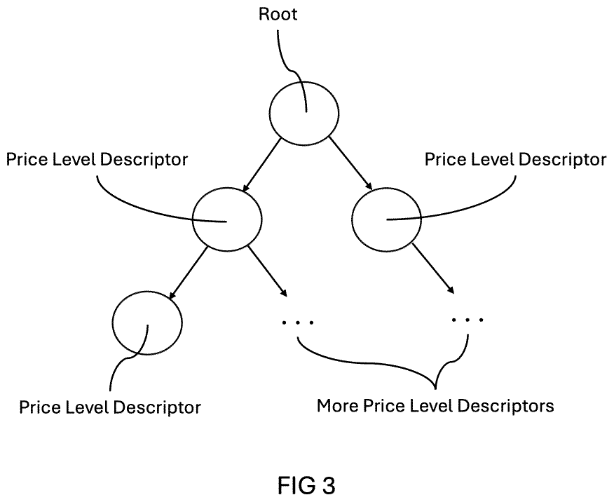

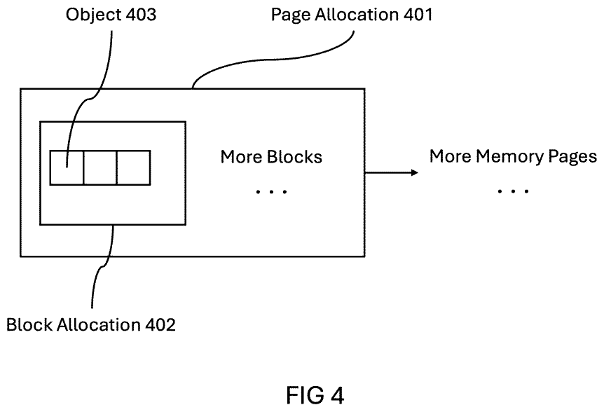

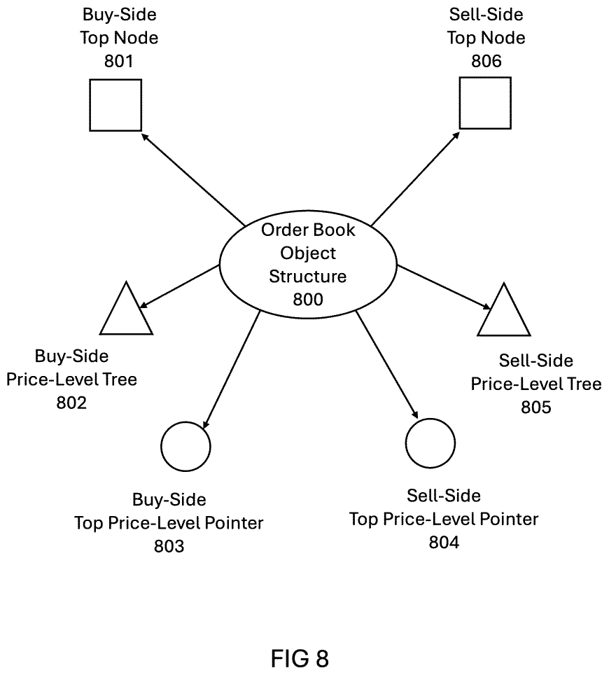

Before describing the matching process in detail, it is necessary to explain the underlying data structure of the order book 800 (see FIG. 8), including the Data Holder Node 200 (see FIG. 2), the Price Level Descriptor (see FIG. 3), and the memory pool (see FIG. 4).

Terminology—“Array of slots/slot table.” As used herein, array of slots (or slot table) denotes:
(a) a single contiguous array;
(b) two or more back-to-back sub-arrays; or
(c) a designated contiguous section of a shared slot arena.
   In all cases, the array(s) or designated section are either physically embedded in the Data-Holder Node's contiguous region or stably referenced by the node (see [0045]) to an equivalently contiguous slot region whose effective base address (or base offset into the arena) and per-slot stride remain invariant during normal operation. The arrays (or designated section) collectively define one logical index space with a predetermined maximum slot capacity C (i.e., the fixed cardinality of the node's slot index space) for the node's order objects. A variable-sized realization whose runtime size satisfies O≤size≤C also qualifies as an “array of slots,” provided that growth within C does not relocate or reallocate the underlying storage. Contiguously addressable means that consecutive slot indices map to fixed-offset locations (e.g., base+i·stride), even when the next index lands in the first element of a subsequent sub-array or when, in the shared-arena case, the index wraps from the section's end back to its start (ring semantics) or advances to the first element of the next designated section. Non-limiting C++ examples include:
an std::vector<T> whose capacity C is established for the node (e.g., via reserve (C) or an allocator policy that prohibits relocation) and whose size grows and shrinks within C—without reallocation that changes the base—qualifies as an array of slots; increasing size up to C (e.g., push_back, resize (n) with n≤C) is permitted, whereas any operation that increases capacity beyond C or would relocate the storage is outside this example.
a single monolithic std::vector<T> (shared arena) that is not reallocated after initialization, where each node stores start and end indices delimiting its designated contiguous section; for that node, C=(end-start) and all indexing and ring behavior occur relative to that section; operations that grow the node's size within C are permitted so long as the arena itself is not reallocated.

Referring to FIG. 2, the Data Holder Node 200 comprises three principal regions:
(a) an order-slot storage region that is either embedded in the node's contiguous region (FIG. 2, element 201) or stably referenced by the node to an equivalently contiguous region with invariant base and per-slot stride during normal operation;
(b) either an area containing Price Level Pointers 202 (the area only exists for the pointer-based embodiments as a structure to implement the per-slot priority tracking) inside the node or a per-node, co-indexed structure external to the node that holds the same per-slot information;
(c) a metadata section 203 (which may represent either in-node or external per-slot metadata, as described in [0063]).
   The metadata typically includes fast-lookup information, such as the current count of orders within the node. In this exemplary embodiment, nodes are doubly linked for ease of traversal; however, a singly linked arrangement could be employed if desired, at the cost of greater implementation complexity. A defining advantage of the Data Holder Node 200 over conventional, linked-list-based approaches is its use of a fixed-capacity block of memory that can hold orders with differing prices in contiguous storage. Traditional designs typically store an unbounded list of orders at a single price level, necessitating pointer dereferences for each insertion, deletion, or lookup. By contrast, the contiguous memory layout in the Data Holder Node 200 provides direct indexing of orders without per-order pointer dereferences, thereby significantly reducing latency and improving cache efficiency.

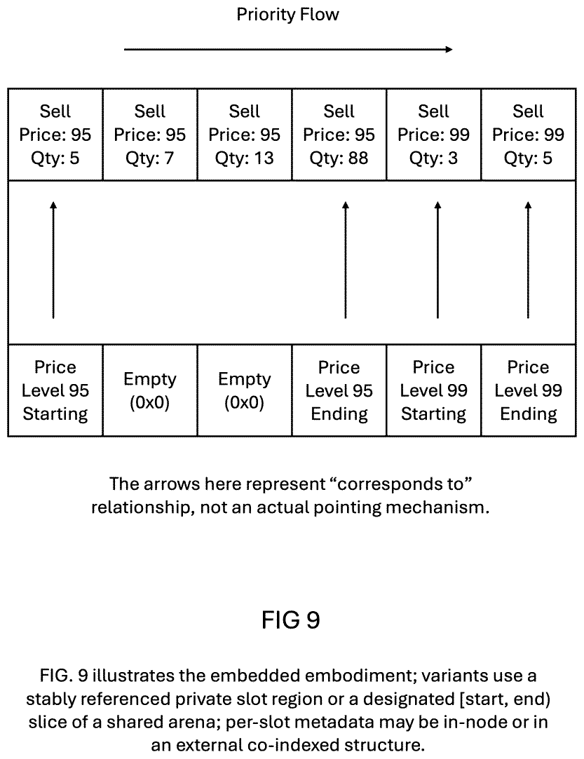

Exemplary Pointer-based, Embedded-storage Embodiment—Continuing with the Data Holder Node, in embedded-storage embodiments, the orders 201 are stored as objects directly within the node's contiguous section rather than as pointers to externally allocated objects. In alternative embodiments consistent with [0049], the node holds a stable reference to an equivalently contiguous slot region—either:
(a) a private allocation (e.g., the underlying storage of an std::vector<T> with predetermined maximum capacity C and no reallocation during normal operation); or
(b) a designated contiguous section [start, end) of a shared slot arena maintained for multiple nodes.
   In either case, the node's indexing and any ring semantics are taken relative to its own slot region and preserve invariant base/stride during normal operation. By contrast, the Price Level Pointers (element 202, in a pointer-based embodiment) are stored as references (genus term defined at [0045] that includes pointers) to externally allocated Price Level Descriptor objects, typically implemented as pointers to those objects. The node itself does not embed the actual Price Level Descriptor objects, which are allocated and maintained separately—often in a dedicated memory pool. This design choice reduces memory overhead within the Data Holder Node and preserves stable references to the Price Level Descriptors, a critical requirement for building the tree structure described in [0068]. In this exemplary embodiment, each price level uses two pointers—one for the highest-priority order (start) and one for the lowest-priority order (end), as shown in FIG. 9. An alternative configuration maintains only an end pointer, reducing complexity but limiting certain functionalities (e.g., O(1) jump to the head of the queue). Consistent with the generalized metadata model in [0063], the per-slot priority-tracking metadata (pointer arrays or their bitmask equivalents) may reside inside the node or in an external, per-node co-indexed structure addressed by the same logical slot indices as the node's contiguously addressable slots; when externalized, the “metadata 203” label denotes the node-local administrative fields (e.g., version, count, or references to the externally-located per-slot priority-tracking metadata). (See FIG. 2 caption; [0049], [0063].)

Because a single order can represent both the highest and lowest priority if it is the only order at its price level, each order may occupy two pointer slots in the Price Level Pointer holder 202 of the pointer-based embodiment. Thus, when both highest- and lowest-priority pointers are employed, the number of pointer slots can be twice the number of order slots 201. Conversely, if only the lowest-priority pointer is used, the pointer slots match the number of order slots. Note that the Price Level Pointer holder (element 202) only exists for pointer-based embodiments, as other embodiments may use different per-slot tracking methodology (e.g., bitmask).

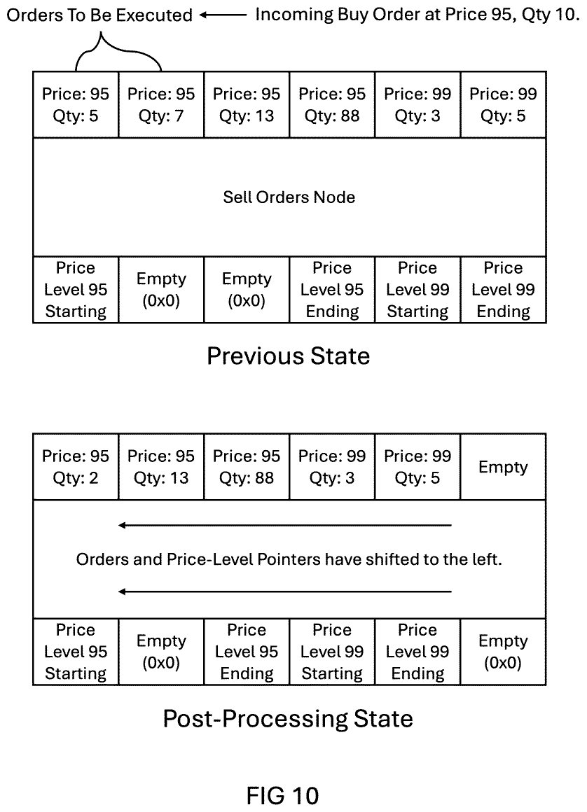

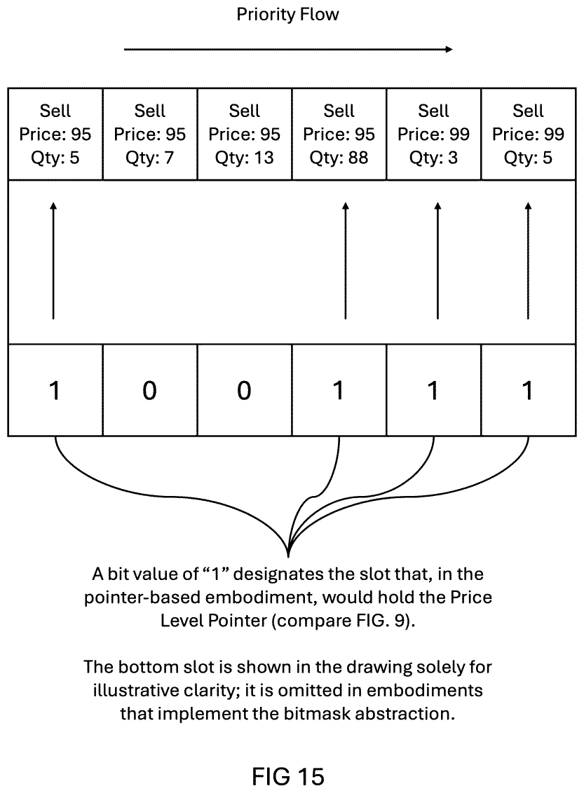

In the exemplary pointer-based embodiments, when multiple orders occupy the same price level, the container that stores the Price-Level Pointers can have unused slots between the highest-priority and lowest-priority orders (see FIG. 9). Each pointer occupies a fixed slot position in the node's logical slot index space; implementations may place the pointer array inside the Data Holder Node or in an external co-indexed array addressed by the same slot indices as the node's contiguously addressable slots (see [0049], [0051]). Whenever an execution, insertion, or cancellation changes the order sequence, the per-slot metadata is updated to ensure coherency. In pointer-array variants, the update is performed by moving or rewriting pointers in the internal array or in the external co-indexed array; in bitmask variants, by shifting and/or toggling flag bits (see [0063] and FIGS. 15-18). The mapping from the node's logical slot indices to metadata positions remains one-to-one throughout (see FIG. 10). For example, if the current highest-priority order is removed, the pointer in the “highest” slot now references the next-highest order, while the “lowest” pointer is updated if a new order is appended at the back.

To move bulk data efficiently, the system invokes a platform-optimized routine referred to herein as SIMD_COPY. All memory regions handled by this routine—including the contiguous order-slot regions referenced by each Data Holder Node and the ring-buffer elements used by the incoming-order and post-processing message queues—are aligned to the machine's cache-line size (typically 64 bytes). This alignment enables each cache line to be copied with a small, fixed number of vector instructions per line (e.g., one vector load and one vector store). In a non-limiting x86 implementation: when the processor supports AVX-512, SIMD_COPY issues 512-bit loads and stores (moving 64 bytes per vector operation); if AVX-512 is unavailable, it falls back to AVX2 (256-bit), then SSE2/SSE (128-bit), and ultimately to a standard memory-copy path when wider SIMD is not available. Optionally, for large forward-only transfers, SIMD_COPY may use non-temporal (streaming) stores to reduce cache pollution; otherwise it employs temporal stores to preserve locality. By treating each movable object as trivially copyable and operating on cache-line-sized chunks (or integral multiples thereof)—and by assuming non-overlapping regions or using memmove-style semantics when overlap is possible—the routine accelerates both intra-node order realignment and inter-thread message transport while remaining portable across architectures. (On non-x86 targets, the routine uses the widest available vector width, e.g., NEON/SVE on ARM or VSX on POWER.)

In addition to moving bulk data, the system also shifts pointer values—often 8 bytes each—between nodes or within the same node. Because these pointer updates are comparatively small (normally, one 64-bit word), they remain very fast even if SIMD instructions are not used. In particular, aligning these pointer slots to at least 8-byte boundaries ensures minimal overhead during pointer swaps or adjustments. This is critical when reassigning Price Level Pointers, updating doubly linked lists, or performing other pointer-based operations (e.g., re-linking nodes after an order is canceled or executed). By carefully managing both large data moves with SIMD and pointer realignments, the system maintains high throughput while minimizing latency throughout the matching process.

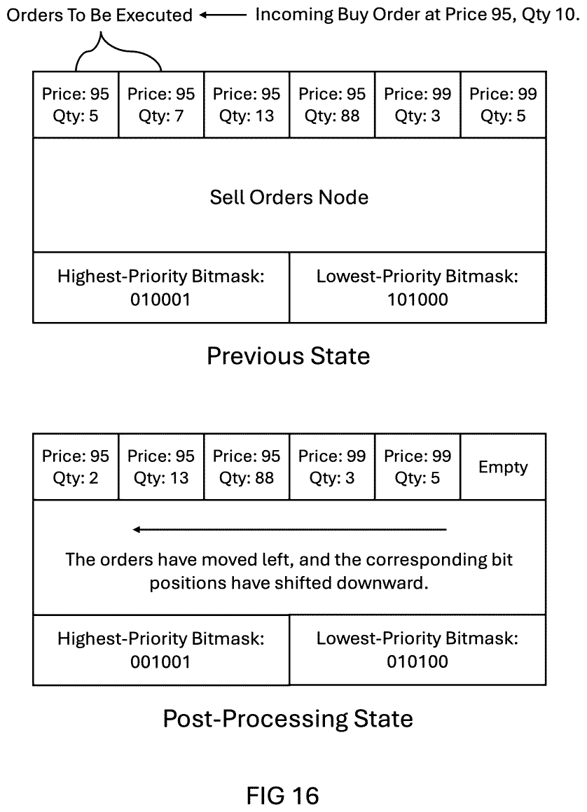

As part of the cache-warming strategy, the system performs a storage-realignment routine that compacts orders within the node's order-slot region—embedded or stably referenced per [0049]—to open contiguous free space for upcoming inserts. The routine validates the target insert offset and the current order count, then selects a movement strategy based on the shift distance and the hardware's cache-line geometry. It prefetches cache-aligned lines for both the order slots and the co-indexed per-slot metadata (e.g., Price Level Pointer slots or bitmask words), whether those metadata reside inside the node or in an external array addressed by the same slot indices, and moves data in vector-width blocks via the SIMD_COPY path with scalar fallbacks as needed (see [0054], [0057]). When regions overlap, moves use memmove-style semantics to preserve correctness ([0054]). The routine updates the associated metadata in place—preserving the one-to-one mapping between the node's logical slot indices and metadata positions ([0053])—so that subsequent Append and Prepend operations ([0059]—[0062]) typically proceed without further realignment on the hot path. (FIG. 10 illustrates the pointer-based variant; FIGS. 16-20 illustrate the bitmask variant.)

Depending on the ratio of cache line size to order size, the function selects different code paths using compile-time conditions (e.g., C++'s constexpr if). It aligns prefetching to cache line boundaries and shifts orders in blocks via SIMD-based operations. Prefetching is executed in write mode and directed to the L1 cache to ensure immediate data availability and maximize performance.

After shifting the order data, the function updates the per-slot metadata so that each slot's metadata entry continues to correspond to the order now occupying that slot. In pointer-array embodiments, this is realized as a safe memory-move of the co-indexed segment (e.g., memmove in C++). When the per-slot metadata is externalized (per-node array or a designated region of a shared metadata arena with invariant base/stride), the same move is applied to that external region; if the region uses ring semantics, the move is executed as two bounded segments that straddle the [start, end) boundary. In bitmask embodiments, the update is performed by word operations that shift and/or toggle the affected mask bits rather than relocating storage (see [0097]-[0105] and FIGS. 15-20). An internal consistency check (e.g., a debug-only assertion) then verifies the slot-metadata bijection and invariants (occupancy superset and head/tail uniqueness), and—for pointer-based variants only—that each pointer still resolves to the Price-Level Descriptor at the expected price. Together with the prefetch/realignment in [0056]-[0057], this routine maintains metadata coherency while minimizing cache misses.

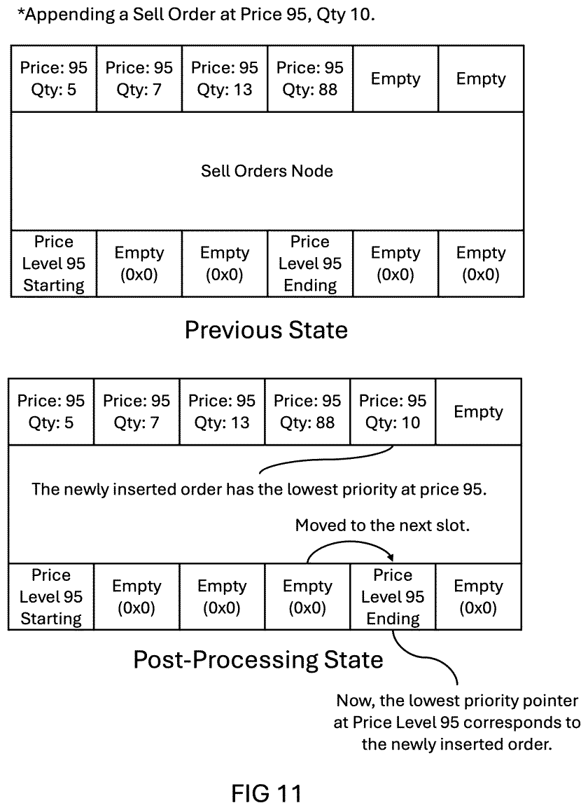

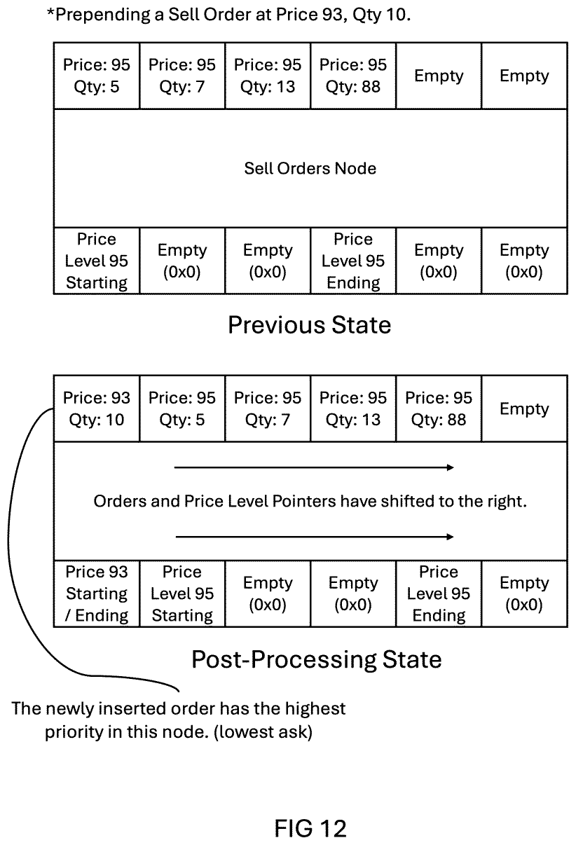

The Data Holder Node supports two primary operations: Append and Prepend. Append adds an incoming order at the ending Price Level Pointer (see FIG. 11), effectively placing the new order at the end of the existing priority chain for that price level. In doing so, the ending pointer shifts its corresponding relationship to the newly appended order. In this exemplary embodiment, appending at the starting pointer location is disallowed to avoid potential errors, though an exchange may opt to enable it if needed. By contrast, Prepend places an incoming order in front of the starting Price Level Pointer, shifting that pointer to the newly prepended order and modifying the overall priority chain (see FIG. 12). This approach is particularly relevant when the order's priority exceeds that of the current top-level order—such as a newly arrived lowest ask at Sell Orders Node, or if a “jump to the front” mechanism is required to override priority.

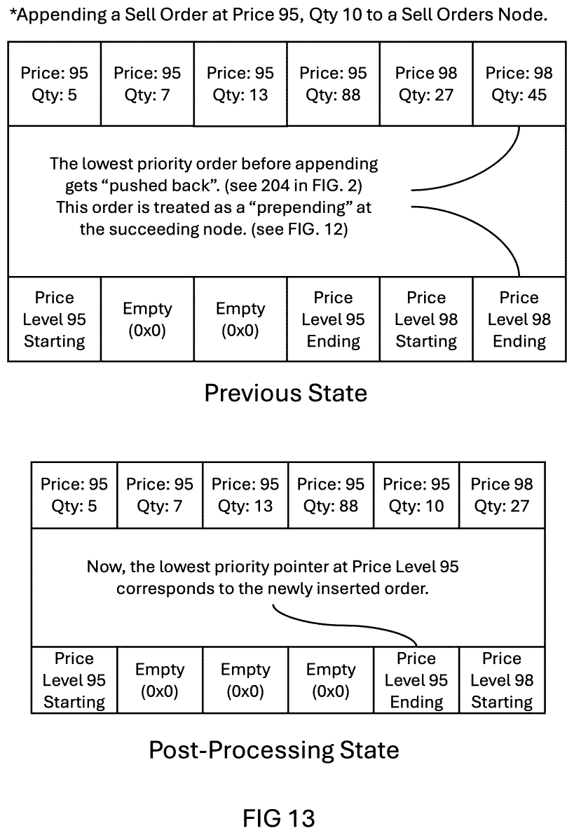

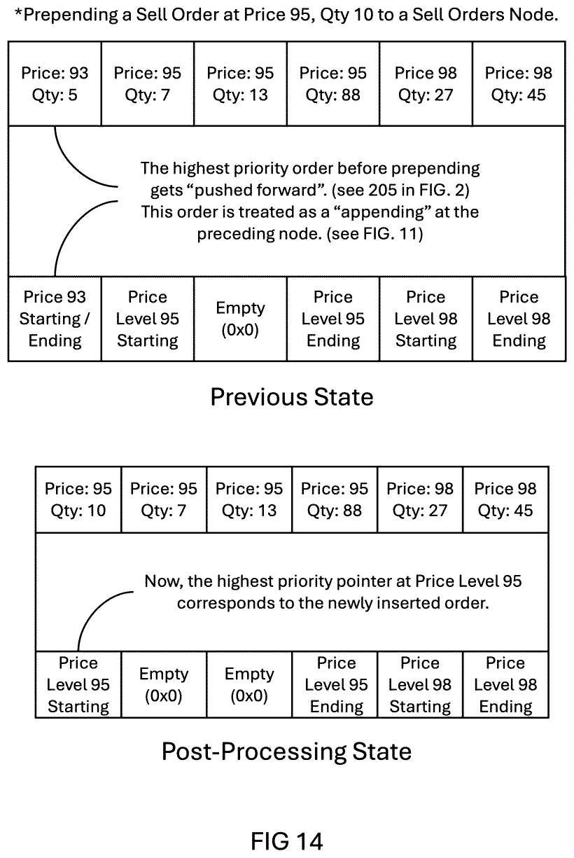

In addition to Append and Prepend, the Data Holder Node offers two derivative mechanisms—Push Back (204) and Push Forward (205)—to maintain an orderly state across multiple nodes (see FIG. 2, FIG. 13, and FIG. 14). For example, if the system tries to append an order to a node that is already full, an existing order—along with its Price Level Pointer (or a null pointer if none is assigned)—may be pushed back to the next node (see FIG. 13). The system decides which order to move by comparing the priority of the node's last order with that of the incoming order. Once pushed back, the displaced order is treated as a newly prepended order in the succeeding node, and the system processes it accordingly.

If the succeeding node is also at capacity, the Push Back operation may cascade further as the least-priority order in that node and its corresponding Price Level Pointer (if any) will in turn be pushed back to the next succeeding node. If a Push Back occurs and no succeeding node exists, a new Data Holder Node is assigned from the memory pool to accommodate the pushed-back order and its corresponding Price Level Pointer. In practice, a reasonably small cascade limit maintains predictable latency; the optimal threshold, however, is chosen empirically for a given system's cache size and memory bandwidth. Increasing the limit tends to keep nodes densely populated, thereby improving cache locality, but it also adds processing overhead to each insertion. Accordingly, both node capacity and cascade depth are tunable parameters that an implementer can adjust to balance throughput and latency on the target architecture.

Push Forward is the symmetrical operation invoked when Prepend occurs on a full node (FIG. 14). The system decides which order to move by comparing the priority of the node's first-slot order (slot 0) with that of the incoming order. Then, the algorithm relocates the chosen order—and its associated Price Level Pointer (if any)—to the preceding node, where it is treated as a newly appended order in that node. If the preceding node is also full, the cascade continues toward the head of the order book, assigning a new Data Holder Node from the memory pool when necessary. Limiting the cascade depth to a modest, empirically determined value helps preserve deterministic performance across different hardware configurations.

Per-node/Per-slot Metadata (generalized)—As used herein, “metadata” denotes the bounded set of fields that summarize a node's state. Updates associated with any single insert, delete, or relocation are constant-bounded—i.e., they touch only a bounded number of machine words/steps, independent of the total number of resting orders in the book. Consistent with [0049], a node's slot region may be (i) physically embedded in the node, (ii) a private, stably referenced contiguous allocation with invariant base/stride, or (iii) a designated contiguous section [start, end) of a shared slot arena (optionally with ring semantics).

Per-slot metadata need not reside inside the Data Holder Node. It may be placed anywhere addressable via a reference (genus at [0045])—either inside the node or in an external, co-indexed structure (i.e., addressed by the same slot indices as the node's contiguously addressable slots)—provided there is a stable one-to-one mapping from the node's logical slot indices to metadata positions for the slots designated to that node. The external realization may be per-node (e.g., a private array) or a designated [start, end) region of a shared metadata arena whose indexing preserves invariant base/stride (or an equivalent fixed index mapping). When externalized, the node stores a stable reference/handle to its per-slot metadata, analogous to how [0049]/[0051] allow stable references to contiguously addressable slot regions.
Metadata may include, without limitation:
(a) one or more arrays of Price Level Pointers (e.g., head/tail or highest/lowest-priority per level) or bitmask encodings thereof (see [0088]-[0096]);
(b) status descriptors (e.g., occupancy/priority flags, counters, or small indexes); and
(c) optional administrative fields (e.g., version, count).
   Implementations may choose any representation and word size; the requirement is only that the per-operation update of such metadata remains constant-bounded as defined above.

Directed, Bounded Cascades—When an Append or Prepend would exceed a node's capacity, the system executes a one-directional relocation cascade to free a slot. A Push-Forward cascade proceeds only toward the head of the book; a Push-Back cascade proceeds only toward the tail. The direction is chosen by the operation and never reverses during the cascade. Let Dₘₐₓ∈[0, ∞) be a fixed configuration constant; at most Dₘₐₓ adjacent nodes are visited. Each hop relocates a single order into the next node in that direction and updates the affected node's metadata (e.g., the node's array of Price Level Pointers, status descriptor bitmasks, or others) in constant-bounded time. Cascade ordering is deterministic within a symbol; no interleaving reorders price-time priority.

Default at the hop limit—If no free slot is found within Dₘₐₓ hops, the default behavior is to add a new node in the order book chain at the cascade boundary in the same direction (at the head for Push-Forward; at the tail for Push-Back) and place the relocating order there. This converts a limit-reached condition into successful completion without reversing direction. Linking the node adjusts predecessor/successor pointers and per-node metadata in constant time and then commits the mutation log. Note: Appendix B ([0152]) establishes that cascades terminate even without a hop cap; Dₘₐₓ is used to bound worst-case latency, not to ensure termination.

Node pool and huge-page growth (default)—In one embodiment, new nodes are first drawn from a per-core node pool. When the pool is empty, the default behavior is to allocate a huge-page-backed block (non-limiting: 2 MB or 1 GB) and populate it with pre-constructed nodes, then replenish the pool and continue the operation. Allocation can be performed without blocking the matching core's critical section if the memory allocator uses a different core than the matching engine's core. If the OS cannot supply memory, the system treats the event as capacity exhaustion and applies the deployment policy (e.g., slow-path enqueue or fail-closed with a retry status).

Invariants and bounds—Throughout success, pool growth, or rollback, the following hold: a node's order counts never exceed its capacity; predecessor/successor links and metadata remain consistent after each committed hop; price-time priority within a node is preserved; and cascades are non-reentrant per price level. Because direction is monotonic and Dₘₐₓ is constant, the worst-case cascade cost is deterministic and bounded.

A Price Level Descriptor includes a metadata section containing the price level itself, the total quantity at that level, and one or more pointers to the Data Holder Node that currently holds either the highest-priority or lowest-priority order of its price level (depending on the pointer's role). Additionally, the Price Level Descriptor is organized as a tree structure (see FIG. 3) to achieve O(log n) lookups when searching for the nearest available price. While this exemplary embodiment uses a red-black tree implementation, any balanced tree, whether binary tree (e.g., AVL tree) or not (e.g., B+ tree), is viable, provided it supports O(log n) searching for the closest price. It should be noted that AVL trees often require more frequent rebalancing, which can introduce additional overhead compared to red-black trees. Therefore, the choice of tree structure depends on the exchange's performance requirements and tolerance for rebalancing costs. The trees are constructed on each side of the order book (Buy and Sell) and their roots 802 and 805 are encapsulated in the Order Book object structure 800. (see FIG. 8) As part of its cache warming strategy, this exemplary embodiment preloads the tree's traversal path into the L3 cache, enabling efficient read access for subsequent lookups.

As illustrated in FIG. 4, the invention introduces a memory pool that allocates memory in large contiguous pages—typically 2 MB, but configurable to 1 GB or any hardware-supported huge page sizes, whenever the host operating system and processor support those huge pages. These pages are obtained according to the system's huge-page configuration, ensuring optimal memory management and performance. Within each allocated page, the memory is subdivided into fixed-size blocks (402) that store multiple objects of a predetermined type.

Each block is designed to hold a specific number of objects, and its structure is optimized to minimize memory fragmentation and maximize cache locality. The custom block allocator is responsible for mapping and unmapping these large pages. When a block becomes fully occupied, it is removed from the free list; conversely, if a block becomes entirely empty, its parent page is unmapped and returned to the operating system.

One of the key differentiators of this memory pool is that the objects are preconstructed within each block at the time of block allocation. Rather than constructing a new object on each assignment request, the pool simply returns a pointer to an already constructed object within the pre-allocated block. This eliminates the runtime overhead of object construction, thereby speeding up the allocation process significantly—a crucial advantage in environments where every nanosecond counts.

Within each block of this exemplary embodiment, free slots are tracked using an array that is directly allocated as part of the block's memory, avoiding an extra heap object for the tracker. This choice concerns the pool's free-slot bookkeeping only and does not constrain the Data Holder Node's order-slot implementation (e.g., an std::vector with reserved capacity C as described in § [0049]). When an object is released, its slot index is returned to this array, ensuring that free slots are efficiently managed and immediately available for reuse. This method of in-block free slot management helps maintain a high level of cache efficiency, as all relevant data remains in a contiguous memory region.

By basing page allocations on the system's huge page configuration—2 MB, 1 GB, or any hardware-supported huge page sizes—the memory pool is highly adaptable to various hardware environments. Large page allocations reduce the frequency of TLB misses and improve memory bandwidth, which is essential for the performance of data-intensive applications like matching engines. The combination of preconstructed objects, efficient block-level management, and in-block free-slot tracking creates a scalable, low-latency memory management system that sets this invention apart from conventional memory allocators.

In one embodiment, each memory pool object is core-specific, rather than shared among multiple processor cores. This design choice avoids the overhead of implementing thread-safe concurrency within the memory pool itself, thereby reducing latency for high-throughput operations. However, it may result in higher overall memory usage if certain cores process fewer orders than others-some pools may remain underutilized while others are at capacity. To address this imbalance, each pool can request a page size tailored to its core's anticipated order volume: for example, 1 GB or larger huge pages (e.g., 2 GB) for the busiest cores, 2 MB pages for typical traffic, or the standard 4 KB page size when order flow is light. Most modern operating systems support multiple huge-page sizes concurrently, so per-core page sizing lets the exchange minimize waste while preserving the latency benefits of core-local, lock-free memory pools. In an exemplary Linux implementation, the engine pins each core-match thread to its dedicated CPU with sched_setaffinity( ), binds the thread's memory policy to the corresponding NUMA node via set_mempolicy( ), and calls mmap( ) with the appropriate flags. Because the kernel maintains separate pools for every huge-page size, a heavily loaded core can request 1 GB or larger pages while a lightly loaded core maps only 2 MB or 4 KB pages, thereby tailoring TLB coverage to real-time demand without sacrificing core-locality or incurring cross-core locks. Exemplary out-of-memory policy may include the following sequence: upon exhaustion of huge-page arenas, or in configurations where policy prohibits allocation of 1 GB pages, the allocator attempts allocation with 2 MB pages, followed by 4 KB pages; if all such attempts fail, the engine generates a failure-closed status. Blocks may utilize last-in, first-out (LIFO) free-lists to preserve cache locality, and whole-page reclamation may be governed by a hysteresis threshold configured to reduce or prevent reclamation-induced page churn.

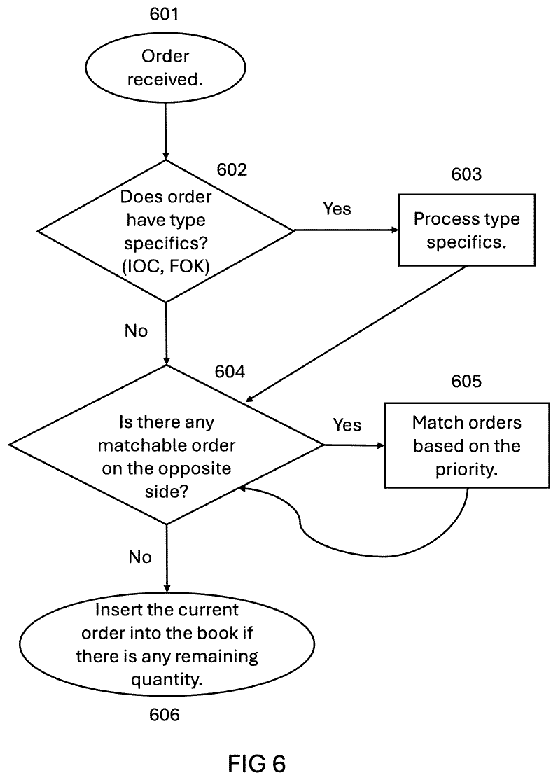

The following section describes the algorithms employed by the core match unit 102. Referring to FIG. 6, the processing logic flow for the core matching process is illustrated. When an order arrives (601), the system immediately sends an order acknowledgment to the post-processing message queue 103. Next, it processes any special-order designations associated with the incoming order (602). Examples of such designations (603) include Immediate-Or-Cancel (IOC) and Fill-Or-Kill (FOK), as defined by the exchange's rulebook and supported order types. The system then checks for any matchable order on the opposite side (604). In this exemplary embodiment, the presence of a matchable order is confirmed by determining whether the top priority Price Level Pointer on the opposite side is active. Because the order book structure 800 maintains the references to the highest-priority (lowest ask and highest bid) Price Level Descriptors for both sides (803 and 804), the relevant pointer address is often stored in the processor's register, making the lookup operation extremely fast. Although the system could also inspect the top nodes (801, 806), it is preferable to avoid reading the underlying memory content to reduce latency. Instead, checking only whether the pointer address is null suffices to confirm availability.

Once a matchable order is identified, the system enters an iterative process to execute orders based on a selected priority policy (605). Supported priority policies may include, without limitation, first-in first-out (FIFO), pro-rata, size-time, and parity-based approaches, and the policy-specific logic may be encapsulated within a strategy object or equivalent policy hook, thereby permitting policy substitution without altering the surrounding matching framework. For each execution, the engine emits a trade signal to the post-processing message queue 103. If a price level is exhausted (i.e., no remaining orders at that level), the corresponding Price Level Descriptor is returned to the memory pool. Similarly, if all orders in a Data Holder Node are depleted, that node is returned to the pool. This prompt reclamation of unused resources ensures high performance and efficient memory utilization throughout the matching process. Once no further orders can be matched, the system proceeds to the order insertion process (701) if any remaining quantity exists on the incoming order; otherwise, it exits the process.

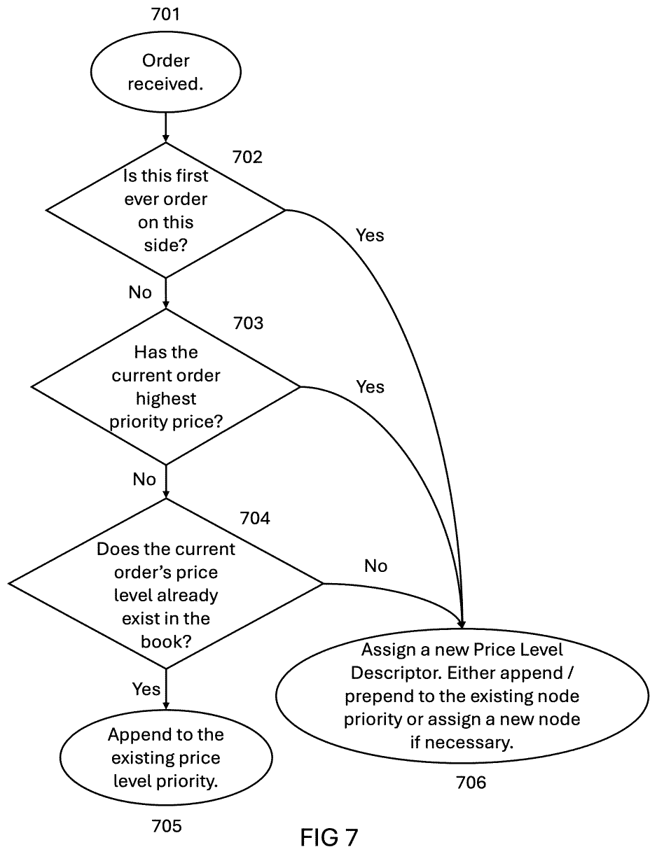

FIG. 7 outlines the order-insertion process. At step 701 the system determines whether the incoming order's price level already exists in the order book. Two alternative lookup paths are available, and the exchange may enable either or both at configuration time:
(a) Baseline path—Tree lookup: The system performs an O(log n) search in the balanced Price Level Descriptor tree;
(b) Optional path—Auxiliary hash map: If enabled, the system first performs an O(1) lookup in a hash map keyed by price level and consults the tree only when the hash result is null. Using either configuration (tree-only or dual tree-plus-hash map), once a price level is found, the system appends the order to that level. If the price level is absent, control passes to the special case flows in steps 702 and 703. In alternative embodiments, the processing order of steps 702, 703, and 704 may be rearranged to address these cases more efficiently on a given hardware platform. The optional hash map trades a modest increase in memory for predictable constant-time existence checks on heavily traded symbols. However, the performance improvement must be measured on the specific system to justify the added complexity.

Case 702 (First Ever Order): This situation arises when the book is empty on the given side (e.g., Buy or Sell). It always involves creating a new Data Holder Node since there are no existing nodes for that side. Because this scenario is relatively rare, the implementation can optimize branch prediction accordingly.

Case 703 (New Highest Priority): If the incoming order's price resets the highest-priority level (lowest ask or highest bid), the system performs Prepend rather than Append. It locates the current highest Price Level Pointer and accesses the corresponding Data Holder Node to place the new order at the front. In some instances, no new Data Holder Node is assigned from the memory pool here—only the prepending operation on the existing node for the current highest priority.

For orders whose price level is not present in the book and is not the highest priority, the system locates the appropriate insertion point by performing a ceiling operation (for buy orders) or a floor operation (for sell orders) to identify the in-order neighbor (predecessor) price level. Once the predecessor price level is identified, the system performs an append at the Data Holder Node that contains the end of that level's order list. Implementation note: depending on node layout, the order may be placed in a slot that is physically adjacent to the neighbor level's tail within the same Data Holder Node; it remains a distinct price level and is not part of the neighbor level's order list. Whenever a new Price Level Descriptor is assigned—whether in Case 702, Case 703, or this general insertion path—the system:
(a) places the descriptor in the Price Level Descriptor tree (see FIG. 8, elements 802 or 805) to preserve O(log n) ordering and;
(b) writes an entry to the auxiliary hash map (if present) so that future existence checks can execute in O(1) time. Likewise, when a price level is exhausted, its descriptor is removed from both the tree and, if applicable, the hash map. This synchronized maintenance ensures that the two data structures remain consistent while allowing the exchange to select the latency-memory trade-off that best fits each trading symbol.

In every order insertion process, the system registers lookup information for the incoming order (a Data Holder Node reference, slot index, or any information that identifies the order's physical location) in a hash map, ensuring O(1) lookups. This mapping is crucial for subsequent operations—such as order cancellation and order modification—because it enables the system to quickly locate and update the relevant order. Similarly, this logic applies to Push Back (204) and Push Forward (205) operations, because once an order is moved to a different Data Holder Node, the hash map must be updated to reflect the new node address for accurate future lookups. For hash map selection, we suggest using a custom closed-hashing design with SIMD-optimized lookups that generally delivers superior performance.

For order cancellation, the system retrieves the Data Holder Node pointer by using the order's unique identifier as a key in the hash map, then proceeds to cancel the order. At the Data Holder Node level, this cancellation process mirrors order execution: the specified order is removed, and if it was the highest or lowest priority at that price level, the corresponding Price Level Pointer is also deleted or adjusted. The remaining orders in the node are then rearranged to reflect their updated priorities. Finally, once the order is successfully canceled, a signal is emitted through the post-processing message queue 103.

Order modification is implemented using a two-tiered approach. First, the system locates the Data Holder Node containing the order by looking up the order's unique identifier in the hash map. Consistent with conventional exchange practice, a modification request that only reduces the order's quantity leaves the order's original time-priority in the limit-order book unchanged. Accordingly, the matching engine merely locates the order at its current node and overwrites the stored quantity value; no re-queuing or re-timestamping is required. Conversely, when the amendment involves either a price revision or an increase in quantity, the matching engine first cancels the resting order in the manner set out in paragraph [0082], then re-enters the revised order as a newly submitted order at the updated price level, thereby assigning it a fresh timestamp and queue position. This approach is necessary because altering an order's price across the execution barrier—the best price on the opposite side—may trigger executions in the order book, or at least it changes the priority of the order if reinserted at different price level. As with order cancellation, a successful order modification results in the emission of a signal via the post-processing message queue 103.

Queue structure and cache geometry—Each data-transport mechanism (elements 101 and 103) employs a lock-free ring buffer. For clarity, the discussion below refers to a single-producer/single-consumer (SPSC) configuration, but the same alignment rules and memory-ordering constraints apply when the ring is instantiated in single-producer/multi-consumer (SPMC), multi-producer/single-consumer (MPSC), or multi-producer/multi-consumer (MPMC) modes. In one embodiment, the write index, read index, and their private cache copies reside on distinct cache lines to eliminate false sharing. Index updates use release-ordered stores on the writer side and acquire-ordered loads on the reader side, guaranteeing producer-to-consumer visibility without full memory fences. Each payload slot is aligned to the processor's cache-line width, so every element occupies exactly one line; this alignment simplifies both direct-memory-access (DMA) bursts in zero-copy mode and vector-instruction loads/stores in copy-optimized mode.

Dual data-movement modes—The queue supports two strategies:
(a) Zero-copy mode: The producer constructs each payload directly inside the destination slot; the consumer obtains a pointer to that slot, processes the object in place, then retires the slot by advancing the read index. Only the index moves in software. The same physical buffer can be exposed through
   (i) a NIC receive ring whose DMA engine writes messages into the ring,
   (ii) a shared-memory mailbox resident in the last-level cache of a NUMA node,
   (iii) an on-chip inter-core fabric that maintains cache coherence, or
   (iv) an RDMA write window registered for remote access.
(b) Copy-optimized mode: When system tuning indicates that an explicit copy gives lower tail-latency, the consumer performs a single, cache-aligned vector-instruction copy of the payload into a local scratch area before processing. Because there is at most one copy—and it spans the exact cache line that contains the object—this mode remains lock-free and cache-friendly.

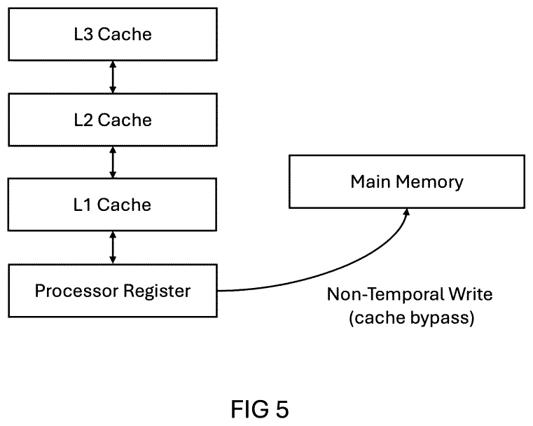

Non-temporal writes and NUMA considerations—If the producer and consumer reside on different NUMA nodes, or if any architectural or system requirement from either the processor or the memory subsystem so dictates, the producer may issue non-temporal store instructions (for example, x86 MOVNTDQ) as illustrated in FIG. 5, such that modified cache lines bypass the producer's private caches and are written directly to the memory controller attached to the consumer's socket. Non-temporal writes are particularly useful when the stored messages do not require retention in the producer's cache. As a general rule of thumb, non-temporal writes may be employed for large, streaming writes that will not be read by the producer in the near term; conversely, they may be avoided on systems with an inclusive last-level cache or when write-combining buffers could introduce undesirable latency, in order to prevent additional DRAM round-trips. Regardless of the policy selected, the queue maintains its lock-free progress guarantees.

Prefetch and cache residency—The consumer maintains a flag indicating whether the next slot is resident in L1. If it is not, and when multiple elements remain in the queue, the consumer prefetches the next slot's cache line to overlap memory latency with business logic. Where a copy is performed, the consumer uses a single vector-instruction transfer of the cache-line-aligned payload before processing. After processing, the consumer releases the slot by advancing the read index.

In the parent application Ser. No. 19/260,613, the following major concepts were discussed:
(a) A bit-mask abstraction that encodes the presence of Price Level Pointers with one bit per order slot, eliminating pointer relocation.
(b) Exemplary bitmask update logic, as well as the mathematical reasoning that corroborates why they are optimal.
(c) Flexible Data Holder Node capacity as well as exemplary mathematical methods for determining the optimal node capacity.
(d) Machine Learning based parameter optimization as well as exemplary implementations for on-the-fly parameter optimization.

In one embodiment the presence or absence of each Price Level Pointer in a Data Holder Node can be abstracted with a single bitmask, rather than an actual presence in a slot of Price Level Pointers. This abstraction encodes pointer presence in a bitmask, so the engine updates a single integer flag instead of physically relocating pointers. Eliminating relocation removes memcpy-style moves and their attendant memory latency. It also deletes the dedicated Price Level Pointer slot, shrinking each Data Holder Node by one (or two if both highest- and lowest-priority are tracked) machine word—typically eight bytes on an LP64 system—for every order slot, yielding a total size reduction of (pointer size×maximum orders per node) bytes. The smaller node packs more nodes per page, thereby boosting spatial locality and lowering translation-lookaside-buffer pressure. Each slot in the node maps to one bit of an integer flag, where a bit value “1” indicates that a Price Level Pointer occupies the slot and a bit value “0” indicates that it does not. Whenever the system appends, prepends, or removes an order, it updates the mask with a bit-shift operation instead of copying or moving pointers, thereby reducing maintenance overhead.

To achieve this abstraction, an embodiment needs to make each order object embed the Price Level Pointer that corresponds to that order's price level. This embedding is feasible because an order's price remains fixed while the order is active; any price change requires removing the order from the book and reinserting it at the new price level, thereby preserving price-time priority. In most 64-bit processor systems, the embedded Price Level Pointer occupies no more than eight bytes, adding only minimal overhead to each order object. An embodiment that tracks both the highest-priority and lowest-priority Price Level Pointers either:
(a) employs two separate bitmask flags; or
(b) uses a single bitmask with distinct bit fields for each priority.
   By contrast, an embodiment that tracks only the lowest-priority pointer uses a single bitmask sized with at least as many bits as the Data Holder Node's maximum order capacity.

Furthermore, the bit-shifting logic inside of this abstraction can easily be implemented without the need to use a branched code. Contemporary 64-bit superscalar processors expose at least two arithmetic-logic units (ALUs) per core; an ALU is the execution block that performs integer arithmetic and logic operations. A 64-bit shift retires in a single cycle, and a compiler can schedule it on an otherwise idle ALU while cache lines for surrounding order data load in parallel, yielding effectively zero added latency. Modern instruction set architectures (ISAs)—the x86-64 BMI1/BMI2 extensions (e.g., BLSR, BLSI, RORX) and Arm v8's bit-field instructions (BFI, BFC)—fuse shift-and-mask sequences into single μ-ops, further reducing issue-width pressure. Consequently, bit-shifting on bitmasks executes in a branchless way, avoids mis-prediction flushes, and introduces negligible overhead to the matching-engine critical path.

On top of the above benefits, embedding a Price Level Pointer in every order object lets the matching engine reach the associated Price Level Descriptor in low-constant O(1) time with a single pointer dereference. Without this embedment the matching engine must either:
(a) traverse the price level tree in O(log n) time; or
(b) probe an auxiliary hash map (if present) in high-constant O(1) time.
   Both paths typically load additional cache lines, which inevitably causes multiple L1-cache misses and raise latency. The direct pointer dereference, by contrast, incurs at most one L1-cache miss (for the corresponding Price Level Descriptor itself) and therefore outperforms the tree and hash map approaches. This constant-time, cache-friendly access is especially valuable when cancellations or modifications require frequent updates to the aggregated quantity at a given price level.

Word Width and Multi-Word Masks—Unless expressly stated otherwise, the examples herein are illustrated using a 64-bit native machine word under the LP64 data model (for example, most Unix-like x86-64 and AArch64 systems). The described algorithms and corresponding proofs are parameterized by the native machine-word width W, and therefore apply without modification to alternative data models (for example, LLP64, ILP32, ILP64) as well as to subsequently developed architectures having wider native words. Let a node's maximum capacity be m slots.
(a) Single-word case.
If m≤W, each mask (for example, head mask or tail mask) is represented as a single W-bit word.
(b) Multi-word case.
If m>W, represent each mask as an array of k=[m/W] words, denoted M[0, . . . , k−1]. Assuming the native word size W is a power of 2, for a logical slot i∈[0, m−1], the corresponding word index and bit position are computed as follows:

$$j = i ≫ {log}_{2} W , b = i \& ( W - 1 ) .$$

where >> denotes bitwise right-shift and & denotes a bitwise AND in this expression. Bit operations at logical slot i thereby mapped to the b-th bit of j-th word in the words array.
   Suffix/prefix shifts generalize by shifting within word j and propagating a single-bit carry across higher-indexed words; such operations remain branch-free and execute in constant time per touched word. On 128-bit or wider ISAs, an implementation may employ native wide-shift instructions, with the semantics remaining unchanged. Bit indexing as defined herein is symbolic and endianness-neutral. Instruction mnemonics cited for a particular ISA are provided solely by way of example and are non-limiting, as functionally equivalent bit-operations exist on ARM, RISC-V, x86, and future architectures supporting 128-bit or larger native words. Accordingly, the analysis and methods described herein are to be understood as word-width agnostic, with the 64-bit form used merely for purposes of exposition.

Formal Introduction—Let a Data Holder Node with maximum order slot capacity C (typically C≤64, if the capacity exceeds 64, expand this method by using two or more bitmasks for each highest and lowest priority), such that a complete Price Level Pointer allocation state in the node fits inside two 64-bit machine words. Denote the Boolean vector space of length-C bit-vectors by

$$V ∶ = {𝔽}_{2}^{C} , \{ {e}_{0} , … , {e}_{C - 1} \} the canonical basis ,$$

and recall that the Boolean ring operations are XOR for addition and AND for multiplication. In this setting every mask is both a vector in V and an idempotent element of the Boolean ring. Lastly, let the order book be a left-to-right chain of Data Holder Nodes

$${N}_{0} , {N}_{I} , … , {N}_{d} , capacity of each {N}_{k} = C \leq 64 .$$

(a) Local price level interval in one node—For a fixed node N write

$${π}_{N} : \{ 0 , … , C - 1 \} \to {ℝ}_{+}$$

which maps each slot index to price level that the order currently stored in that slot belongs to. If price level p occurs in N with at least one order, define the block boundaries

$${α}_{N} ( p ) : = min \{ i \vert π ( i ) = p \} , {ω}_{N} ( p ) : = max \{ i \vert π ( i ) = p \} ,$$

such that the occupied slots of level p form one contiguous run [α_{N}(p), ω_{N}(p)] inside node N. A node may contain no orders of p, one run, or be completely filled with p.
(b) Global first/last-node predicates—Define

$$First ( p ) := min \{ k \vert p appears in {N}_{k} \} , Last ( p ) := max \{ k \vert p appears in {N}_{k} \} .$$

A price level that exceeds one node's capacity simply satisfies

$$F i r s t ( p ) < L a s t ( p )$$

where intermediate nodes hold the middle segment of the queue.
(c) Head/tail masks inside one node N—Define two Boolean vectors

$${H}_{N} , {T}_{N} ∈ V , {H}_{N} = ( {H}_{0} , … , {H}_{C - 1} ) , {T}_{N} = ( {T}_{0} , … , {T}_{C - 1} ) ,$$

by the rule

$${H}_{i} = 1 ⇔ ( N = {N}_{First ( {π}_{N} ( i ) )} ) ∧ ( i = {α}_{N} ( {π}_{N} ( i ) ) ) ,$$

$${T}_{i} = 1 ⇔ ( N = {N}_{Last ( {π}_{N} ( i ) )} ) ∧ ( i = {ω}_{N} ( {π}_{N} ( i ) ) ) .$$

Thus,
   (i) every price level has at most one head bit and at most one tail bit in the entire order book;
   (ii) if an order is the sole order at its price level, the single order may carry both flags;
   (iii) interior nodes of a long queue carry no flag for that level.
(d) Admissible—mask set for the node-Define the admissible set

$${S}_{N} = \{ ( {H}_{N} , {T}_{N} ) ∈ {V}^{2} \vert definitions ( a ) - ( c ) hold \} .$$

Because the flag positions are determined solely by π_{N}, any two masks in S_{N} agree on every index where a flag is permitted.
(e) Closure under node-wise Boolean operations—For the current node N let

$$( H , T ) ∈ {S}_{N}$$

be the unique head/tail mask that exactly describes the present slot array of N and let

$$( {U}_{H} , {U}_{T} ) ∈ V \times V$$

be a sparse update vector produced by one of the operators in Table [0097]. By construction the update vectors toggle only those bit positions that are legally allowed to carry a flag for their price level (never more than one head and one tail slot per price level). The matching engine then may apply one of two word-size primitives:

$$( H ⊕ {U}_{H} , T ⊕ {U}_{T} ) \to ( H , T ) ( XOR toggle ) , \\ ( H ∧ ¬ {U}_{H} , T ∧ ¬ {U}_{T} ) \to ( H , T ) ( AND clear ) .$$

Because the support of U_{H}, U_{T} is restricted to the single legal slot for each flag inside N, the above operations can never create an illegal “1” for any price level; they can only erase of flip existing legal bit. Formally,

$$( H , T ) ∈ {S}_{N} ⇒ ( ( H ⊕ {U}_{H} , T ⊕ {U}_{T} ) ∈ {S}_{N} ∧ ( H ∧ ¬ {U}_{H} , T ∧ ¬ {U}_{T} ) ∈ {S}_{N} ) .$$

Therefore S_{N} is closed under component-wise AND and XOR even when a price level queue extends over many Data Holder Nodes.
(f) Composite layout—When register pressure is high or the compiler can fuse two bitmasks into a single scalar variable, an embodiment can embed the ordered pair (H, T) in a single 64-bit word

$$M = H ‖ T ,$$

e.g. the lower 32 bits store heads, the upper 32 tails. Bit-field isolation (BFXIL/BFI on Arm, BEXTR on x86 BMI2) and cross-field moves (RORX, logical rotates) let the CPU manipulate the two sub-vectors without branching and with the same latency profile as the dual-mask variant.

$$Let V = {𝔽}_{2}^{C}$$

with the usual tensor product ⊗. The ordered pair of head- and tail-bitmasks is the direct sum

$$V ⊕ V ≅ {𝔽}_{2}^{2 C} .$$

Because finite-dimensional [symbol] ₂-vector spaces form a rigid symmetric-monoidal category

$$( {Vect}_{{𝔽}_{2}}^{fd} , ⊗ , {𝔽}_{2} ) ,$$

the standard evaluation/coevaluation morphisms yield a natural isomorphism

$$( H , T ) ↦ ( H ⊗ {e}_{0} ) ⊕ ( T ⊗ {e}_{1} ) ,$$

whose concrete matrix is a block permutation of the identity and therefore invertible. Thus, the packing/unpacking operation preserves all information without appealing to specialized Boolean-ring properties. The choice between layouts is therefore a micro-architectural optimization, not a semantic one.
(g) Memory-Footprint Impact—Substituting the two-pointer (head+tail) layout with the dual- or composite-mask scheme deletes 2×C×pointer-size bytes of node metadata, where C is the node's capacity; a single reference to the corresponding Price Level Descriptor now embedded in each order object often slips into padding that already exists to satisfy cache-line alignment (e.g., the 8-byte gap rounding a 56-byte payload up to 64 bytes), so it costs zero extra space and the node realizes the full 2×C×pointer-size saving. If the padding is smaller than a pointer, the compiler extends the object and the net win falls somewhere between C×pointer-size and 2×C×pointer-size, depending on how many slack bytes are reclaimed; should the legacy design have held only one pointer per order, the new scheme still saves up to C×pointer-size or at worst breaks even. Thus, by harvesting otherwise unused alignment holes, the practical reduction can exceed the baseline C×pointer-size estimate and—in the best-aligned case—approach the full 2×C×pointer-size gain.

Priority-Tracking Variants—The apparatus and methods detailed in this specification are illustrated with an embodiment that concurrently tracks both the highest- and lowest-priority items. This dual-tracking example is provided solely by way of illustration and should not be construed as limiting. Persons of ordinary skill in the art will appreciate that the lowest priority only tracking may likewise be implemented without departing from the scope of the present disclosure, simply by omitting the head mask path.

Formal Invariants—Let a node state be [symbol] =(O, H, T)∈O^{C}×V², where Oᵢ is either an order object or ⊥ (empty slot). Define the slot-bit bijection

$$η : i ↦ {e}_{i} .$$

The correctness of all subsequent transforms hinges on three invariants:
   (a) Occupancy condition—All head/tail bits are subsets of the occupancy set; formally:

$$supp ( H ) ⋃ supp ( T ) ⊆ \{ i \vert {O}_{i} \neq ⊥ \}$$

where for a bit-vector

$$x = ( {x}_{0} , {x}_{1} , … , {x}_{C - 1} ) ∈ {𝔽}_{2}^{C} ,$$

$$supp ( x ) := \{ i \vert {x}_{i} = 1 \} .$$

(b) Head uniqueness—For every price level π,

$${\sum }_{i : {O}_{i} has price π} H \cdot {e}_{i} \leq 1 .$$

(c) Tail uniqueness—The analogous inequality on T.
Because XOR is the additive group law in V, these constraints define a Galois-closed subset

$$i = \{ ( O , H , T ) \vert all conditions ( a ) - ( c ) hold \}$$

of the product Boolean ring O^{C}×V². Any affine self-map of V² that preserves the coordinate support of (H, T) is automatically an endomorphism of i, a fact that the matching engine exploits to prove correctness of each update.

Operators and Algebraic Toolkit—All mask manipulations are built from four word-parallel primitives, each expressible as a linear or affine map on V:

| | | Linear | Micro-op |
|---|---|---|---|
| Symbol | Definition (on x ϵ V) | rank | realization |
| Sₖ | Left shift by k (x << k, zero-fill) | C − k | 1 cycle SHL/LSL |
| Rₖ | Right shift by k (x >> k, zero-fill) | C − k | 1 cycle SHR/LSR |
| Pₖ^{R} | Suffix-right-shift: Fix indices < k; | C − 1 | SHL + |
| | send i > k → i + 1, i = k → 0 | | AND mask |
| Pₖ^{L} | Suffix-left-shift: Fix indices < k; | C − 1 | SHL + |
| | send i > k → i − 1, i = C − 1-> 0 | | AND mask |
| Cᵢ | Clear bit i: x ∧ ¬eᵢ | C − 1 | BTR or AND |
| | | (idem- | with negated |
| | | potent) | mask |

Note that

$${P}_{k}^{R} and {P}_{k}^{L}$$

are named in the order arrangement direction (left-to-right, the suffix comes on the right end), thus perform an opposite side logical shift

$$( {P}_{k}^{R} does a left shift , {P}_{k}^{L} does a right shift ) .$$

The micro-op realizations shown in the above table are illustrative of x86-64 cores; Arm and other ISAs offer analogous single-cycle or fused instructions. All other transformations—e.g. prefix shifts, bit injections, or rank-1 toggles—compose these primitives and at most one sparse vector XOR. These maps are linear endomorphisms, therefore not necessarily invertible. Each is injective on the subspace that occurs at runtime, which is enough to preserve correctness. Under the Word-Ram cost model, each primitive is Θ(1) time; on real hardware the latency is dominated by a single 64-bit ALU pipe, schedulable parallel to data-cache fetches. By restricting attention to this toolkit, the matching engine guarantees:
(a) Branch-free critical paths—updates do not incur mispredictions.
(b) Constant-time worst case per node—no data dependent loops; time is bounded by two shifts+two bit-tweaks for bitmask updates.
(c) Information-theoretic minimality—since every operator preserves or reduces the Hamming weight of (H, T), the representation never fattens beyond 2C bits irrespective of workload.
   These expanded definitions supply the algebraic foundation for all subsequent operations.

Non-Uniqueness of Update Equations—In the following Boolean vector space:

$$V = {𝔽}_{2}^{C} , {V}^{2} = V \times V ≅ {𝔽}_{2}^{2 C}$$

A bitmask update routine transforms a state (H, T)∈V² into a new pair (H′, T′). The most common implementation is an affine endomorphism

$$F ( H , T ) = ϕ ( \begin{matrix}H \\ T\end{matrix} ) ⊕ b , ϕ ∈ End ( {V}^{2} ) , b ∈ {V}^{2}$$

because XOR (⊕)) is the additive law in V². But, the functional spec does not require linearity: any Boolean circuit that satisfies the following two conditions as well as maintaining the invariant of the system is admissible, even if it is non-linear. The correctness requirement is simply:
   (a) F(supp(H)∪supp(T))⊆{i|Oᵢ≠⊥} (mask bits never point to empty slots);
   (b) F preserves the head/tail-uniqueness inequalities price-level-wise.

XOR↔OR Replaceability Under a Pre-condition—Consider the Prepend path (§ [0105]):
(a) Prefix shift S₁ is a zero-fill map, therefore it sets bit 0 to zero.
(b) An embodiment may choose either
   (i) XOR Insertion x [symbol] x⊕e₀
   (ii) OR Insertion x [symbol] x∨e₀
Because both yield the same result on that zeroed-out operand.
   Thus, any affine update of the form in can be converted into a non-linear variant

$${F}_{V} ( H , T ) = ( {ϕ}_{H} ( H , T ) ⋁ {b}_{H} ) \vert \vert ( {ϕ}_{T} ( H , T ) ⋁ {b}_{T} ) ,$$

where φ is the linear part and (b_{H}, b_{T}) are constant masks, without changing the logical book whenever the vacated bits are guaranteed to be 0 in the affine form. In that sense XOR and OR are inter-substitutable under the zero-filled operand pre-condition supplied by the shift operators.

Affine Endomorphisms, Non-Linearity, and Implementation Freedom—Hence, there are two different directions can be employed:
(a) Affine option—keeps the update inside the category of linear maps; rank, kernels, and composition can be reasoned about with matrices. The concrete rules we adopt use exactly one composition of the rank-deficient primitives (Sₖ, Rₖ, Pₖ, Cᵢ) introduced in [0097] plus a translation vector b of Hamming weight≤2. The transition vector gives a rank≤2 perturbation—algebraically minimal and compiling to ≤2 BTS/BTR/BTC μ-ops per mask on x86-64 architecture.
(b) Non-linear option—replaces some XORs by ORs. Algebraic linearity is lost, but the correctness requirement defined in still hold, so the routine is functionally correct. In some cases, an embodiment might prefer OR for the following reasons:
   (i) Idempotent flag-set: x∨e₀ cannot clear a flag if the same write happens twice, which is useful under CAS retries or speculative aborts.
   (ii) Concurrent safety: in case of a Data Holder Node being shared among two or more threads, multiple threads OR-ing the same bit only converge to 1; XOR could toggle to 0.
   (iii) Zero hardware penalty: OR imm (immediate operand) and EOR/XOR imm are both single-cycle μ-ops on the latest x86-64 and AArch64.
Because both options satisfy the invariants, and because the matching engine never needs to invert the update, there is no canonical formula. An embodiment can therefore choose the variant that: minimizes latency on a particular ISA, exposes BFI/BFXIL fusion on AArch64, or aligns better with formal-verification strategy (affine maps are easier to reason about in Coq/SSReflect).

Conclusion on the Non-Uniqueness of Update Equations—Two routines F₁, F₂, whether both affine, both non-linear, or one of each—are observationally equivalent whenever they maintain the invariant in [0096] and satisfy the correctness requirement in [0098]. For each bitmask update equation stated herein, persons of ordinary skill in the art will recognize that an alternative or equivalent update rules may be employed; however, so long as the underlying set of features being evaluated is identical, each such implementation will produce the same resulting bitmask. Hence the specific shift-plus-flag equations as well as their mathematical reasoning presented in below are exemplary, not limiting: any mathematically consistent alternative (including, but without limitation, XOR↔OR substitutions under zero-fill) remains within the disclosed scope.

Match-and-Insert Invariant, Stable Index Mapping (FIG. 16)—Let the order array before execution be the sequence

$$O = ( {O}_{0} , … , {O}_{n - 1} ) {O}_{i} ∈ 𝒪 ⋃ \{ ⊥ \}$$

where [symbol] ={o|o is well defined order}, and assume a set D={d₁< . . . <dᵣ}⊆{0, . . . C−1} of slots is about to be removed (order fills, cancels, etc.). Define the deletion map

$$Π = {P}_{{d}_{r}} ∘ … ∘ {P}_{{d}_{1}} ,$$

where each P_{d}_{ⱼ} is the suffix-left-shift operator that was introduced in [0097]. Because every P_{d}_{ⱼ} deletes only bit information that corresponded to a deleted order, Π(H, T) still satisfies the invariant requirement. Then, the matching engine performs the following updates:
   (a) Payload compaction moves the suffixes of O left by the number of deletions r.
   (b) Mask compaction applies the rank C−r deletion map Π.
During execution, a naïve application of Π would seem to require r separate shifts; however, as long as r≤C an embodiment can vectorize into two shifts plus masks for a single contiguous deletion run. Even when not vectorized, the number of word operations is a constant-bounded number per mask. Thus, the mask update cost

$$Θ ( ⌈ \frac{r}{C} ⌉ ) = Θ \qquad ( 1 )$$

in the Word-RAM model whenever a node fits in one word—meeting the latency target for ultra-low-latency trading systems.

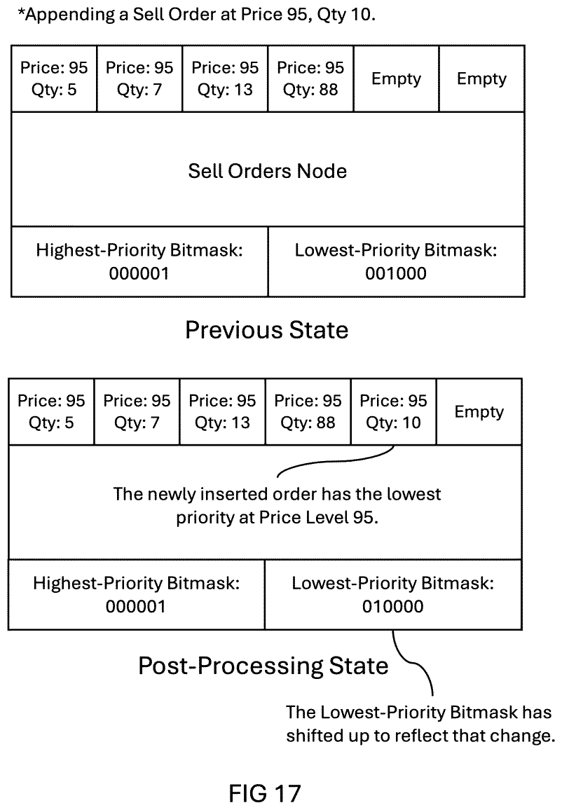

Simple Append (a special case of block 705, FIG. 7), (FIG. 17)—Suppose the Data Holder Node currently holds k<C active slots, so the incoming order is appended at index k. Define the rank-1 toggling vector

$${δ}_{T} = ( {e}_{k} ⊕ {e}_{k - 1} ) ,$$

i.e. clear bit at k−1 and set bit at k. Then, the matching engine updates the bitmasks with the following equations:

$${H}^{′} = H , {T}^{′} = T ⊕ {δ}_{T} .$$

This equation has the following algebraic properties:
   (a) Rank argument—T [symbol] T⊕δ_{T} differs from the identity by a matrix of rank 1; hence it is the minimal linear perturbation that can relocate a single 1-bit.
   (b) Endomorphism of i—Because the perturbation only affects two indices, both of which are known occupied (k−1 and k), the subset invariant is preserved. Head/tail uniqueness is preserved because exactly one bit per price level remains set.
   (c) μ-op realization—For example, on x86-64:
      (i) BTR mask, (k−1)—bit-test-and-reset (clears the old tail flag).
      (ii) BTC mask, k—bit-test-and-complement (sets the new tail flag).
   These two μ-ops share no data dependency except through the mask register, giving a dependency depth 1 and retiring in ≤2 cycles even on a narrow superscalar front end.
Thus, the best-case and worst-case latency of Simple Append differ by at most two ALU μ-ops.

Generalized Append (general case of block 705, 706, FIG. 7), Suffix-Shift Transform and Bit-Flag Injection (FIG. 17)—Unlike the simple “size=k” case, a general Append may insert at an interior slot k even when higher indices already contain orders. The matching engine therefore performs two coupled actions:
(a) Open a gap in both payload and masks—Assume the node currently holds k′ live orders (0≤k<k′−1<C). Using the suffix-right-shift operator,

$${P}_{k} : V \to V ,$$

$${( {P}_{k} x )}_{i} = \{ \begin{matrix}{x}_{i} & i < k \\ 0 & i = k \\ {x}_{i - 1} & k < i < C\end{matrix}$$

which is injective on the subspace {x|x_{C-1}=0}, because just before the Append, the ending slot C−1 is vacant or about to be evicted. If the slot C−1 was occupied before the Append, apply Push Back to evict the spot. Because the entire node's information (assuming C≤64, if not, expand this model using two or more 64-bit integers) fits in one 64-bit word, the suffix-right-shift operator executes in Θ(1) time.
(b) Define a predicate for the new order—After performing bitmask update of (a), we define a generalized predicate φ as follows:

$$φ ( a ) = \{ \begin{matrix}1 & if the incoming order a carries a Price Level Pointer \\ 0 & otherwise\end{matrix}$$

$$φ ( a ) = \{ 〈 a , 1 〉 \vert a ∈ 𝒪 ∧ PL P ( a ) \} ⋃ \{ 〈 a , 0 〉 \vert a ∈ 𝒪 ∧ ¬ P L P ( a ) \} .$$

The predicate determines whether the incoming order “a” would carry a Price Level Pointer if it was a pointer-based embodiment. For example, the general insertion case element 706, Append is invoked as a part of creation of a new price level, and thus φ(a)=1. By contrast, the insertion case of element 705 would be φ(a)=0 because the price level for that order already exists in the matching engine's order book, and thus the incoming order would not carry a Price Level Pointer. For the case of Append as Push Forward-derivative (see [0062] for reference), φ(a) would determine whether the corresponding Price Level Pointer is being pushed forward together with order a. φ(a) is called generalized because it's defined separately in both highest- and lowest-priority context. (respectively, φ_{H}(a), φ_{T}(a)) To eliminate any confusion, φ(a) is defined solely for the incoming order that's being passed as an argument of the Append, and not for the pre-existing orders in a Data Holder Node.
(c) Bitmask update equations
   (i) For the case of Append as Push Forward-derivative, the case divides to two cases: whether the Appended Data Holder Node is full or not. If not full, then the matching engine updates bits with the following branchless way:

$$( \begin{matrix}{H}^{′} \\ {T}^{′}\end{matrix} ) = ( \begin{matrix}{P}_{k} & 0 \\ 0 & {P}_{k}\end{matrix} ) ( \begin{matrix}H \\ T\end{matrix} ) ⊕ ( \begin{matrix}{φ}_{H} ( a ) {e}_{k} \\ {φ}_{T} ( a ) {e}_{k}\end{matrix} )$$

Where k is the index of the slot being inserted. If the Data Holder Node being appended is full, the case turns to another cascaded-Push Forward case. After the Push Forward of the order at index 0, the Data Holder Node should now have an empty slot, and the case resolves to the above “non-full” case. This concludes for Append as Push Forward-derivative.
(ii) For the case of Append as a general case of block 705, 706—this case also divides into block 705 and 706. In case 705, there is no new price level being created, and thus φ(a)=0 for both highest- and lowest-priority for the incoming order's price level. Also, the incoming order is being appended to the existing priority, thus it will replace the older lowest-priority flag for that price level. For the case 706, a new price level is being created, thus φ(a)=1 for both highest- and lowest-priority for its price level. Also, the case 706 does not need reallocation of the bit flag since the incoming order is the sole order at that price level. Then, the matching engine updates the bitmask with the following branchless way:

$$( \begin{matrix}{H}^{′} \\ {T}^{′}\end{matrix} ) = ( \begin{matrix}{P}_{k} & 0 \\ 0 & {P}_{k}\end{matrix} ) ( \begin{matrix}H \\ T\end{matrix} ) ⊕ ( \begin{matrix}{φ}_{H} ( a ) {e}_{k} \\ {e}_{k}\end{matrix} ) ⊕ ( \begin{matrix}0 \\ ¬ {φ}_{T} ( a ) {e}_{k - δ ( k )}\end{matrix} )$$

where δ(k) in this context, is defined as follows:

$$δ ( k ) := 1 - {δ}_{k 0} = \{ \begin{matrix}0 & if k = 0 \\ 1 & otherwise\end{matrix}$$

The purpose of δ(k) is to confine the index within the canonical basis boundary when k=0.
   FIG. 17 annotates the before-and-after masks, showing the suffix shift and the newly raised bit at index k; all other price levels retain their head/tail markers unchanged, preserving the invariant defined in [0096]. The entire mutation, payload move plus mask update, remains constant time on any node.

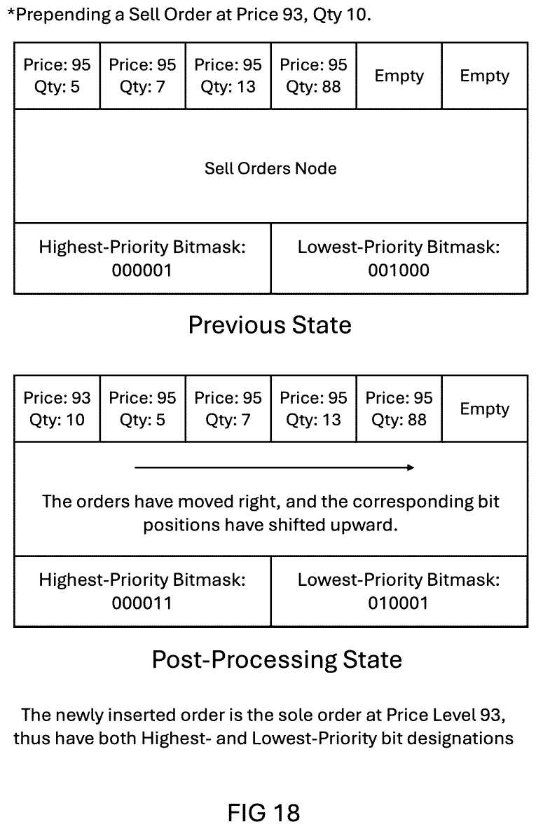

Generalized Prepend, Prefix-Shift Transform and Bit-Flag Injection (FIG. 18)—In one embodiment that does not implement the “jump to the front” function, Prepend always inserts the incoming order at slot index 0. For the “jump to the front” function, which may involve prepending an order at non-zero index location, a different prefix-shifting can be employed (Sₖ, where 1<k<C). For simplicity, this paragraph describes a general scenario where the insertion is done at index 0. Then, the matching engine shifts every pre-existing order (and its metadata) one index higher. Let

$${S}_{1} : V \to V , {S}_{1} ( x ) = x ≪ 1 mod {2}^{c}$$

(logical left shift by 1 in a fixed C-bit word) which has rank (S₁)=C−1; injective on vectors with x_{C-1}=0, since either the node was not full, or the order in the first slot (index 0) is about to be evicted via the Push Forward operation. Then, the matching engine updates the following:
   (a) Prefix-shift of both masks—If the node was full, the matching engine evicts the first order and its corresponding bit via the Push Forward. If the first slot was evicted, the rest of the orders and the bitmasks are already aligned and thus there is no need for an additional shift. However, if the node was not full, the matching engine uses the above defined S₁ operator. Then, the shifting operator is defined as:

$$ϕ = \{ \begin{matrix}I & if the first slot was evicted before the Prepend \\ {S}_{1} & otherwise\end{matrix}$$

where I:V→V is the identity matrix defined in the respective dimension.
(b) Adjust head and tail flags for the new order—In case of prepending due to creating a new price level (block 706, FIG. 7), by definition, the prepended order is both highest- and lowest-priority at its price level π since it's the sole order at its price level, thus we have:

$$( \begin{matrix}{H}^{′} \\ {T}^{′}\end{matrix} ) = ( \begin{matrix}( I - {E}_{0} ) ϕ & 0 \\ 0 & ( I - {E}_{0} ) ϕ\end{matrix} ) ( \begin{matrix}H \\ T\end{matrix} ) ⊕ ( \begin{matrix}{e}_{0} \\ {e}_{0}\end{matrix} )$$

where E₀ is defined as an outer product of canonical basis e₀,

$${E}_{0} = {e}_{0} {e}_{0}^{T} , ( I - {E}_{0} ) ∈ End ( V ) ,$$

or simply as non-linear expressions,

$${H}^{′} = ϕ H ∨ {e}_{0} ( sets bit 0 unconditionally )$$

$${T}^{′} = ϕ T ∨ {e}_{0} ( likewise sets bit 0 ) .$$

However, if the price level π already existed, wherein the case Prepend is invoked as a derivative mechanism of Push Back, then there is no guarantee that the newly inserted order is either highest- or lowest-priority at its price level. Then, the matching engine uses the generalized predicate defined in [0104]:

$$φ ( a ) = \{ \begin{matrix}1 & if the prepended order a carriers a Price Level Pointer \\ 0 & otherwise\end{matrix}$$

In other words, the predicate φ(a) tells whether the prepended order would carry a Price Level Pointer if it was a pointer-based embodiment. Then, the matching engine updates the bitmasks with the following equations:

$$( \begin{matrix}{H}^{′} \\ {T}^{′}\end{matrix} ) = ( \begin{matrix}ϕ & 0 \\ 0 & ϕ\end{matrix} ) ( \begin{matrix}H \\ T\end{matrix} ) ⊕ ( \begin{matrix}{φ}_{H} ( a ) {e}_{0} \\ {φ}_{T} ( a ) {e}_{0}\end{matrix} )$$

This concludes the bit-shifting for Prepend method.
(c) Complexity analysis—The metadata update performs one 64-bit shift per mask, up to two 64-bit word writes, and no data-dependent branches inside the critical path (the result of the predicate φ(i) is already known at the time of invocation of Prepend). Thus, the prepend path retains Θ(1) latency, matching the information-theoretic lower bound for inserting one order and updating at most two Boolean flags.

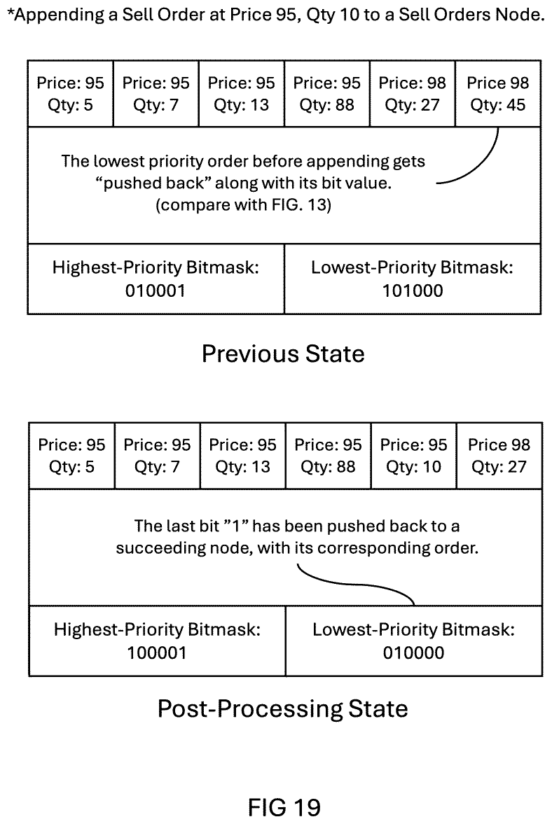

Push Back (FIG. 19)—When Append targets a full node (size=C), the engine decides which order to relocate to the succeeding node by comparing the priority of the tail order (slot i=C−1) and the incoming order. If the incoming order is being relocated to the succeeding node, the current node's state does not change. The following is description of the tail order eviction case. (Eviction at slot i=C−1)
(a) Node state and invariant—The mapping “slot i [symbol] bit i” is a bijection between the set of occupied slots and the set of bits that are 1 in either mask. Inside the Boolean ring [symbol] {0,1}^{C}, ⊕, ∧ [symbol] each mask is simply a length-C Boolean vector.
(b) Clearing the information of the evicted order—The operator “clear bit” is the Boolean-ring endomorphism

$${C}_{C - 1} : x ↦ x ∧ ¬ {e}_{C - 1} .$$

Because it fixes every bit except the one being cleared, it is idempotent but not invertible; that is exactly what we need when permanently removing the tail slot. Also, at the same time the matching engine calculates the generalized predicate that will be used in the following derived-Prepend operation for the evicted order

$${φ}_{x} ( a ) = \{ 〈 x , 1 〉 \vert x ∈ V ∧ {e}_{C - 1}^{T} x = 1 \} ⋃ \{ 〈 x , 0 〉 \vert x ∈ V ∧ {e}_{C - 1}^{T} x = 0 \}$$

where x∈{H, T} in the above expression is each bitmask. Then, the matching engine updates the bitmask of the Data Holder Node as follows:

$$( \begin{matrix}{H}^{′} \\ {T}^{′}\end{matrix} ) = ( \begin{matrix}{C}_{C ‐ 1} & 0 \\ 0 & {C}_{C ‐ 1}\end{matrix} ) ( \begin{matrix}H \\ T\end{matrix} )$$

(c) Transforming the node—Removing the last order restricts the index set from {0, . . . , C−1} to {0, . . . , C−2}; the identity map on those surviving indices remains a bijection and preserves their natural order. Applying the clearing endomorphism to H and T therefore maintains the slot-bit bijection on the smaller index set. After the relocation, the matching engine proceeds the insertion process as Prepend on the successor node.
(d) Cost—One order is copied out, two single-word Boolean-ring operations are executed. Constant time irrespective of C.

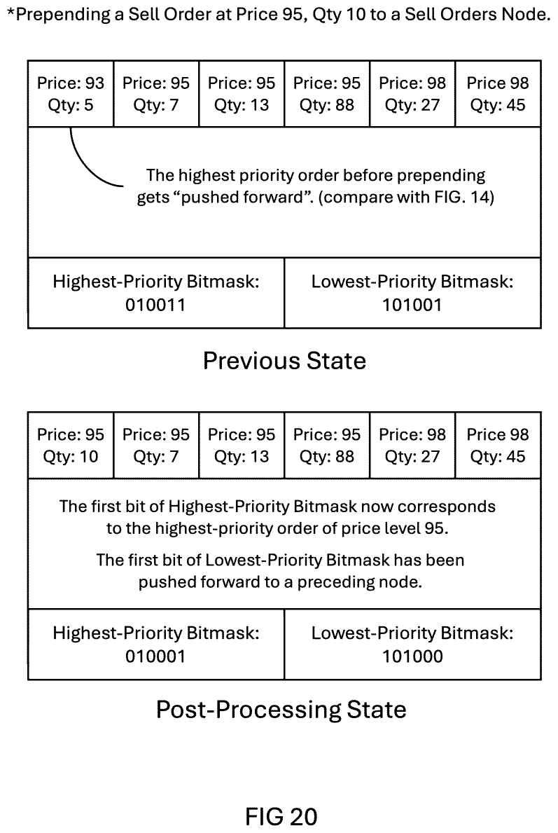

Push Forward (FIG. 20)—When Prepend targets a full node (size=C), the matching engine decides which order to relocate by comparing the priority of the head order and the incoming order. In case the incoming order is relocated, the current node's state does not change. The following description is for the case when the matching engine evicts the head order (slot i=0) and transfers it to the immediately preceding node. It then reevaluates the generalized predicate φ(a) from [0104] by checking whether that displaced order retains a corresponding Price Level Pointer. Then, the matching engine updates the bitmask of the Data holder Node as follows
(a) Define a shift down operator—On the sub-space {x∈V|x₀=0} the logical right shift operator R₁:V→V is defined as:

$${R}_{1} ( x ) = ( x ≫ 1 ) .$$

R(x) preserves XOR and AND, so is an endomorphism of the Boolean ring [symbol] {0,1}^{C}, ⊕, ∧ [symbol] . Because all vectors fed into R₁(x) satisfy x₀=0, no information is lost when the shift discards bit 0. Within this subset, R₁ is therefore injective (one-to-one) on the subset {x∈V|x₀=0}.
(b) Order-index bijection—The map on slot indices,

$$i ↦ i - 1 ( 1 \leq i \leq C - 1 )$$

is an order-preserving bijection from the old index set {1, . . . , C−1} onto the new set {0, . . . , C−2} Applying R₁(x) to both masks transports every ‘1’ bit through exactly this bijection, thus the slot-bit invariant is maintained.
(c) The bitmask update—The matching engine calculates the generalized predicate that will be used in the following derived-Append operation for the evicted order

$${φ}_{x} ( a ) = \{ 〈 x , 1 〉 \vert x ∈ V ∧ {e}_{0}^{T} x = 1 \} ⋃ \{ 〈 x , 0 〉 \vert x ∈ V ∧ {e}_{0}^{T} x = 0 \} .$$

Then, the matching engine updates bitmasks as follows:

$$( \begin{matrix}{H}^{′} \\ {T}^{′}\end{matrix} ) = ( \begin{matrix}{R}_{1} & 0 \\ 0 & {R}_{1}\end{matrix} ) ( \begin{matrix}H \\ T\end{matrix} ) .$$

In case where the shifting operator R₁ is defined as non-zero-fill, (particularly, in non-linear expressions that use non-zero-fill shifting operators)

$$( \begin{matrix}{H}^{′} \\ {T}^{′}\end{matrix} ) = ( \begin{matrix}{C}_{C - 1} & 0 \\ 0 & {C}_{C - 1}\end{matrix} ) ( \begin{matrix}{R}_{1} & 0 \\ 0 & {R}_{1}\end{matrix} ) ( \begin{matrix}H \\ T\end{matrix} )$$

After the transfer, the insertion continues as Append on the predecessor node. If the predecessor is also full, the hop repeats toward the book head. The shift of both masks keeps the relative position of any existing Price Level Pointer correct after the physical order array shift, and the cascade depth cap again bounds latency.

Introduction to Flexible Node Capacity—In one embodiment, the maximum number of orders a Data Holder Node can hold is defined as a monotone, non-increasing function of its depth—the number of hops from the order book head. Nodes at or near the head experience orders-of-magnitude higher access rates than those further away, thus allocating larger contiguous blocks to these “hot” nodes amortizes cache-line shifts and reduces the frequency of Push-Back/Push-Forward cascades. Nodes deeper in the book, by contrast, may stay intentionally “thin,” shrinking their cache- and TLB-footprint without harming latency-critical paths. This depth-aware sizing preserves all slot-bitmask invariants introduced in [0096] while aligning memory usage with observed locality, thereby lowering the expected L1-miss cost per matched or modified order.

Scope-Neutral Disclaimer—The mathematical derivation of the depth-aware Flexible Node Capacity strategy and the machine-learning optimization loop are illustrative only. Practitioners may employ other analytical or data-driven techniques—including, without limitation, a whole-book latency-minimization objective, gradient-boosted decision trees, boosted regression trees, random forests, linear and generalized-linear models, kernel methods, Gaussian-process regressors, mixture models, contextual bandits, and reinforcement-learning controllers- or static heuristics/rule-based reallocators, without departing from the teachings or claimed subject matter.

Formal Introduction to Flexible Node Capacity—Let

$$κ \text{:} ω \to {ℕ}_{\geq 1} , d ↦ {C}_{d}$$

assign to every Data Holder Node at distance d∈ω from the order book head (hereunder “depth”), an order capacity C_{d}. Assume the following constraints:
   (a) Monotone non-increasing property,

$${C}_{0} \geq {C}_{1} \geq {C}_{2} \geq ⋯$$

(b) Maximum order capacity,

$${C}_{0} \leq {C}_{Max} \leq 64$$

such that each bitmask can describe the entire node's status within one 64-bit word. The maximum order capacity 64 is illustrative and non-limiting. When an embodiment requires a relaxed requirement for the maximum order capacity, use two or more words for each bitmask.
(c) No artificial cap in the total order book size,

$${\sum }_{d < ω} {C}_{d} = ∞ .$$

The rationale for the above assumption is as follows: Empirical telemetry on live matching engines shows that the access frequency decays super-exponentially with depth; allocating larger buckets near the head amortizes O(1) updates over more orders while keeping tail pages leaner and cache-friendlier. This flexible node-capacity model guarantees safety against infinite recursion, even in the absence of an explicit cascade limit and irrespective of how each node's capacity is determined. A formal proof of this property is provided in Appendix B (illustrative and non-limiting).

Derivation of Latency Cost Model—Consider an optimization problem of processing latency per order basis.
(a) Formal introduction—An embodiment may implement minimization of the following cost function:

$${L}_{i} ( {k}_{j} ) = {P}_{L 1} ( i ) {T}_{hit} ( {k}_{j} ) + [ 1 - {P}_{L 1} ( i ) ] {T}_{miss} ( {k}_{j} )$$

where, Lᵢ is the processing latency of order i which is contained in the Data Holder Node at depth j, kⱼ is the capacity of that Data Holder Node, P_{L1} is the probability of order i being in L1 cache, Tₕᵢₜ is the processing latency at L1 cache hit, and Tₘᵢₛₛ is the processing latency at L1 cache miss. One thing to note here is that Tₕᵢₜ and Tₘᵢₛₛ are both functions of the Data Holder Node size kⱼ, since every insertion/deletion requires adjustment of the entire node storage, thus Tₕᵢₜ, Tₘᵢₛₛ grow linearly with kⱼ. Then,

$${T}_{hit} ( {k}_{j} ) = {Ak}_{j} , A = \frac{{t}_{c} + wu}{2} , {T}_{miss} ( {k}_{j} ) = {Ak}_{j} + {t}_{m}$$

where t_{c} is L1 cache round trip latency (~4 CPU cycles), w is write/all-access ratio, u is slot shifting latency (~5 CPU cycles per shifted order, assuming each order size is 64 bytes), and tₘ is the remote memory access penalty (normally, +120 CPU cycles). The constant A reflects the expected value of linear scan and shift cost.
(b) Empirical access model—The empirical order book data from one of the most liquid books, such as Nvidia stock, shows that the orders in the top of the book are exponentially more likely to be accessed than the orders in the deeper region of the order book. This shows a remarkably straight line on a log-log plot. Consequently:

$$\# of updates ( l ) ∝ {l}^{- β}$$

where β is an empirical parameter to be determined from actual data, and l is each price level counted from the top of the book. Then, assume that a price level that is closer to the top of the book contains exponentially more orders than the remote price levels

$${n}_{l} = {n}_{1} {e}^{- γ ( l - 1 )} ( γ > 0 ) .$$

where n₁ is the number of orders contained in best bid-ask price level (top of the book). For simplicity, within the price level, assume that the orders in the front are equally likely to be hit as the orders in the back of the queue.

$$Pr ( hit offset j \vert l ) = 1 / {n}_{l} .$$

Then, an embodiment can construct the per-order hit probability as follows:

$${p}_{l , j} = Pr ( Price level l ) Pr ( offset j \vert l ) = \frac{{l}^{- β}}{{Z}_{lvl}} \cdot \frac{1}{{n}_{l}} .$$

where the following normalizer is used in the above equation,

$${Z}_{lvl} = {\sum }_{m = 1}^{∞} {m}^{- β}$$

(Across price levels, Riemann zeta series) Putting it together gives,

$${p}_{l} = \frac{{l}^{- β}}{{Z}_{lvl} {n}_{l}} .$$

(c) Sanity checks—The postulated exponential decay of queue length with price level depth holds only when the decay constant γ is re-estimated from live telemetry, and not hard-wired to the first few ticks, which are frequently “humped” rather than monotone. Parameter γ—and, by extension, any distributional parameter—therefore resides squarely within an implementer's design freedom and does not limit the scope of the invention. Likewise, the intra-level hit-probability term is meaningful only under FIFO or price-time priority; in a pure pro-rata matcher the offset-within-level factor collapses to unity, leaving a model driven solely by the cross-level term.

Mapping Back to the Global Linear Rank i—For algorithms that need the one-dimensional ranking used in earlier sections:

$$i = {\sum }_{m < l} {n}_{m} + j ⇒ l = 1 + \frac{1}{γ} ln \frac{{n}_{1}}{{n}_{l}} ,$$

(a) Recap of the ingredients:

| Component | Formula | Parameter |
|---|---|---|
| Level-hit frequency | # of hits(l) ∝ l^{-β} | β > 1 |
| Queue length | nₗ = n₁r^{l-1}, r = e^{-γ} | γ > 0 |

Normalizers:

$${Z}_{lvl} = {\sum }_{m = 1}^{∞} {m}^{- β} \\ {N}_{m ax} = \frac{{n}_{I}}{1 - r} .$$

(b) Conversion of prefix-sum—A resting order with global rank i (1≤i<Nₘₐₓ) sits in the unique price level l that satisfies

$$i = {S}_{l - 1} + j , {S}_{l - 1} = {n}_{1} \frac{1 - {r}^{l - 1}}{1 - r} , 1 \leq j \leq {n}_{l}$$

where Sₗ₋₁ is prefix-sum up to the price level l−1, and j is the offset within the price level l. Here l(i) is defined as the ordinal price level (not an actual price) for rank i, which is a natural number. Therefore, the effect of j inside of logarithm becomes negligible. Solving for l without j gives:

$$l ( i ) = 1 + \frac{ln [ 1 - \frac{( 1 - r ) i}{{n}_{1}} ]}{ln r}$$

because 1≤i<Nₘₐₓ, the value of the bracket is in (0,1) range, which makes the logarithm in the numerator negative. Since ln r=−γ<0, the expression l(i) as whole is well-defined and l(i)≥1 throughout the live book.
(c) Express nₗ and l^{-β} in terms of i—Inserting the l(i) expression in (b) into nₗ=n₁r^{l-1} gives:

$${n}_{l} ( i ) = {n}_{1} {r}^{l ( i ) - 1} = {n}_{1} {r}^{\frac{ln [ 1 \frac{( 1 - r ) i}{{n}_{1}} ]}{ln r}} = {n}_{1} [ 1 - \frac{( 1 - r ) i}{{n}_{1}} ]$$

$$using$$

$${N}_{m ax} = {n}_{1} / ( 1 - r ) , \\ {n}_{l} ( i ) = ( 1 - r ) ( {N}_{m ax} - i ) .$$

For level factor l^{-β}, it is straightforward from the expression in (b):

$${l}^{- β} = {[ 1 - \frac{1}{γ} ln ( 1 - \frac{i}{{N}_{m ax}} ) ]}^{- β} .$$

(d) Assembling pᵢ—Substituting the result of (d) into the result of [0111](b),

$${p}_{i} ( β , γ ) = \frac{1}{{Z}_{lvl} ( 1 - r )} \cdot \frac{{[ 1 - \frac{1}{γ} ln ( 1 - \frac{i}{{N}_{ma x}} ) ]}^{- β}}{{N}_{ma x} - i} .$$

(e) Asymptotic expressions:
Near the top of the book, let x be,

$$x = \frac{i}{{N}_{m ax}} ≪ 1.$$

$$Then ,$$

$$l ( i ) = 1 - \frac{ln ( 1 - x )}{γ} = 1 + \frac{χ}{γ} + O ( {x}^{2} ) , \\ {l ( i )}^{- β} = 1 - \frac{β}{γ} x + O ( {x}^{2} ) , \\ \frac{1}{{N}_{m ax} - i} = \frac{1}{{N}_{m ax}} ( 1 + x + O ( {x}^{2} ) ) .$$

$$Therefore ,$$

$${p}_{i} = \frac{1}{{Z}_{lvl} {n}_{1}} [ 1 + ( 1 - \frac{β}{γ} ) x + O ( {x}^{2} ) ] ( i ≪ {N}_{ma x} ) .$$

In the deeper book, set

$$i = {N}_{m ax} ( 1 - ε ) with ε ↓ 0.$$

$$Then ,$$

$${N}_{m ax} - i = ε {N}_{m ax} ,$$

$$and$$

$$l ( i ) = 1 - \frac{ln ε}{γ} = 1 + \frac{\vert ln ε \vert}{γ} ⇒ {l ( i )}^{- β} \approx {( \frac{γ}{\vert ln ε \vert} )}^{β} .$$

$$Therefore ,$$

$${p}_{i} \approx \frac{1}{{Z}_{lvl} {n}_{1}} \cdot \frac{{( \frac{γ}{\vert ln ε \vert} )}^{β}}{ε} ( i = {N}_{m ax} ( 1 - ε ) , 0 < ε ≪ 1 ) .$$

Hence the tail decays like 1/[ε|ln ε|^{β}], which is considerably flatter than the naive power law l^{-β}. This is because as the book goes deeper, the price level also becomes shorter (nₗ ↓0).

Derivation of Optimal Node Capacity—Based on the probabilistic model derived in the above paragraph, an embodiment may derive the further concrete model as follows:
(a) Probability that a whole node is cached—A node sits in L1 if and only if any order in it was accessed recently. For small probabilities pᵢ, and deeper nodes are assumed to have a small node size kⱼ,

$${P}_{L 1} ( node j ) = 1 - {\prod }_{n = 0}^{{k}_{j} - 1} ( 1 - {p}_{{s}_{j} + n} ) \approx {\sum }_{n = 0}^{{k}_{j} - 1} {p}_{{s}_{j} + n} = {P}_{j} ( {k}_{j} )$$

where sⱼ in this context is defined as the global rank (1-based) of the first order stored in node j. Since every write/delete on an order requires linear adjustment of the entire storage of the node, it's reasonable to assume that every order in the same node has the same cache-hit probability

$${p}_{{s}_{j} + n} = {p}_{{s}_{j}} ( n = 0 , … , {k}_{j} - 1 ) .$$

Summing over the node gives:

$${P}_{j} ( {k}_{j} ) = {\sum }_{n = 0}^{{k}_{j} - 1} {p}_{{s}_{j} + n} = {k}_{j} {p}_{{s}_{j}} .$$

(b) Per-order cost inside node j—Insert the last identity into the equation derived in [0111](a):

$${L}_{i} ( {k}_{j} ) = {Ak}_{j} + [ 1 - {P}_{j} ( {k}_{j} ) ] {t}_{m}$$

where A, tₘ are previously introduced in [0111](a). Except for the additive constant tₘ, the only part that depends on the node size is

$${Δ}_{j} ( {k}_{j} ) = {Ak}_{j} - {P}_{j} ( {k}_{j} ) {t}_{m} .$$

(c) Minimizing Δⱼ(kⱼ) at deep nodes—Translation to computer-executable instructions requires Pⱼ(kⱼ) in closed form. Using the derivation result in [0112] and assuming the node is “thin” compared with its distance from the top (kⱼ<<sⱼ), the following asymptotic expression is achieved for the deep nodes,

$${p}_{{s}_{j}} \approx \frac{{C}_{top}}{1 - \frac{{s}_{i}}{{N}_{m ax}}} {( \frac{γ}{\vert ln [ 1 - \frac{{s}_{i}}{{N}_{ma x}} ] \vert} )}^{β}$$

where, Cₜₒₚ is defined as:

$${C}_{top} := \frac{1}{{Z}_{lvl} {n}_{1}} .$$

Using the result:

$${P}_{j} ( {k}_{j} ) = {\sum }_{n = 0}^{{k}_{j} - 1} {p}_{{s}_{j + n}} = {k}_{j} {p}_{{s}_{j}} gives ,$$

$${Δ}_{j} ( {k}_{j} ) = {k}_{j} [ A - {t}_{m} {p}_{{s}_{j}} ] .$$

Because pₛ_{ⱼ} is already extremely small, there exists a rank s^{†}, such that

$$∃ {s}^{†} s . t . {p}_{s} † = \frac{A}{{t}_{m}} .$$

For every node whose first rank satisfies sⱼ>s^{†},

$${Δ}_{j} ( {k}_{j} ) = {k}_{j} [ A - {t}_{m} {p}_{{s}_{j}} ] > 0$$

the coefficient in the above bracket is positive, which implies

$${k}_{j}^{*} = {k}_{min}$$

as the optimal node size.
(d) The nodes near top of the book—At near the top of the book, the assumption (kⱼ<<sⱼ) no longer holds. Therefore, this case requires a more precise derivation without the linearization. Using ln(1−x)≈−x,

$${P}_{j} ( {k}_{j} ) = 1 - {\prod }_{n = 0}^{{k}_{j} - 1} ( 1 - {p}_{{s}_{j} + n} ) \approx 1 - exp ( - {\sum }_{n = 0}^{{k}_{j} - 1} {p}_{{s}_{j} + n} ) .$$

From the asymptotic expression that was derived in [0112],

$${p}_{i} = \frac{1}{{Z}_{lvl} {n}_{1}} [ 1 + ( 1 - \frac{β}{γ} ) x + 0 ( {x}^{2} ) ] .$$

Because x≈0 at near top of the book, take only O(1) term from above. Also using pₛ_{ⱼ}₊ₙ=pₛ_{ⱼ} for (n=0, . . . , kⱼ−1), gives:

$$1 - exp ( - {\sum }_{n = 0}^{{k}_{j} - 1} {p}_{{s}_{j} + n} ) \approx 1 - exp ( - {k}_{j} {C}_{top} ) .$$

Then, the derivative of Δⱼ is given as:

$$\frac{d {Δ}_{j}}{d {k}_{j}} = A - {t}_{m} \frac{\partial {P}_{j} ( {k}_{j} )}{\partial {k}_{j}} = A - {t}_{m} {c}_{top} exp ( - {k}_{j} {C}_{top} ) ,$$

which crosses zero at

$${k}_{j}^{*} = \frac{1}{{C}_{top}} ln [ \frac{{t}_{m} {c}_{top}}{A} ] .$$

Thus, the optimal top-node size grows logarithmically with tₘ/A, which logically makes perfect sense because,
   (i) a large L1-cache miss penalty tₘ pushes the designer to pack more orders into the top nodes, such that a single cache load amortizes the cost,
   (ii) whereas a large per-shift scan cost A favors smaller nodes to curtail the linear work done on every modification.
Dimension analysis confirms the mathematical soundness of the formula: both tₘ and A are measured in CPU cycles, thus their ratio is dimension-free. Also, Cₜₒₚ is a dimensionless quantity, which in turn confirms

$${k}_{j}^{*}$$

as dimensionless quantity. Therefore, the above formula is well-posed.
(a) Practical caveat for the first few price levels—The derivation relies on the exponential decay nₗ=n₁e^{-γ(l-1)}, which holds empirically deeper in the book. The first one to five ticks of many liquid equities exhibit a “hump”—queue lengths that are longer than the extrapolated exponential. Because the model underestimates the true hit probability for such orders in top nodes, the analytic value

$${k}_{j}^{*}$$

should be treated as a conservative lower bound for the actual top-node size. If tighter sizing is required, replace the exponential tail by a richer density—e.g. a discrete-Gamma fit or a lightweight neural regressor. Either alternative plug seamlessly into the latency formula but introduces additional parameters and runtime cost; the incremental complexity must be weighed against the (usually modest) latency savings.

Machine Learning based Parameter Optimization—In one embodiment, the parameters used in the above (β,γ) can be learned on-the-fly and be optimized to the real time data. Every order hit generated by the matching engine can be immediately turned into one stochastic-gradient step using the otherwise idle SIMD arithmetic units.
(a) Data point definition—For every incoming message or appropriately sampled message that is routed to a resting order an embodiment can log (or generate on-the-fly):

| Symbol | Recorded Value |
|---|---|
| lₜ | Price level index (ordinal rank) of the hit at time t |
| nₗ | Queue length just before the hit (number of resting |
| | orders at that price level) |

(b) Probabilistic model recap—From [0111](b),

$${p}_{θ} ( β , γ ) = \frac{{l}^{- β}}{{Z}_{lvl} {n}_{l}}$$

where nₗ=n₁r^{l-1}, r=e^{-γ} and the Riemann zeta series Z_{|v|} can be approximated by truncating tail terms at certain threshold. The per-event negative log-likelihood is

$${l}_{t} ( θ ) = β ln {l}_{t} + ln {Z}_{lvl} ( β ) + ln ( {n}_{l} ) .$$

(c) Online stochastic-gradient update for (β,γ):
   (i) Gradients

$${\partial }_{β} {l}_{t} = ln {l}_{t} + \frac{{\partial }_{β} {Z}_{lvl}}{{Z}_{lvl}} , {\partial }_{β} {Z}_{lvl} = - {\sum }_{m = 1}^{{M}_{max}} ( ln m ) {m}^{- β} ; {\partial }_{γ} {l}_{t} = {\partial }_{γ} ln ( {n}_{l} ) = - ( {l}_{t} - 1 ) .$$

where Mₘₐₓ is aforementioned truncating threshold. Because ∂_{β}Z_{|v|} only depends on β, an embodiment may cache the series value and its derivative and refresh them every few thousand steps for computational efficiency.
(ii) Adaptive-SGD rule

$${θ}_{t + 1} = {\prod }_{( 1 , ∞ ) \times ( 0 , ∞ )} [ {θ}_{t} - {η}_{t} {g}_{t} ] , {g}_{t} = {( {\partial }_{β} {l}_{t} , {\partial }_{γ} {l}_{t} )}^{T}$$

where ηₜ=η₀/(1+λt) (sliding learning-rate schedule, or Adam if necessary), and Π is a projection operator onto the admissible region β>1, γ>0.
(d) Lightweight streaming alternative for γ—Since the queue length process {nₗ} evolve much more slowly than hit locations, an embodiment may instead, estimate γ by running regression of ln nᵢ on l. Then,

$$ln {n}_{l} = ln {n}_{1} - γ ( l - 1 ) + {ε}_{l} .$$

Maintain exponentially weighted moments (Welford update, weight α<<1):

$${\overline{l}}_{t} = {\overline{l}}_{t - 1} + α ( {l}_{t} - {\overline{l}}_{t - 1} ) ,$$

$${\overline{y}}_{t} = {\overline{y}}_{t - 1} + α ( ln {n}_{{l}_{t}} - {\overline{y}}_{t - 1} ) ,$$

$${S}_{ll , t} = ( 1 - α ) ( {S}_{ll , t - 1} ) + α ( {l}_{t} - {\overline{l}}_{t - 1} ) ( {l}_{t} - {\overline{l}}_{t} ) ,$$

$${S}_{ly , t} = ( 1 - α ) ( {S}_{ly , t - 1} ) + α ( {l}_{t} - {\overline{l}}_{t - 1} ) ( ln {n}_{{l}_{t}} - {\overline{y}}_{t - 1} ) ,$$

where S_{il,t} is weighted variance accumulator of price levels, and S_{ly,t} is weighted covariance accumulator between level and log-depth. Then,

$${γ}_{t} = - \frac{{S}_{ly , t}}{{S}_{ll , t}} ( e . g . , α \approx {10}^{- 5} for \sim 0.1 s half life ) .$$

This estimator can run in parallel with the SGD step for β.
(e) Alternative estimator families—In lieu of or in addition to the scalar-parametric updates described above, an embodiment may employ any supervised, unsupervised, semi-supervised, reinforcement-learning, or online-learning estimator to map runtime features (e.g., depth, queue length, volatility, time-of-day embeddings) to either
   (i) the model parameters, such as β,γ of the exemplary node-hit probability model; or
   (ii) a direct prediction of node-hit probability Pⱼ(kⱼ) and/or the optimal node capacity

$${k}_{j}^{*} .$$

Non-limiting examples include: multi-layer perceptrons and other deep feed-forward neural networks; convolutional or recurrent nets; transformer-style feed-forward layers; gradient-boosted decision trees, boosted regression trees, random forests; linear and generalized-linear models with regularization (ridge, lasso, elastic-net); kernel machines (e.g., support-vector regression/classification); Gaussian-process regressors; mixture-of-experts; contextual bandits; and policy-gradient or value-based reinforcement-learning controllers. The estimator choice is implementation-dependent and non-limiting; outputs are post-processed, if needed, to satisfy the admissible region β>1, γ>0 and the monotone non-increasing capacity constraint

$${C}_{0} \geq {C}_{1} \geq {C}_{2} \geq ⋯ .$$

(f) Training regimes (online, incremental, batch)—The learning component may be trained online (e.g., per-event stochastic updates), incrementally (e.g., histogram-based boosting rounds added as data accumulate), or offline in mini-batches, with the controller applying updated parameters or models between batches subject to the rate-limiting and A-change constraints that bound tail latency during reconfiguration. For non-differentiable estimators (e.g., boosted trees, random forests), fitting may occur on a sidecar thread or process, with the active model swapped in atomically at batch boundaries to preserve determinism.
(g) Estimator-agnostic controller contract—Regardless of estimator family, the controller exposes a uniform interface that
   (i) reads telemetry and model outputs;
   (ii) computes the optimal node capacity

$${k}_{j}^{*}$$

or its model parameters such as β,γ of the exemplary node-hit probability model;
(iii) projects the results into the admissible set β>1, γ>0 and enforces monotonicity of capacity as a function of depth; and
(iv) applies changes only between batches with a maximum permitted change of Δ slots per update interval, thereby preserving the latency bound during reconfiguration.
If the ML controller is disabled or out-of-bounds, a static policy (e.g., geometric taper 64→32→16→8) is used, which remains within scope.

Integration with Node-size Controller—In one embodiment, the node-size update algorithm may operate as follows: at each T_{rebalance} interval (for example, every 10 ms or after 100,000 processed messages), the controller reads the latest parameters and computes an updated optimal node capacity k* for each Data Holder Node. Parameter updates are rate-limited and applied only between batches, and the controller is configured such that the node capacity cannot change by more than Δ slots per T_{rebalance} interval, thereby guaranteeing a bounded tail latency during reconfiguration. If k* differs from the current capacity by more than a predetermined threshold (for example, two or more slots), the system resizes the Data Holder Nodes by
(a) dynamically allocating new Data Holder Nodes in each memory pool based on the updated capacity, and
(b) retiring or recycling Data Holder Nodes whose capacities no longer conform to the updated setting.
   If the machine-learning-based controller is disabled or diverges from acceptable operating bounds, a static policy (for example, a geometric taper sequence of 64→32→16→8) may be employed instead; such a static policy remains within the scope of the invention.

Memory Allocator Integration—In one embodiment, the core-local memory pool may pre-carve a fixed set of node-size classes—such as 8-slot, 16-slot, 32-slot, and 64-slot Data Holder Nodes—during start-up. When the order book requires growth or shrinkage, the engine can replace a node by swapping in a pre-built instance through a pointer swap, thereby avoiding the latency of a heap allocation. Where hardware constraints or memory-footprint considerations favor precise sizing, the same allocator may synthesize a node on demand by drawing from its huge-page arena and constructing only the capacity actually required. Both allocation paths may operate from the same lock-free pool, permitting implementers to combine them—for example, favoring pre-allocation on latency-critical symbols while biasing toward just-in-time allocation where cache size, TLB coverage, or order-flow volatility make finer granularity more efficient.

SIMD and Low-Precision Packing in Estimator Implementations—In embodiments where the estimator admits vectorized arithmetic, scalar parameters or intermediate statistics may be stored in reduced-precision formats such as FP16 or bfloat16, with accumulators retained in FP32 to avoid numerical overflow. Implementations may pack a full SIMD register of reduced-precision values and apply updates with a single vector operation. Non-limiting examples include:
(a) on x86-64, AVX-512FP16 fused multiply-add (e.g., vfmadd132ph) and AVX-512 BF16 dot-product (e.g., vdpbf16ps); and
(b) on Armv8 NEON or SVE, fused multiply-add (fmla) and widened accumulate (fmlal), and where available, BF16 dot-product (bfdot).
   Where native FP16/BF16 arithmetic is unavailable, operands may be widened to FP32 for computation and compacted for storage/transport. For estimators based on decision trees or ensembles, statistics such as histogram bins, gradient/Hessian sketches, split scores, or leaf values may likewise be stored in reduced precision, or computed in FP32 and compacted for transport. These optimizations are optional and do not constrain the choice of estimator or model family; they may be enabled via compile-time flags and/or run-time feature detection (e.g., CPUID) so that the same source builds and dispatches for AVX-512, AVX2, NEON, or SVE without altering estimator semantics.

Together, the bitmask abstraction delivers pointer-management in constant time, saves cache space, and maintains the strict latency budget demanded by high-performance matching engines.

Introduction of Improved Balanced-search Tree—In one embodiment, the matching engine represents each active price level as a Price Level Descriptor in a balanced search tree—preferably a red-black tree, although any other balanced search tree functions equivalently, and not limited to binary search trees. The engine inserts a new price level only when the book receives the first order at a previously empty level, and it removes a price level only when the last order at that level cancels or executes. In an embodiment, the balanced search trees implemented inside of the matching engine tracks the in-order predecessor and successor of every active price level, the tree algorithms accept those two pointers as explicit parameters. Supplying this contextual knowledge collapses the conventional O(log n) search phase to O(1) in most cases; the algorithm does not have to descend the tree to locate an insertion gap or an in-order successor for deletion.

Formal Model of the Price Level Manifold and its Tree Embedding—
(a) The ordered price group: Let,

$$( ℙ , + , 0 , \leq )$$

be a countable, totally ordered Abelian group that is Archimedean-embedded in

$$( ℚ , + , 0 , \leq )$$

i.e., ∀p, q∈ [symbol] , ∃n∈ [symbol] :np≥q. No multiplicative structure is postulated here. The discreteness assumption

$$∀ p ∈ ℙ , ∃ ε > 0 : ( p - ε , p + ε ) ∩ℙ = \{ p \}$$

reflects that price ticks are quoted on a lattice of minimal quantum δ>0.
(b) Descriptor Fiber bundle: Define the order-descriptor bundle

$$π : 𝒟 \to ℙ , {π}^{- 1} ( p ) = \{ non - empty FIFO list of orders at price p \} .$$

For each exchange event time t∈ [symbol] _{≥0} the limit-order book is the partial section

$${σ}_{t} : ℙ \to 𝒟 , supp {σ}_{t} := \{ p \vert \vert {σ}_{t} ( p ) defined \} ,$$

which is finite because of bounded standing-order capacity. Equip supp σₜ with the sub-order inherited from [symbol] .
(c) Functional embedding into a category: Consider the category

$${BalBST}_{h} = \{ T = ( V , E , root ) \vert T is a binary search tree and height ( T ) \leq h \} ,$$

with morphisms the order- and ancestry-monotone embeddings/quotients described in Appendix C. Fix a balancing scheme [symbol] ∈{red-black, AVL, weight-balanced, chromatic, . . . }. Then, write

$${ε}_{ℬ} : ( \begin{matrix}Finite , totally ordered sets \\ ( S , \leq )\end{matrix} ) \to {BalBST}_{O ( lo g \vert S \vert )}$$

for the canonical balanced-tree functor that inserts the elements of S in increasing order while continuously re-balancing under [symbol] . The state of the book at time t is then the object

$${T}_{t} := {ε}_{ℬ} ( supp {σ}_{t} ) .$$

Crucially, the in-order traversal

$$𝒾 : V ( {T}_{t} ) \to supp {σ}_{t}$$

is an order-isomorphism; however, the edge set E(Tₜ) stores balancing information only and is generally not the Hasse diagram of (supp σₜ, ≤).

### Neighbor-Aware Insertion, Rigorous Specification—

(a) Definition.
Neighbor-aware insertion is performed by splicing a new price level at the unique parent location determined by its in-order neighbors at the lowest common ancestor, using a bounded number of reference writes, independent of the number of price levels stored in the tree, and then rebalancing along a single root-to-leaf path via local transforms.
(b) Path-minimum lemma.
Let p∈ [symbol] \supp σₜ and suppose both of its immediate neighbors with respect to \ supp σₜ are existing and known:

$$P = {max}_{q} \{ q < p \} , S = {min}_{q} \{ q > p \} , where q ∈ supp {σ}_{t} .$$

Then, exactly one pointer in the set {right(P), left(S)} is ⊥ (null), and that null slot is the unique parent location for inserting p that preserves the binary search tree property.
(c) Proof to the lemma.
Because P<S and there is no key strictly between them, every key in the right-subtree of P is ≥S; dually, every key in the left-subtree of S is ≤P. Therefore,

$$right ( P ) \neq ⊥ ⇒ min ( right ( P ) ) = S ⇒ left ( S ) = ⊥ ,$$

and vice-versa. Uniqueness follows because two simultaneous nulls would contradict the strict ordering triple P<p<S. This is even more obvious when considering the lowest common ancestor

$$A = LCA ( P , S )$$

which is necessarily either P or S. If A≠{P, S} then

$$key ( P ) < key ( A ) < key ( S ) ,$$

which contradicts the assumption that no key lies strictly between P and S. Therefore, exactly one of P, S is the ancestor; the other is descendant located in the corresponding child-side subtree. When A=P, min(right(P))=S and left(S) must be null, otherwise there would be another key that separates P and S. The symmetric argument applies to the case A=S. All statements combined, validate that exactly one pointer in the set {right(P), left(S)} is null.
(d) Exemplary neighbor-aware splice algorithm.
Define the following

$$\text{?} ( p , P , S ) : {T}_{t} \to {T}_{t} ⋃ \{ p \}$$

$$by$$

$$\text{?} ( p , P , S ) = \{ \begin{matrix}right ( P ) := {Z}_{p} , & if right ( P ) = ⊥ \\ left ( S ) := {Z}_{p} , & otherwise\end{matrix}$$

where Zₚ is defined as the pointer address of p. In the actual implementation, Zₚ is a pointer to the Price Level Descriptor that corresponds to the price level p. The application is straightforward; apply the operator [symbol] (p, P, S) when the in-order neighbors P, S are known. By Lemma in (a), this writes ≤2 pointers (not including the in-order traversal Prev and Next pointers, which would still be bounded by a constant if included) and costs O(1). After splicing, invoke the rebalance transducer

$${ℛ}_{𝔅} : T \to T , height ( {ℛ}_{𝔅} ( T ) ) \leq {𝒞}_{𝔅} log \vert {V}_{T} \vert ,$$

where [symbol] _{RBT}=2 for red-black trees, and [symbol] _{AVL}≈1.44 (using base-2 logarithm). Hence,

$${T}_{insert} ( \vert {V}_{T} \vert ) = {\underbrace{O ( 1 )}}_{splice} + {\underbrace{O ( log \vert {V}_{T} \vert )}}_{rebalance} .$$

If either neighbor is not supplied, the matching engine defaults to a root-to-leaf search costing O(log|V_{T}|), thus the algorithm degrades gracefully.
(e) Exemplary handling of boundary cases.
The algorithmic complexity bound still applies the same in the boundary cases.
   (i) Leftmost insert (P=⊥):then left(S)=⊥ and p splices as S's left child (left(S):=Zₚ).
   (ii) Rightmost insert (S=⊥):then right(P)=⊥ and p splices as P's right child (right(P):=Zₚ).
   (iii) Empty tree (P=⊥,S=⊥):p becomes the root.
(f) Application to the matching engine.
During the insertion workflow shown in FIG. 7—whether invoked by a fresh order ([0077]-[0081]) or by a modification that re-inserts an order ([0083])—control ultimately reaches either block 705 or 706:
   (i) Block 706 with case 702=true (the tree of Price Level Descriptors is empty). Because no Price Level Descriptors are present, the incoming node becomes the root and no rebalancing is required.
   (ii) Path from block 703 to block 706. The matching engine already holds references to the highest-priority Price Level Descriptors (elements 803 and 804 in FIG. 8). Each descriptor maintains direct previous and next pointers to its in-order neighbors, enabling constant-time identification of the parent slot. The splice itself therefore costs O(1), followed by an O(log|V_{T}|) rebalancing step.
   (iii) Path from block 704 to block 706. The absence of a Price Level Descriptor at the target price has already been confirmed—either by the preceding traversal of the descriptor tree (which surfaced elements 802 and 805 in FIG. 8) or by a lookup in the auxiliary hash map referenced in [0077]. That same search returns the immediate in-order predecessor and successor, allowing the neighbor-aware splice to be executed in constant time. Consequently, only the O(log|V_{T}|) rebalancing step remains.
   (iv) Block 705. This is the sole path that attaches the incoming order to the existing price level, which do not require modification of the Price Level Descriptor tree.
(g) Scope note—illustrative store counts. Where this section or its examples enumerate a particular number of reference writes (e.g., “≤4 stores”), those counts illustrate one canonical script; the limiting definition is the genus statement above: neighbor-aware insertion uses a bounded, constant number of reference writes confined to a single ancestor path, followed by local transforms. Functionally equivalent scripts that group or split primitives may differ by a constant without departing from this disclosure.

Neighbor-Aware Deletion, Successor-Graft Calculus—
(a) Definition.
Neighbor-aware deletion (successor-graft) is performed by replacing a designated node with its in-order neighbor (the successor, or the predecessor when the designated node's key is rightmost) using a bounded number of reference writes, independent of the number of price levels stored in the tree, and then rebalancing along a single root-to-leaf path via local transforms.
(b) Notation and primitives: For any node v write,
   (i) par (v): parent pointer, possibly ⊥ (null pointer) if v is the root;
   (ii) left (v), right (v): child pointers, also possibly ⊥.
Define three constant-time primitives (each performs ≤2 pointer stores, not including Prev/Next pointer adjustments for the in-order neighbors, which would still be bounded by a constant if included), where each arrow means value assignment in the following table:

| Symbol | Effect on pointers | # of stores |
|---|---|---|
| Transplant(u, v) | childpar(u) ~ v; par(v) < par(u) | ≤2 |
| Attach_L(u, v) | left(u) < v; par(v) - u | 2 |
| Attach_R(u, v) | right(u) ~ v; par(v) - u | 2 |

All primitives treat ⊥ on the right-hand side as no-op store.
(c) Piecewise successor-graft: Let Z be the node to delete, supplied by the caller together with its in-order successor Y. Two mutually exclusive cases exhaust the topology of Y.
(d) Case A—Successor is the direct right child:

$$Y = right ( Z ) ,$$

$${SG}_{A} ( Z , Y ) = Transplant ( Z , Y ) ◦ Attach\_L ( Y , left ( Z ) ) .$$

which has pointer cost of Transplant+Attach_L≤4 stores. No aliasing arises because the original right(Z) is now the root of the graft and is never re-attached to itself.
(e) Case B—Successor is deeper in the right subtree:

$$Y \neq right ( Z ) .$$

In this case, let P=par(Y) (which necessarily P≠Z). The standard algorithm removes Y from its current position, fills the gap with right(Y), then transplants Y to Z's position and attaches both of Z's subtrees.

$$S {G}_{B} ( Z , Y ) = Transplant ( Y , right ( Y ) ) ◦ Attach\_R ( Y , right ( Z ) ) ◦ Transplant ( Z , Y ) ◦ Attach\_L ( Y , left ( Z ) )$$

which has pointer cost of 2 Transplant+Attach_R+Attach_L≤8 stores. Ordering guarantees that each pointer read in a later primitive still contains its original value:
   (i) right(Y) is read before any primitive modifies it;
   (ii) right(Z) and left(Z) are untouched until they are moved under their new parent Y.
(f) Case C—Z has no successor:

$$Y = ⊥ .$$

In this case, there is no in-order successor to Z and, by definition, Z has no right child. Then, the deletion reduces to the one-child/leaf case handled in the usual binary search tree delete routine. Formally,

$$S {G}_{C} ( Z ) = Transplant ( Z , left ( Z ) ) .$$

The Transplant overwrites the appropriate child pointer of par(Z) and, if left(Z)≠⊥, updates par(left(Z)). Thus [symbol] has a pointer cost of at most 2 stores (only one store when left(Z)=⊥).
(g) Exemplary Successor-Graft algorithm—The algorithm becomes

$$S G ( Z , Y ) = \{ \begin{matrix}{SG}_{A} ( Z , Y ) , & Y = right ( Z ) \\ {SG}_{B} ( Z , Y ) , & Y \neq right ( Z ) \\ {SG}_{C} ( Z ) , & Y = ⊥\end{matrix} .$$

The application of the operator is just as straightforward as it is for the neighbor-aware insertion case. It is applied using the point of deletion, Z, and its in-order successor, Y.
(h) Complexity and correctness.
The following statements hold
   (i) Lookup phase: if both pointer addresses Z, Y are supplied⇒O(1).
   (ii) Pointer rewrites: constant (at most 8 stores).
   (iii) Balancing fix-up: Let T⁻=Tₜ be the state of the tree before the operation and T⁺=SG(Z, Y)(Tₜ) be the state immediately after the graft. The set of red-black invariants i_{RBT}, is preserved throughout the tree except, at most, locally at the original position of the successor Y; this statement holds for other balancing schemes, such as AVL balance factor. To restore the invariants, a classical delete-fixup algorithm is invoked. This process traverses a single ancestor path from the point of the local violation up to the root, which has a maximum length of O(log|V_{T}|). Along this path, it performs a constant amount of work per node (e.g., rotations and color changes). The worst-case for this fix-up is therefore O(log|V_{T}|), matching the neighbor-aware insertion bounds.
(i) Application to the matching engine.
The neighbor-aware deletion routine is invoked when a Price Level Descriptor becomes empty—more commonly after an order is cancelled or modified, and less frequently when the remaining quantity at that price is fully executed. Because each descriptor stores direct pointers to its immediate in-order predecessor and successor, the matching engine can supply the addresses of the descriptor to be removed (Z) and its in-order successor (Y, if any) to the successor-graft operator without first traversing the Price Level Descriptor tree. The graft rewrites at most eight pointers in constant time; when Y is absent (Case C), the cost drops to at most two pointer stores. (not accounting the Prev, Next pointer adjustment costs) A standard delete-fixup walks up a single ancestor path to restore the tree's balancing invariants, performing O(log|V_{T}|) work. Consequently, the end-to-end cost of excising a Price Level Descriptor is bounded by

$${T}_{Delete} ( \vert {V}_{T} \vert ) = {\underbrace{O ( 1 )}}_{successor - graft ( SG )} + {\underbrace{O ( log \vert {V}_{T} \vert )}}_{rebalance} ,$$

matching the complexity guarantee established for neighbor-aware insertion.
(j) Scope note—illustrative store counts. The “≤4/≤8/≤2 store” tallies in Cases A-C enumerate one canonical realization using the primitives in (b). Implementations that, for example, coalesce parent/child updates, mask writes to ⊥, or maintain Prev/Next links inline may adjust the constant. The normative requirement is the section's opening definition: neighbor-aware deletion is realizable with a bounded, constant number of reference writes confined to a single ancestor path, with subsequent local fix-up.

Mathematical Background and Scope—The neighbor-aware insertion/deletion framework is not confined to binary search trees; it applies across the family of balanced search trees, including binary and m-ary variants. The formal reasoning establishing this generality appears in Appendix C and is illustrative and non-limiting—it does not prescribe a particular tree. In practice, the engineering procedure is straightforward: when predecessor and successor links are available, perform insertion by splicing the new node in O(1) time and perform deletion by grafting the in-order successor or predecessor (i.e., replacing the target node with its in-order neighbor) in O(1) time; in both cases, follow with the tree's standard O(log n) rebalancing. A person having ordinary skill in the art can readily express analogous update equations for common variants—red-black, AVL, B/B+-tree, weight-balanced, and later-developed balanced trees—directly from their textbook insertion/deletion routines, without reference to the formal proofs in Appendix C. Because enumerating procedures for every variant would be impractical, this specification provides a general proof of applicability together with representative procedures.

Exemplary Procedures for the Multi-way Trees—See Appendix C (EQ-BST morphisms and corridor locality) for the general proof.
(a) Neighbor-aware insertion.
In an m-ary EQ-BST, the interval (P,S) selects a unique gap at

$$α = {LCA}_{T} ( {loc}_{T} ( P ) , {loc}_{T} ( S ) ) ;$$

where loc_{T}(k) is the unique node of T containing key k. The splice descends into exactly one child toward that gap.
(b) Neighbor-aware deletion (successor-graft).
To delete key z choose y=succ_{T}(z) (or y=pred_{T}(z) if z is rightmost). The pair (z,y) determines a unique corridor anchored at

$$α = {LCA}_{T} ( {loc}_{T} ( z ) , {loc}_{T} ( y ) ) .$$

Replace z by y with a constant number of pointer rewrites inside the subtree of α; repair any underflow by sibling borrow/merge along that corridor bottom-up toward the root.

Embedding/quotient-morphism Balanced Search Tree—As used herein, an “Embedding/quotient-morphism balanced search tree” (hereunder EQ-BST) is a search tree that:
(a) preserves the in-order key sequence during any rebalancing operation;
(b) performs rebalancing via local, structure-preserving transforms (e.g., rotations; re-colorings; split/merge/borrow/redistribute; separator promote/demote) that modify at most a constant number K of nodes or pages per transform, where K is independent of the number of stored keys n; and
(c) maintains height O(log n).
   Structures whose rebalancing includes subtree rebuilds that modify more than a constant number of nodes in a single operation (e.g., scapegoat-style rebuilds) are not EQ-BSTs for purposes of this specification. Such rebuilds must not be confused with the ordinary fix-up walk in balanced trees within the EQ-BST category, where rebalancing is carried out as a sequence of local transforms along the update-to-root path—each transform touches at most a constant number K of nodes, although the walk may span O(log n) levels. A further rigorous formalization is presented in Appendix C as BalST^{emb/epi} category of trees (illustrative; non-limiting).

Terminology—“page” (multi-way tree). As used herein for B/B+-tree embodiments, a “page” means a tree node (leaf page or internal page) that stores an array of keys and, for internal pages, child references. “Page-local” describes edits whose writes are confined to a single page and, if minimum-degree constraints require, one sibling and the parent along the update-to-root corridor anchored at the LCA; these transforms include insert, remove, borrow, merge, and redistribute and preserve in-order sequence with rebalancing along at most one root-to-leaf path. The term does not denote OS or hardware memory pages (e.g., 4 KB, 2 MB huge pages) used by the memory allocator elsewhere in this specification.

Application of the Generalized Balanced Tree Category—The neighbor-aware insertion and deletion primitives lift from the binary case to embedding/quotient-morphism balanced search trees (EQ-BSTs) without change. This is because these operations rely only on in-order traversal and subtree ancestry relationships, properties which remain invariant under the broader class of structure-preserving embedding or quotient morphisms allowed in the EQ-BST category.
(a) The following non-exhaustive, illustrative instances of EQ-BST:
   (i) Balanced binary search trees: red-black, AVL, weight-balanced, and their top-down 2-3-4 encodings;
   (ii) B-trees of arbitrary order—from 2-3-4 trees and 2-4 trees up to high-fan-out page-oriented variants;
   (iii) B+-trees, where keys reside in leaves and internal nodes hold only separators;
   (iv) B*-trees, which postpone splits by redistributing keys between siblings to improve space utilization;
   (v) B-link trees and blink-balanced trees, whose extra right-sibling pointers support concurrent updates without global locks;
   (vi) (a,b)-trees in their many fixed-degree specializations, such as 2-3 trees, 3-5 trees, and 4-7 trees;
   (vii) Fractal trees and Bε-trees, which choose m and d to maximize write buffering while still meeting the category's balance constraints;
   (viii) Cache-oblivious B-trees (e.g., van Emde Boas-layout trees) where fan-out is tuned implicitly by the memory hierarchy but remains bounded between d and m;
   (ix) Prefix B-trees and compressed-key B-trees that store only compressed discriminators in internal nodes;
   (x) UB-trees and other space-filling-curve indexes that keep z-values in multi-way balanced nodes.
(b) The next list captures probabilistic structures that are not in the EQ-BST category in a deterministic sense, but exhibit the same behavior in expectation:
   (i) Classical Binary Treap—a binary search tree (BST) ordered by key, with a heap ordering by a random priority at each node;
   (ii) Generalized Multiway Treap—a multiway search tree (analogous to a B-tree) that uses randomness (e.g. random priorities or skip-list style promotions) to maintain balance. Examples include skip trees (randomized multiway trees derived from skip lists) and B-Treaps (randomized B-tree analogs).
      For every structure in the first list (a)—and, for the second list (b), with high probability under their standard randomness assumptions—the matching engine can obtain the in-order predecessor and successor of a located price level in O(1) time (via maintained neighbor links), then perform the necessary splice, split, merge, or borrow using a constant number of pointer writes. The subsequent rebalancing touches at most one root-to-leaf path, preserving the overall bounds:

$${T}_{Insert} ( n ) = {\overbrace{O ( 1 )}}^{splice} + {\overbrace{O ( log n )}}^{rebalance} ,$$

$$and$$

$${T}_{Delete} ( n ) = {\underbrace{O ( 1 )}}_{successor - graft ( SG )} + {\underbrace{O ( log n )}}_{rebalance} .$$

These bounds are independent of whether the book is maintained as a binary tree, a high-fan-out B+-tree, or any other member of the EQ-BST category, and they extend to the randomized structures in the expected-case sense.

Hardware Accelerator Overview—In one embodiment, the price level indexing and maintenance logic described in [0119]-[0127] is realized as a dedicated order book accelerator (“OBA”) that operates on price level metadata only and stores no order objects. The OBA comprises:
(a) descriptor memory implemented as a contiguous array of fixed-size Price Level Records;
(b) tree logic that represents those records as nodes of a balanced search tree keyed by price;
(c) neighbor-link registers that hold per-node predecessor/successor references;
(d) an insertion pipeline that performs the neighbor-aware splice of [0121];
(e) a deletion pipeline that performs the successor-graft of [0122]; and
(f) a fix-up micro-sequencer that executes constant-size local transforms (rotations, recolorings, split/merge/redistribute, or height updates) along at most a single root-to-leaf path, consistent with the EQ-BST discipline of [0125]-[0127] and the procedures summarized at [0124].
   The accelerator services one symbol (instrument) per core to preserve time priority and may be instantiated in multiple copies to process multiple symbols in parallel.

Price Level Record Layout—As used herein, ‘Price Level Descriptor’ (software) and ‘Price Level Record’ (hardware) denote corresponding representations of the same price level metadata. For binary EQ-BST variants (e.g., red-black, AVL, weight-balanced), each record occupies a fixed-size slot in descriptor memory and includes at least:
(a) price (or tick index as defined in [0136]);
(b) aggregate quantity;
(c) left-child, right-child, and parent references (genus “reference” per [0045], e.g., index/handle into the descriptor array); and
(d) predecessor and successor references that realize the in-order neighbor links used by [0121]-[0122].
   For B/B+-tree variants, price level records occupy the leaf level and include price, aggregate quantity, and leaf-sibling (prev/next) links; internal page nodes separately hold arrays of keys and child references (see [0131]). To enable page-local transforms, each leaf record additionally stores a leaf-container reference (a handle to its owning internal page) and, optionally, a slot-in-page subindex. Optional fields include a side flag (bid/ask) and cached best-of-book marks to speed extrema updates (see [0075] and FIG. 8 elements 803/804). Writes to any single field are performed as one word write when the field is word-aligned and the memory supports byte/word enables; otherwise the update completes in one or a few cycles using a bounded sequence of word writes.

Descriptor Memory and Banking—The descriptor memory is realized as multi-banked SRAM (or equivalent on-chip RAM) comprising M banks with interleaved addressing on the record index. Each record is RAM-word/burst aligned and may occupy an integral number of RAM words. A read or write of one record completes in one or a few cycles, subject to port and bank availability; implementations may use dual-ported or multi-ported macros where available. Bundles of dependent fields (e.g., parent and one child) can be fetched in parallel when they map to distinct banks; otherwise, they are issued over successive cycles. Banking parameters (M, interleave stride) are design-time or configuration-time constants and do not constrain the EQ-BST discipline. The constant bounds cited herein apply to the number of distinct reference fields edited per operation; elapsed cycles may exceed one due to port/bank scheduling in this SRAM. The contiguous, fixed-slot layout mirrors the contiguous, fixed-size pools described for software in [0069]-[0073].

Tree Logic and Local-Transform Fix-Up—The OBA implements any embedding/quotient-morphism balanced search tree (EQ-BST) per [0125]-[0127]. For binary EQ-BSTs (e.g., red-black, AVL, weight-balanced), the record layout of [0129] applies and the fix-up micro-sequencer issues RotateL, RotateR, Recolor, and HeightAdj micro-ops, each touching a constant number of nodes along at most one root-to-leaf path. For B/B+-tree variants, price level records reside in the leaf level, while separate internal page nodes hold arrays of keys and child references; the fix-up micro-sequencer applies constant-size local transforms at the page granularity (e.g., split/merge/redistribute) that preserve in-order sequence per [0124]. The leaf container reference ([0129]) allows fix-up to locate and modify the owning page without a scan.

Neighbor-Aware Insertion Pipeline—When the host supplies the in-order predecessor P and successor S for a missing price (as in [0121]), the OBA executes a four-stage insertion:
(a) Allocate a free record slot and stage its address (reference) in a pipeline register;
(b) Attach the record as the null child of exactly one of {right(P), left(S)} according to the path-minimum lemma at [0121](b)-(c);
(c) Update neighbor links (Prev/Next) for the new node and its two neighbors with a constant-bounded number of stores (bound is on fields touched); and
(d) Schedule fix-up on the unique update-to-root path via local transforms.
   If hints are absent or fail validation against current links, the OBA finds P and S by an internal tree search in O(log n) and then proceeds; the number of reference fields written prior to fix-up remains constant-bounded, independent of the number of records.

Successor-Graft Deletion Pipeline—When the host supplies a node Z to remove and its in-order successor Y, the OBA performs the piecewise successor-graft of [0122](d)-(g). The pipeline executes the primitive Transplant, Attach_L, and Attach_R edits, each a constant-size pointer rewrite, and then invokes delete-fix-up along one root-to-leaf path. Definition (for clarity): childpar(u) writes left (par(u)) if u is its parent's left child; otherwise, it writes right (par(u)). If Y is not supplied or is stale, the OBA locates Y internally in O(log n) and proceeds. Prev/Next neighbor links are adjusted with a constant-bounded number of stores; pointer rewrite counts remain independent of book size.

Extrema Registers and Snapshots—The OBA maintains Best-Bid and Best-Ask registers that point to the current extrema records, permitting constant-time retrieval of top-of-book. The host may request depth snapshots computed solely from records by traversing successor links from an extremum. Snapshots use a quiescent cut: the OBA captures the extremum reference and a monotonic snapshot epoch; traversal follows successor links visible under that epoch. Implementations may use a read fence or per-node version counters (seqlock pattern) to avoid torn reads during concurrent maintenance: pointer rewrites publish under a commit epoch, and readers either (i) consult a shadow image at/before that epoch or (ii) validate identical version reads before/after traversal.

Host Interface—A memory-mapped or message-based host interface accepts price level update messages (create/increment/decrement/remove) and optional neighbor hints (P,S,Y). Hints are validated against current links; on mismatch the OBA disregards the hint and returns a diagnostic code while completing the operation. The interface complements the lock-free queues already disclosed ([0046]-[0047], [0084]-[0087] and preserves the single-thread-per-symbol sequencing semantics.

Tick-Indexed Comparators—Prices inhabit a discrete tick lattice as stated in [0120](a). In hardware, comparisons may be performed on an integer tick index

$$k = ⌊ \frac{P - {P}_{0}}{δ} ⌋$$

where P₀(base price) and δ (tick size) are programmable OBA configuration registers. Each record may store k directly or compute it on ingress using integer fixed-point (e.g., reciprocal-multiply+shift); comparator parameters are fenced when P₀ or δ change to avoid races with in-flight compares. The tree key is either P or k, with an order isomorphism between them for fixed P₀, δ. When the tree key is P, changing P₀ or δ updates only comparator parameters and does not disturb the in-order sequence. When the key is stored k, changing P₀ or δ requires re-deriving keys or rebuilding to preserve order.

Coherency and Hazard Detection—In one embodiment, the OBA processes exactly one update at a time per symbol. In variants that allow limited overlap, a coherency module prevents conflicting edits by (i) scoreboarding nodes that may be touched by the structural edit and its fix-up, i.e., Z, Y, P, S and the nodes on the selected fix-up corridor toward the root, (ii) rejecting or deferring a message that would alias any currently claimed node or its Prev/Next neighbors, and (iii) committing the set of pointer updates as a read-modify-write transaction that either completes in full or is retried. The corridor is discovered incrementally during the ascent; the scoreboard extends the claim one node at a time. Host reads are either stalled or routed to the pre-commit image to prevent torn observations.

Atomic Word Updates (Software Variant)—Although the core matcher is single-threaded per symbol, an embodiment that permits concurrent maintenance (e.g., maintenance thread or multi-symbol service) performs each reference edit (left, right, parent, prev, next) as a single-word atomic read-modify-write, for example compare-and-swap (CAS) or load-linked/store-conditional (LL/SC), with release/acquire ordering analogous to the lock-free queues ([0084]). Under contention, retries may be unbounded; the design targets obstruction-free or lock-free progress rather than wait-free bounds. Primitive counts bound the number of distinct fields to update per operation, not the retry count under contention.

Aggregate-Quantity Semantics—The aggregate quantity field of a record is updated by a single word-sized store when only the owner thread mutates it, or by CAS when concurrent writers may race (e.g., asynchronous decrement by a separate execution unit). The value is application-level and does not participate in tree balancing; therefore, its atomicity is independent of the structural pointer edits above.

Reconfigurable-Logic Realization—In one embodiment, the OBA is implemented in reconfigurable logic (e.g., FPGA). A configuration image (bitstream) defines: (i) the descriptor memory (bank count, record size, interleave); (ii) tree logic and the fix-up micro-sequencer for the selected EQ-BST discipline; (iii) neighbor-link registers; (iv) the insertion and deletion pipelines; (v) the coherency module; (vi) the tick-comparator parameters; and (vii) the host interface registers and message formats. Loading the configuration image instantiates a complete OBA instance that performs neighbor-aware splice and successor-graft followed by local-transform rebalancing using references as defined at [0045]. The host interface includes CDC synchronizers for multi-clock deployments.

Micro-Architectural Variants—The configuration image may select among red-black, AVL, or B/B+-tree balancing at synthesis time, or expose a microcode table of local transforms that a privileged agent can patch while the engine is quiescent (or via shadow-update with an atomic switch) within predefined safety bounds. The observable behavior at the host interface remains a balanced search tree that preserves in-order key sequence and bounds fix-up to a single root-to-leaf path.

Constant-Bounded Structural Edits—For both hardware and software embodiments, attaching a new node with known neighbors ([0121]) or grafting a successor ([0122]) is realized as a bounded, constant number of single-word reference stores before any rebalancing step. Neighbor-link (Prev/Next) adjustments likewise complete in a constant-bounded number of stores per link. These bounds apply to the number of distinct reference fields edited per operation and are independent of book size; elapsed cycles may exceed one due to banking/port scheduling in descriptor SRAM ([0130]). Interpretive note: numerical pointer-write counts given anywhere in the specification are illustrative, in the same sense that the bit-mask update equations are exemplary and non-unique ([0098]-[0101]). The controlling, limiting statements are those at the start of the respective sections—[0121] (insertion) and [0122] (deletion)—which require a bounded, constant number of single-word reference writes prior to any rebalancing.

Reference Encoding—References are physical pointers, indices, or handles ([0045]). An FPGA implementation often uses index references to the descriptor array; a CPU implementation may use either pointers or indices. Conversions between encodings are strict isomorphisms that preserve the EQ-BST structure ([0125]-[0127]).

Record Allocation—Hardware allocation of new Price Level Records draws from a free-list in descriptor memory, implemented as a singly linked list of free indices, with the head cached in a control register. Returning a record pushes its index back to the list. Allocation does not touch order objects or Data Holder Nodes. In overlapped variants, the free-list uses an (index, generation) pair or an epoch/quarantine to prevent ABA reuse while readers are active.

Best-of-Book Hot Path—The OBA exposes one-cycle read ports for Best-Bid/Best-Ask registers in the accelerator clock domain. Host reads across clock domains use synchronized shadow registers. Updates to these registers are triggered by (i) insertion at a new extremum, (ii) deletion of the current extremum, or (iii) decrements that exhaust the extremum's aggregate quantity, and are handled as part of the same bounded store scripts as the structural edits (see [0075] and FIG. 8, elements 803/804).

Software/Hardware Equivalence—All accelerator behaviors are observationally equivalent to the software procedures in [0119]-[0124]: given the same sequence of price level events and neighbor hints, both embodiments produce isomorphic trees (Appendix C) with identical in-order sequences and the same top-of-book outcomes.

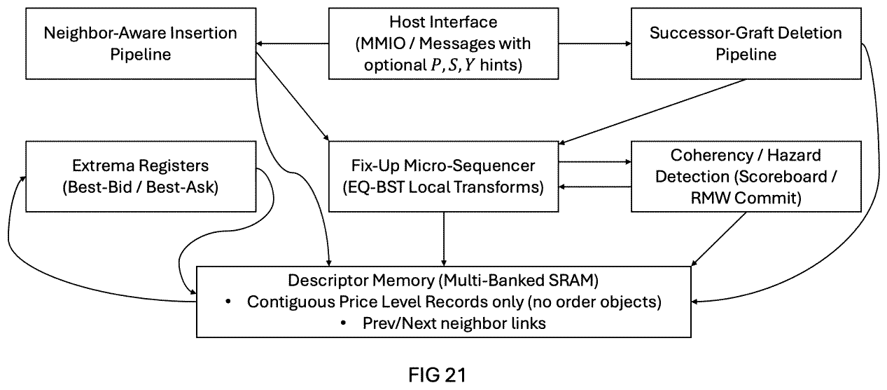

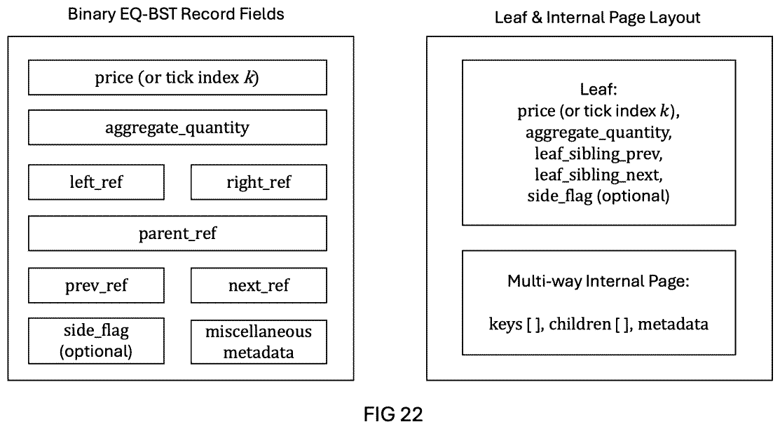

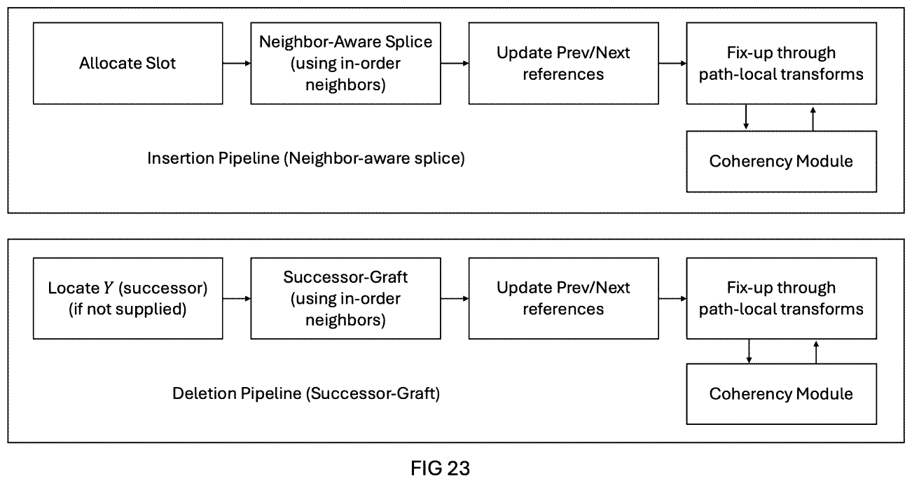

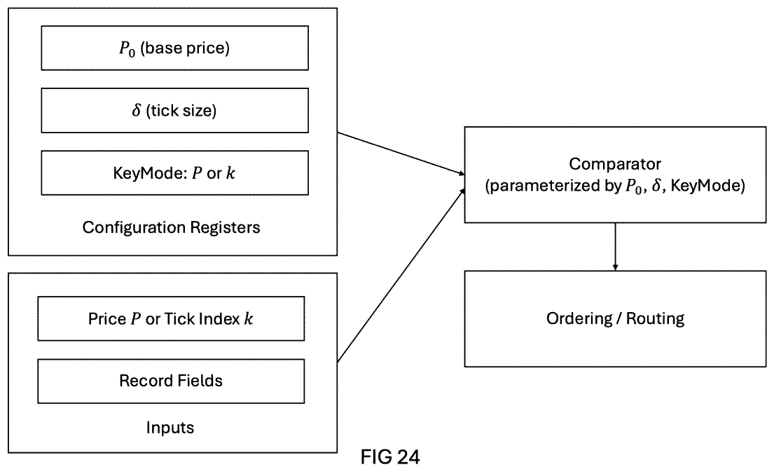

Non-Limiting Figures—Without limiting scope, FIG. 21 may depict the accelerator top-level block diagram (descriptor memory, pipelines, fix-up sequencer, coherency, host interface); FIG. 22 the Price Level Record layout; FIG. 23 the insertion/deletion pipelines; and FIG. 24 the tick-comparator and configuration registers. These figures illustrate, but do not restrict, the embodiments above.

### APPENDIX A—CLARIFYING NOTE ON THE “RANK” USAGE

### (Illustrative and Non-Limiting)

Unless stated otherwise, all vector-space operations are over [symbol] ₂ and throughout, “⊕” denotes component-wise addition in [symbol] ₂ (i.e., bitwise XOR); there is no inter-bit carry. Likewise, “∧” denotes component-wise multiplication in [symbol] ₂ (bitwise AND). References herein to the “rank” of an update mean the rank of the linear operator that either:
(a) is the linear part of the stated affine update; or
(b) agrees with the affine update on the relevant admissible subset defined in the specification.
   Mask updates in this disclosure are modeled as affine endomorphisms on V² (shifts/XOR/AND with a sparse translation vector), and non-linear XOR↔OR variants remain within scope as noted above.

Regarding the Rank Example Used in Simple Append—On states with Tₖ₋₁=1 and Tₖ=0, the affine update T [symbol] T⊕(eₖ⊕eₖ₋₁) coincides with the linear map M defined by Meₖ₋₁=eₖ and Meⱼ=eⱼ for j≠k−1. Equivalently,

$$M = I ⊕ ( ( {e}_{k} ⊕ {e}_{k - 1} ) {e}_{k - 1}^{T} ) ,$$

so M⊕I is a single outer product and therefore rank-1 over [symbol] ₂.

Regarding the Rank Example Used in General Append—The linear part acting on (H,T) is diag(Pₖ, Pₖ), where the zero-fill suffix-shift Pₖ has rank C−1 (injective on the subspace with x_{C-1}=0, per the precondition stated in that paragraph. Hence the block-diagonal linear part has rank 2 (C−1) (or C−1 if only T is tracked.). The accompanying translation term raises the newly created flags and does not affect the stated rank of the linear part. Accordingly, any use of “rank” in this specification is shorthand for “rank of the linear operator” that either:
(a) is the linear part of the stated affine update; or
(b) matches the stated affine update on the admissible subset at issue and imposes no limitation beyond the implementation-agnostic affine/Boolean formulations already provided.

### APPENDIX B—PROOF OF SAFETY AGAINST INFINITE RECURSION

### (Illustrative and Non-Limiting)

Order Book System Model—Let the order book be represented by a finite sequence of Data Holder Nodes,

$$𝒩 = {( {N}_{k} )}_{k = 0}^{D}$$

where N₀, N_{D} are the first Data Holder Node and the last Data Holder Node in the order book chain, respectively. A cascade operation is a sequence of state transitions, σ₀→σ₁→ . . . . A state σ is defined by the configuration of orders in [symbol] and the index k of the currently operative node Nₖ.

Recursion Safety on Cascades—Both Push Forward and Push Back cascade algorithms are governed by a strictly decreasing measure on a well-ordered set, which guarantees their termination. Therefore, infinite recursion is mathematically impossible regardless of any changes to Data Holder Node capacities. Here's the proof:
(a) Push Forward cascade safety—Let→_{PF} be the state transition relation for a Push Forward cascade. A transition moves the operative focus from a full node Nₖ to preceding node Nₖ₋₁. Define a ranking function ƒ_{PF} mapping the state σ to the well-ordered set ( [symbol] , <):

$${f}_{PF} ( σ ) := k$$

For any transition from a state with operative index k to one with index k−1, the rank strictly decreases (ƒ_{PF}(σ′)<ƒ_{PF}(σ)). As the rank is a natural number bounded below by 0, the relation is well-founded, and no infinite Push Forward cascade can exist.
(b) Push Back cascade safety—Let the measure of a state σ whose operative node is Nₖ be the lexicographically ordered pair:

$${f}_{PB} ( σ ) = ( c ( σ ) , d ( σ ) ) ∈ ℕ \times ℕ$$

where c(σ) is the total number of full nodes from Nₖ to the tail (inclusive), and d(σ) is the distance from Nₖ to the snapshot tail Tail₀ (the tail index captured when the cascade starts). During a transition from state σ (at index k) to σ′ (at index k+1), the primary measure c(σ) cannot increase. Because Tail₀ is fixed for the duration of the cascade, each hop strictly reduces (c,d) in lexicographic order even when the physical tail grows (e.g., the capacity-1 extend-tail case).
   (i) If c(σ′)<c(σ) (which occurs if node Nₖ becomes non-full and this change is not offset by other nodes becoming full), the pair strictly decreases.
   (ii) If c(σ′)=c(σ), the secondary measure d(σ) strictly decreases:

$$d ( {σ}^{′} ) < d ( σ ) .$$

In all cases, the pair (c(σ), d(σ)) strictly decreases with respect to the lexicographical order on [symbol] × [symbol] . Since this order is well-founded, infinite Push Back cascades are impossible.

### APPENDIX C—BALANCED-TREE FORMALISM & CATEGORY-THEORY

### (Illustrative and Non-Limiting)

Functorial Generalization to the Family of Balanced Search Trees—
(a) Category of generalized balanced search-tree: Fix an ordered triple (m, d, S) that satisfies the following constraints:
   (i) Order of the tree.
   m∈ [symbol] with m≥2. Hereunder a “node” is defined as generalized tree vertex object that conceptually includes Price Level Descriptor. A node is allowed at most m children; this constant is commonly called the order (or maximum arity) of the tree. Classical binary search trees have m=2; a B-tree of order 4 has m=4, and so on.
   (ii) Minimum degree.
   d∈ [symbol] satisfies 2≤d≤m. Every non-root internal node must maintain at least d children at all times. For example: in a textbook B-tree, d is chosen as

$$\underline{d} = ⌈ \frac{m}{2} ⌉ ;$$

more generally, an (a,b)-tree lets any pair a,b with 2≤a≤b and

$$a \leq \frac{b}{2} .$$

(iii) Key set.
S is a finite, totally ordered set with cardinality n:=|S|. The elements of S are the keys to be stored in the tree.
All subsequent constructions—objects, morphisms, height bounds, and algorithms—are parametrized by this triple (m, d, S).
(b) Objects: The class is defined as

BalST_{h,m,d}
consisting of rooted, ordered search trees T=(V, E, root) that jointly satisfy the following four invariants:
   (i) Search (range-routing) invariant.
   Every internal node stores an ordered sequence of separator keys

$$〈 {k}_{1} < … < {k}_{r} 〉 and 1 \leq r < m .$$

These keys carve up the total order into (r+1) disjoint half-open intervals. When a lookup value x arrives, the matching engine compares it with the separators and follow exactly one child pointer whose interval captures x. This is the direct generalization of the left-/right rule in a binary search tree.
(ii) Capacity invariant.
For robustness against pathological insert/delete sequences, every non-root internal node must keep its degree

$$deg ( v ) = \#children ( v )$$

within the bounds

$$\underline{d} \leq deg ( v ) \leq m .$$

If a deletion causes a node to underflow (<d children), a merge or borrow is forced; if an insertion causes overflow (>m children), the node is split. These are the same rules used in text-book B-trees.
(iii) Height bound.
Dividing the key set only d-ways at every level gives the slowest possible growth of the number of leaves, hence the tallest legal tree is constructed. Counting carefully:
   1. The root has at least two children (otherwise the tree would be height 0).
   2. Every next level multiplies the number of nodes by at least d.
Hence the number of leaves L in a height-h tree satisfies

$$2 {( {d}^{*} )}^{h - 1} \leq L \leq n ⇒ h \leq ⌈ {log}_{\underline{d}} ( \frac{n}{2} ) ⌉ = O ( {log}_{\underline{d}} n ) .$$

d is usually a fixed system constant, which gives O(log_{d} n)=O(log n). For example, with m=4 and d=2 (a 2-4 tree) gives h=O(log₂ n)=O(log n). With m=256 and d=128 (common in on-disk B-trees) the height becomes O(log₁₂₈ n), i.e. usually in 2-4 range even for millions of keys.
(iv) Leaf-policy variants.
Two standard storage policies are both accommodated:
   1. Internal-key trees (BalST^{int}) keep the full record (key+payload) in every node. (e.g., B-tree)
   2. Leaf-key trees (BalST^{leaf}) store payload only in the leaves; internal nodes carry separators only. (e.g., B+ tree)
Formally, the two policies just produce two sub-categories with the same structural constraints.

Morphisms of The Generalized Balanced Tree Category—
Let

$$T = ( V , E , root ) , {T}^{′} = ( {V}^{′} , {E}^{′} , {root}^{′} )$$

be objects of the balanced-tree category BalST_{h,m,d}. A morphism ƒ:T→T′ consists of two order-preserving maps for vertex V and key K,

$${f}_{V} : V \to {V}^{′} , {f}_{K} : K ( T ) \to K ( {T}^{′} )$$

such that:
   (a) Root preservation.

$${f}_{V} ( {root}_{T} ) = {root}_{{T}^{′}} .$$

(b) Sibling order preservation.
If the children of u are v₁, . . . , vᵣ from left to right in T, then ƒ_{V}(v₁), . . . , ƒ_{V}(vᵣ) are the children of ƒ_{V}(u) from left to right in T′.
(c) Ancestor-compatibility under local edits.
Let loc_{T}(k) be the unique node of T containing key k, and write u≤_{T} v to mean “u is an ancestor of v (reflexive) in the tree T”. The strict version is u<_{T} v (proper ancestor). With this notation, the following holds:
   ƒ_{V}(loc_{T}(k))≤_{T′} loc_{T′}(ƒ_{K}(k)) for every key k that's not deleted, where ƒ_{V}(u) is the lowest common ancestor in T′ of the post-edit locations of the keys hosted by u in T. In other words, the image key lies inside the subtree rooted at the image of its old host. This specializes to equality in rotations for binary trees and tolerates split/merge redistribution in m-ary trees.
(d) Decoration preservation.
If leaf predecessor/successor links are maintained, then ƒ_{V} respects the induced total order on leaves (order-embedding for embeddings; order-quotient for surjections).
(e) Category of balanced tree with embedding/quotient morphisms.
The identities of ƒ are (id_{V}, id_{K}). Composition is pointwise; the ancestry clause is transitive, so compatibility is preserved. Thus, with mathematical precision, the category is denoted as follows:

$${BalST}_{h , m , \underline{d}}^{emb / epi}$$

which is the category whose objects are the balanced trees and whose arrows are embedding/quotient morphisms.

### Canonical Balancing Functor of The Generalized Balanced Tree Category—

(a) Domain category.
Let FinOrd denote the category whose objects are finite totally ordered sets (S, ≤) and whose morphisms are order-preserving bijections

$$ϕ : ( S , \leq ) \to ( {S}^{′} , {\leq }^{′} ) ( i . e . , order isomorphisms ) .$$

(b) Definition of the functor.
Fix order parameters (m, d) with 2≤d≤m and a deterministic split/merge discipline [symbol] (e.g., classical B-tree rules, (a,b)-tree rules, etc.).

$${E}_{{ℬ}_{m}} : FinOrd \to {∐}_{h ∈ ℕ} {BalST}_{h , m , \underline{d}}^{emb / epi}$$

(i) On objects: For a finite totally ordered set (S, ≤), insert the elements of S in increasing order into an empty tree under [symbol] . The resulting tree is denoted [symbol] (S).
(ii) On morphisms: For an order-preserving bijection φ: (S, ≤)→(S′, ≤′), let [symbol] (φ) be the strict isomorphism whose key component is φ and whose vertex component sends a node u of [symbol] (S) to the unique node of [symbol] (S′) that hosts φ[Kᵤ] (child order and root preserved). Where Kᵤ⊆S denotes the set of distinct keys associated with node u.

$$i . e . , {K}_{u} = \{ k ∈ S \vert \text{?} {}_{( s )} ( k ) ∈ Σ ( u ) \}$$

where Σ(u)={u} in BalST^{int} and Σ(u)=leaves(subtree(u)) in BalST^{leaf} (separator copies ignored). Functoriality follows from determinism and locality of [symbol] . For the functoriality proof, see [0156].
(c) Height bound theorem (height of an (m, d)-tree).
Let
   (i) m≥2 be the order (maximum children per node);
   (ii) 2≤d≤m be the minimum degree enforced on every non-root internal node; and
   (iii) h be the common depth of all leaves (the uniform-leaf or balanced property).
Two canonical storage policies occur in practice:

| | |
|---|---|
| Variant | Where are the distinct keys stored? |
| Internal-key trees (BalSTint) | in every node-root, internal, and leaf |
| Leaf-key trees (BalSTleaf) | only in leaves; internal nodes carry separator |
| | copies only |

Let n denote the number of distinct keys in the data structure (duplicates counted once). Then, for any (S, ≤)∈FinOrd with |S|=n, the height h of [symbol] (S) satisfies
   (iv) BalST^{int},

$$h \leq ⌈ {log}_{\underline{d}} ( \frac{n + 1}{2} ) ⌉$$

(v) BalST^{leaf},

$$h \leq 1 + ⌈ {log}_{\underline{d}} ( \frac{n}{2 ( \underline{d} - 1 )} ) ⌉$$

Both inequalities simplify to h=0 (log_{d} n) when asymptotic notation is appropriate, and both are attained by trees that run at minimum legal occupancy.
(d) Proof of the (c).
   (i) Prerequisites (capacity invariants).
      1. If h=0, the root itself is a leaf; the bounds are trivial.
      2. If h≥1, the root is internal with 2≤deg(root)≤m. (Convention: we adopt the standard B/B+-tree rule that a non-leaf root has at least two children; if an implementation permits a transient one-child root after merges, we contract the top edge—promote the child to root—reducing h by 1 and restoring this convention.)
      3. Every non-root internal node v satisfies

$$\underline{d} \leq deg ( v ) \leq m .$$

Consequently, it carries

$$\#separator keys ( v ) = deg ( v ) - 1 \geq \underline{d} - 1 .$$

4. Every leaf node stores at least d−1 and at most m−1 distinct keys, whether BalST^{int} or BalST^{leaf}.
These are exactly the occupancy constraints found in any textbook description of B-trees or B+ trees.
(e) Step 1—How many nodes can there be on each level?
   (i) Depth 0.
   This is just root. If the height h≥1, the root is internal and therefore owns at least two child pointers.
   (ii) Depth 1.
   Because of the previous statement, the first level under the root has at least 2 nodes. (Under the adopted convention. With a one-child variant, the constants in the bounds below change without affecting the O(log n) result.)
   (iii) Depth i≥2.
   Every node at level i−1 is a non-root internal node and must therefore have at least d children. Thus, each level multiplies its predecessor by a factor of at least d.
Formally, a simple mathematical induction proves

$$\#nodes at depth i \geq 2 {\underline{d}}^{i - 1} , \qquad 1 \leq i \leq h .$$

Consequently, the number of leaves is at least

$${L}_{min} = 2 {\underline{d}}^{h - 1} .$$

(f) Step 2—Translate “many nodes” into “many keys”.
   (i) BalST^{int}
   Every node stores real data keys, whether it's root, deep internal, or leaf.
      1. Root: ≥1 key.
      2. Internal nodes at depths 1, . . . , h−1: each stores at least d−1 keys.
      3. Leaves: same lower bound d−1 keys.
   Then,

$$n \geq 1 + \underline{( d} - 1 ) {\sum }_{i = 1}^{h - 1} \#nodes at depth i + ( \underline{d} - 1 ) {L}_{min}$$

Substituting the level counts from Step 1,

$$n \geq 1 + ( \underline{d} - 1 ) {\sum }_{i = 1}^{h - 1} 2 {\underline{d}}^{i - 1} + ( \underline{d} - 1 ) 2 {\underline{d}}^{h - 1} = 1 + 2 ( \underline{d} - 1 ) {\sum }_{j = 0}^{h - 1} {\underline{d}}^{j} = 1 + 2 ( {\underline{d}}^{h} - 1 ) = 2 {\underline{d}}^{h} - 1 .$$

(ii) BalST^{leaf}
Now, only leaves matter; internal separator copies are not part of n.

$$n \geq ( \underline{d} - 1 ) {L}_{min} = 2 ( \underline{d} - 1 ) {\underline{d}}^{h - 1} .$$

(g) Step 3—Solving for h.
   (i) BalST^{int}

$${\underline{d}}^{h} \leq \frac{n + 1}{2} , \qquad h \leq ⌈ {log}_{\underline{d}} ( \frac{n + 1}{2} ) ⌉ .$$

(ii) BalST^{leaf}

$${\underline{d}}^{h - 1} \leq \frac{n}{2 ( \underline{d} - 1 )} , \qquad h \leq 1 + ⌈ {log}_{\underline{d}} ( \frac{n}{2 ( \underline{d} - 1 )} ) ⌉ .$$

Both derivations require a ceiling because h is integral.
(h) Discussion.
Setting every interior node to its minimum legal occupancy attains equality in the height bounds derived above. Although the internal-key and leaf-key storage policies have different leading constants, both give the same asymptotic height.

$$h = O ( {log}_{\underline{d}} n ) = O ( log n ) ,$$

because the minimum-degree d is often a fixed implementation constant. Consequently, all higher-level complexity statements—search, neighbor-aware insert/delete, range scans—remain O(log n) once h is plugged in.
   (i) A subtlety arises for m-way trees (B-trees, (a,b)-trees, etc.): during the re-balancing phase an overflow or underflow at a single node may move or copy up to m−1 keys and m child pointers. In the worst case this happens on every level touched by the update, giving a per-operation bound

$${T}_{worst} ( n ) = O ( m {log}_{\underline{d}} n ) .$$

Because the order m is chosen once at design time, typically 4-8 for cache-resident trees and 64-512 for page-oriented trees, which is constant with respect to n. Implementations therefore absorb the linear factor into the big-O notation and still quote O(log n) latency.
(ii) Moreover, a split (or merge) can occur only after Θ(m) successful inserts (or deletes) into the same node. Amortizing over those operations divides the cost by m, restoring the familiar logarithmic average:

$$\frac{O ( m {log}_{\underline{d}} n )}{m} = O ( {log}_{\underline{d}} n ) = O ( log n ) .$$

Thus, the neighbor-aware splice/graft still eliminates one root-to-leaf search, and the overall performance guarantee remains O(log n) per update—both in the strict worst-case for binary trees and in the amortized sense for fixed-order multi-way trees.

Natural Transformations of the Generalized Balanced Tree Category—Here are further concrete statements to elaborate the logic behind applying the generalized balanced tree category to the engineering claims.
(a) Standing assumption on balancing disciplines.
Throughout the matching engine fix a balancing discipline [symbol] (binary case) or [symbol] (m, d)-case such that:
   (i) Determinism.
   The sequence of rotations, color flips, splits, or merges executed during an insertion or deletion is uniquely determined by the relative order of keys seen so far; it does not depend on their numeric values.
   (ii) Locality.
   The discipline operates only on the unique root-to-leaf path that contains the affected key and on a bounded neighborhood around that path.
Every classical scheme (red-black, AVL, weigh-balanced, (a,b)-tree, B-tree, B+-tree) satisfies this assumption.
(b) Preliminaries and notation.
   (i) FinOrd: category of finite totally-ordered sets with all order-preserving bijections as morphisms.
   (ii) Superscript ‘str’ (iso-only): For any category [symbol] used herein, [symbol] ^{str} denotes the iso-only wide subgroupoid on the same objects: its morphisms are only strict structure-preserving isomorphisms. For the tree categories this means arrows preserve the root, ordered edges, sibling order, and ancestor-compatibility and are invertible; embeddings/quotients live only in [symbol] ^{emb/epi}.
   (iii) BalBST^{emb/epi} and BalST^{emb/epi}: categories of balanced search trees (binary or (m, d)) whose morphisms are embedding/quotient morphisms (root, ordered edges, sibling order preserved and ancestor-compatible). i.e.,

$${BalBST}_{h}^{str} \text{?} {BalBST}^{str} , {BalST}_{h , , m , \underline{d}}^{str} \text{?} {BalST}^{str} ,$$

BalBST^{str}→BalST^{str}, BalST^{str}→BalST^{emb/epi}, and BalBST^{emb/epi}→BalST^{emb/epi} all of which are full and faithful inclusion functors.
(iv) Forgetful functor U, “erase the edges, keep the ordered key set”

$$U : \{ \begin{matrix}{BalBST}^{emb / epi} \to FinOrd & ( on binary trees ) \\ {BalST}^{emb / epi} \to FinOrd & ( on multi - way trees )\end{matrix} .$$

(v) [symbol] (binary) or [symbol] (multi-way): “insert keys in ascending order while re-balancing under the chosen discipline. Both definitions in this context are:

$$\text{?} : FinOrd \to {BalBST}^{emb / epi} ,$$

$$\text{?} : FinOrd \to {BalST}^{emb / epi} .$$

In the following sections, the discussions are based on the multi-way case since the binary case is immediate by setting (m=2). Thus, for notational simplicity, we write [symbol] , [symbol] to mean [symbol] , [symbol] (multi-way default), and only when we specifically mean the binary restriction, we write [symbol] , [symbol] .
All subsequent functors and morphisms live in these categories.
(c) Statement 1: The canonical balancing construction is functorial.
For (S, ≤)∈FinOrd, let

[symbol]

(S):=the tree obtained by ordered insertion of the elements of S under discipline [symbol] .
Given φ:(S, ≤)→(S′, ≤′) an order-preserving bijection, construct the unique strict isomorphism

$$\text{?} ( ϕ ) := ( \text{?} {( ϕ )}_{V} , ϕ ) : \text{?} ( S ) \to \text{?} ( {S}^{′} ) ,$$

where the key component of the induced arrow is the given order-preserving bijection φ, and the vertex component [symbol] (φ)_{V} is the node map determined by where those keys land after applying φ. For each node u of [symbol] (S), let Kᵤ⊆S be the set of keys hosted at u. Then, [symbol] (φ)_{V}(u) is the unique node u′ of [symbol] (S′) that hosts the image set φ[Kᵤ]; child order and the root are preserved. i.e.,

$$\text{?} {( ϕ )}_{V} ( u ) := {\text{?}}_{( {S}^{′} )} ( \{ {\text{?}}_{( {S}^{′} )} ( ϕ ( k ) ) : k ∈ {K}_{u} \} ) .$$

By the determinism and order-equivalence of [symbol] , inserting S and inserting S′ (via φ) perform exactly the same finite edit script on isomorphic paths, thus [symbol] (S) and [symbol] (S′) are isomorphic as rooted, ordered trees. Consequently, [symbol] (φ) is a strict isomorphism and [symbol] is a functor.
(d) Proposition 1: Identity preservation.
For every (S, ≤), the following holds.

$$\text{?} ( {id}_{S} ) = {\text{?}}_{( S )} .$$

Proof.
The key component is id_{S} by definition. For the vertex component, let u be a node of [symbol] (S) and Kᵤ⊆S the set of keys it hosts (for leaf-key variants, Kᵤ is the set of leaf keys under u). Then,

$$\begin{matrix}\text{?} {( id )}_{V} ( u ) = {\text{?}}_{( S )} ( \{ loc ( id ( k ) ) : k ∈ {K}_{u} \} ) \\ = {\text{?}}_{( S )} ( \{ loc ( k ) : k ∈ {K}_{u} \} ) \\ = u ,\end{matrix}$$

since u is the lowest common ancestor containing all those locations. Hence the vertex map is id, proving the claim.
(e) Proposition 2: Composition preservation.
For φ₁:S→S′ and φ₂:S′→S″, the following holds.

$$\text{?} ( {ϕ}_{2} ∘ {ϕ}_{1} ) = \text{?} ( {ϕ}_{2} ) ∘ \text{?} ( {ϕ}_{1} ) .$$

Proof.
Write T= [symbol] (S), T′= [symbol] (S′), T″= [symbol] (S″). For the key component,

$${( \text{?} ( {ϕ}_{2} ) ∘ \text{?} ( {ϕ}_{1} ) )}_{K} = \text{?} {( {ϕ}_{2} )}_{K} ∘ \text{?} {( {ϕ}_{1} )}_{K} = {ϕ}_{2} ∘ {ϕ}_{1} = \text{?} {( {ϕ}_{2} ∘ {ϕ}_{1} )}_{K} .$$

While the vertex component is:
For a node u∈T with hosted-key set Kᵤ⊆S,

$$\begin{matrix}{( \text{?} ( {ϕ}_{2} ) ∘ \text{?} ( {ϕ}_{1} ) )}_{V} ( u ) = \text{?} {( {ϕ}_{2} )}_{V} ( \text{?} {( {ϕ}_{1} )}_{V} ( u ) ) \\ = {LCA}_{{T}^{′′}} ( \{ {loc}_{{T}^{′′}} ( {ϕ}_{2} ( {k}^{′} ) ) : {k}^{′} ∈ {ϕ}_{1} [ {K}_{u} ] \} ) \\ = {LCA}_{{T}^{′′}} ( \{ {loc}_{{T}^{′′}} ( {ϕ}_{2} ( {ϕ}_{1} ( k ) ) ) : k ∈ {K}_{u} \} ) \\ = \text{?} {( {ϕ}_{2} ∘ {ϕ}_{1} )}_{V} ( u )\end{matrix}$$

Thus, the vertex components agree pointwise, establishing equality of arrows.
(f) Statement 2: In-order traversal is a natural isomorphism.
Let F:=U∘ [symbol] : FinOrd→FinOrd.
The following lemma holds. (Component-wise identities)
   (i) Lemma 1: For every (S, ≤), the in-order traversal

$${η}_{S} : S \to F ( S ) = U ( \text{?} ( S ) ) ,$$

is the identity map on the underlying set (η_{S}(x)=x).
Proof: Under a comparison-based, deterministic discipline, inserting S in increasing order yields a tree whose in-order walk enumerates the keys in strictly increasing order with no duplication. Forgetting edges (U) leaves the same totally ordered set S. Hence, η_{S} is the identity bijection on the underlying set.
(ii) Lemma 2: For every order-preserving bijection φ:S→S′ in FinOrd,

$$F ( ϕ ) ∘ {η}_{S} = {η}_{{S}^{′}} ∘ ϕ .$$

Proof.
By the definition of [symbol] on arrows, the key component of [symbol] (φ) is φ; therefore,

$$F ( ϕ ) = U ( \text{?} ( ϕ ) ) = {( \text{?} ( ϕ ) )}_{K} = ϕ .$$

Thus, F(φ)∘η_{S}=φ∘id_{S}=φ and η_{S′}∘φ=id_{S′}∘φ=φ, proving commutativity. This concludes that each η_{S} is a bijection.
(g) Natural isomorphism theorem.
Let F:=U∘ [symbol] :FinOrd→FinOrd. The family η={η_{S}} with components:

$${η}_{S} : S \to F ( S ) = U ( \text{?} ( S ) ) , {η}_{S} ( x ) = x ,$$

is a natural isomorphism

$$η : {Id}_{FinOrd} ⟹ F .$$

Proof.
For any order-preserving bijection φ:S→S′ consider the square

$${η}_{S} = \begin{matrix}S & ϕ & {S}^{′} \\ {id}_{S} ↓ & \to & ↓ {η}_{{S}^{′}} \\ F ( S ) & \begin{matrix}F ( ϕ ) \\ \to \end{matrix} & F ( {S}^{′} )\end{matrix} = {id}_{{S}^{′}}$$

Since F(φ)=U( [symbol] (φ))=( [symbol] (φ))_{K}=φ, both routes equal to φ; the square commutes. Each η_{S} is the identity bijection on the totally ordered set, hence η is a natural isomorphism.
(h) Neighbor-aware insert/delete as natural transformations.
The following discussion is based on the multi-way category BalST^{emb/epi}, the binary case is immediate by setting m=2. The following endofunctors are defined:
For a fixed key p,
   (i) Insertₚ acts on objects by splicing p using the provided neighbor pointers, followed by rebalancing under [symbol] along a single root-to-leaf path under the chosen discipline; on arrows ƒ=(ƒ_{V}, ƒ_{K}), mirror the finite edit script on the image path and act as ƒ off-path.
   (ii) Deleteₚ is defined as a dual construction when p∈K(T) (successor-graft with path-local fix-up); if p∉K(T), set Deleteₚ(T)=T and Deleteₚ(ƒ)=ƒ.
Determinism and locality assumption ensures these definitions are well-posed and preserve identities and composition; hence both operations endofunctors on BalST^{emb/epi}.
Define components:

$${ι}_{T} : T \to {Insert}_{p} ( T ) ,$$

by the identity on surviving keys and the minimal-ancestor node map (as defined earlier). Then, ι_{T}:Id⇒Insertₚ is a mono natural transformation, with naturality

$${Insert}_{p} ( f ) ∘ {ι}_{T} = {ι}_{{T}^{′}} ∘ f .$$

Similarly, the deletion embedding

$${δ}_{T} : {Delete}_{p} ( T ) \to T$$

is a mono (identity on surviving keys; minimal-ancestor node map) with naturality:

$${δ}_{{T}^{′}} ∘ {Delete}_{p} ( f ) = f ∘ {δ}_{T} .$$

Additionally, the deletion quotient

$${π}_{T} : T \text{?} {Delete}_{p} ( T )$$

is an epi (drops p; local child-list surjection around the edit) with naturality:

$${Delete}_{p} ( f ) ∘ {π}_{T} = {π}_{{T}^{′}} ∘ f .$$

(i) Proposition 3: Naturality of insertion inclusion.
In BalST^{emb/epi}, for every morphism ƒ=(ƒ_{V}, ƒ_{K}):T→T′,

$${Insert}_{p} ( f ) ∘ {ι}_{T} = {ι}_{{T}^{′}} ∘ f ( an arrow T ⟶ {Insert}_{p} ( {T}^{′} ) ) .$$

Proof.
For the keys: Since ι_{K,T} is the identity on existing keys and Insertₚ(ƒ)_{K}=ƒ_{K} on those keys,

$${( {Insert}_{p} ( f ) ∘ {ι}_{T} )}_{K} = {f}_{K} = {( {ι}_{{T}^{′}} ∘ f )}_{K} .$$

For the vertices: For each node u∈V(T) with hosted-key set H_{T}(u)≠Ø,

$$\begin{matrix}( {{Insert}_{p} ( f )}_{V} ∘ {ι}_{V , T} ) ( u ) = {LCA}_{{Insert}_{p} ( {T}^{′} )} \{ {loc}_{{Insert}_{p} ( {T}^{′} )} ( {f}_{K} ( k ) ) : k ∈ {H}_{T} ( u ) \} \\ = ( {ι}_{V , {T}^{′}} ∘ {f}_{V} ) ( u )\end{matrix} ,$$

because both routes take the LCA in the same post-insert tree of the same set of key locations. Hence the arrows agree component-wise.
Remark.
This subsumes the strict-isomorphism case as a special instance (then the induced arrow is itself an isomorphism). The proof does not depend on traversal direction; it only uses locality and determinism of the balancing discipline.
(j) Corollary: In BalST^{emb/epi}, the insertion inclusions and deletion embeddings,

$$ι : Id ⟹ {Insert}_{p} and δ : {Delete}_{p} ⟹ Id$$

are natural transformations, with naturality, for every ƒ:T→T′,

$${Insert}_{p} ( f ) ∘ {ι}_{T} = {ι}_{{T}^{′}} ∘ f , {δ}_{{T}^{′}} ∘ {Delete}_{p} ( f ) = f ∘ {δ}_{T} .$$

(k) Successor-graft via deletion naturality.
Let Deleteₚ act on objects by the usual successor-graft+path-local fix-up when p∈K(T), and as the identity when p∉K(T). On arrows ƒ=(ƒ_{V}, ƒ_{K}):T→T′, define the following

$${{Delete}_{p} ( f )}_{K} := {f}_{K} restriected to K ( T ) \backslash \{ p \} ,$$

and let Deleteₚ(ƒ)_{V} be the lowest common ancestor (LCA) map induced by that key map: for each node u⁻ of Deleteₚ(T) with hosted-key set H_{T}_{^{−}}(u⁻)≠Ø,

Deleteₚ(ƒ)_{V}(u⁻):=LCA_{Delete}_{_{p′}}_{(T′)}({loc_{Delete}_{_{p′}}_{(T′)}(ƒ_{K}(k)):k∈H_{T}_{^{−}}(u⁻)}),
where p′:=ƒ_{K}(p) when p∈K(T) (otherwise p′ is irrelevant). This is well-posed by determinism with locality (the edit stays on a single corridor) and yields a morphism Deleteₚ(ƒ): Deleteₚ(T)→Delete_{p′}(T′).
(l) Proposition 4: Functorial successor-graft, in base category form.
For every ƒ:T→T′ and deletable p∈K(T) with p′:=ƒ_{K}(p),

$${δ}_{{T}^{′}} ∘ {Delete}_{p} ( f ) = f ∘ {δ}_{T} .$$

Proof.
Off the edited corridor, Deleteₚ(ƒ) agrees with ƒ. On the corridor, both routes take each node to the lowest common ancestor of the same set of post-delete key locations, so the vertex components match; the key components match by construction (restriction of ƒ_{K}). Thus, the square commutes.

### Consequences for the Engineering Claims.

(a) Representation-independence.
Algorithmic correctness and the O(1)+O(log n) complexity bound holds for any concrete layout that realizes an object of BalST^{emb/epi}. Pure layout changes (pointer schemes, memory layouts) are strict isomorphisms inside this category and therefore translate one implementation to another without touching the proofs.
(b) Plug-replace balancing.
Switching from red-black to, say, (a,b)-trees swaps the canonical balancing functor [symbol] , for [symbol] . Because the balancing discipline is deterministic and local, all insertion/deletion naturality diagrams remain intact under this swap.
(c) Coherence under optimization passes.
Compiler or run-time rewrites that apply strict tree isomorphisms (e.g., cache-oblivious layouts, key/child relabelings) do not invalidate neighbor-aware splice/graft logic: the insertion inclusions ι: Id⇒Insertₚ, and the deletion embeddings δ: Deleteₚ⇒Id are natural, hence edits commute with these representation changes.

### FINAL REMARK

With the assumption on the balancing disciplines surfaced and every diagram now proved explicitly, the categorical layer is fully operative rather than decorative: it certifies that the matching-engine algorithms commute with all structure-preserving changes of representation, which is precisely the abstraction benefit that motivated its inclusion.

1. An order book price level apparatus comprising processing circuitry and contiguous storage, the contiguous storage providing a plurality of fixed-size addressable positions for storing price level records, each price level record storing at least a price and an aggregate quantity for a price level, and the processing circuitry configured to:
(a) represent the price level records as entries in a balanced search tree keyed by price, the records addressable by references into the contiguous storage, whereby the price level records are maintained in price-sorted order;
(b) locate a price level record by price via comparison-guided descent from a root of the balanced search tree;
(c) maintain in-order neighbor links among the price level records, implemented as predecessor and successor references in record-per-node trees or as leaf-sibling links in page-based multi-way trees, whereby each entry's in-order neighbors are identifiable from the stored links;
(d) perform at least one neighbor-aware update operation, the neighbor-aware update operation comprising at least one of:
(i) a neighbor-aware insertion by splicing a new price level record at a parent location determined from one or both in-order neighbor links, using a bounded number of reference writes, independent of the number of price levels stored in the tree, the new price level record becomes an entry in the balanced search tree, and then rebalancing along a single root-to-leaf path via local transforms, each local transform touching a constant number of entries;
(ii) a neighbor-aware deletion by replacing a designated entry with an in-order neighbor identified via a stored in-order neighbor link of the designated entry, using a bounded number of reference writes, independent of the number of price levels stored in the tree, the designated entry is removed from the balanced search tree, and then rebalancing along a single root-to-leaf path via local transforms, each local transform touching a constant number of entries;
wherein the rebalancing restores a balance invariant of the balanced search tree.

2. The apparatus of claim 1, wherein the balanced search tree is an embedding/quotient-morphism balanced search tree that preserves in-order key sequence and performs rebalancing via constant-size local transforms (EQ-BST).

3. The apparatus of claim 1, wherein the balanced search tree comprises one of: a red-black tree, an AVL tree, a weight-balanced tree, a treap, an (a,b)-tree, a B-tree, or a B+-tree encoded over the references of the price level records in the contiguous storage.

4. The apparatus of claim 1, wherein, in a record-per-node balanced search tree, each price level record further stores left-child, right-child, and parent references into the contiguous storage, and the processing circuitry updates said references in coordination with updates to the predecessor and successor references during the neighbor-aware insertion or the neighbor-aware deletion.

5. The apparatus of claim 1, wherein the contiguous storage is cache-line aligned and each price level record is a fixed-size structure occupying an integral number of machine words.

6. The apparatus of claim 1, further comprising extrema references designating a best-ask entry and a best-bid entry, enabling constant-time retrieval of top-of-book price level records.

7. The apparatus of claim 1, wherein the contiguous storage is realized as multi-banked memory with interleaved addressing on a record index, each price level record occupying an integral number of memory words across the banks, such that dependent fields of a single price level record are fetchable in parallel when they map to distinct banks.

8. The apparatus of claim 1, wherein the price is mapped to a tick index by an offset function from a base price and tick size, and the tick index is stored in the price level record.

9. The apparatus of claim 1, wherein updating the aggregate quantity is performed by a single machine-word store or an atomic compare-and-swap operation.

10. The apparatus of claim 1, wherein the in-order neighbor links are maintained as references within the price level records and supplied to the neighbor-aware insertion or the neighbor-aware deletion, such that the processing circuitry splices or grafts without descending the tree.

11. The apparatus of claim 1, wherein the processing circuitry inserts a new price level record into the balanced search tree only upon receiving a first order at a previously empty price level, and removes a price level record only upon cancellation or execution of a last order at that price level, whereby the balanced search tree contains only price levels at which at least one order is pending.

12. The apparatus of claim 1, wherein each said reference write is performed by a single machine-word store or by a single atomic compare-and-swap operation.

13. The apparatus of claim 1, wherein the local transforms of the rebalancing comprise:
(a) in a record-per-node tree, rotations and at least one of recolorings or height adjustments; or
(b) in a page-based multi-way tree, at least one of page splits, page merges, or key redistributions among sibling pages;
wherein the rebalancing restores a balance invariant of the balanced search tree upon completion.

14. The apparatus of claim 1, further comprising an auxiliary hash map keyed by price, wherein the processing circuitry performs constant-time existence checks via the hash map before accessing the balanced search tree.

15. The apparatus of claim 1, wherein the operations of the processing circuitry recited in (a)-(d) are implemented as one of:
(a) software executed by one or more processors; or
(b) software executed by one or more processors together with configurable hardware logic configured to execute at least a portion of said operations.

16. An order book accelerator circuit comprising:
(a) descriptor memory providing a plurality of fixed-size addressable positions for storing price level records, each record storing at least a price and an aggregate quantity;
(b) tree logic to represent the price level records as entries in a balanced search tree keyed by price, the records addressed by references into the descriptor memory, whereby the price level records are maintained in price-sorted order;
(c) comparison logic to locate a price level record by price via comparison-guided descent from a root of the balanced search tree;
(d) neighbor-link registers that, for each node or leaf record, hold predecessor and successor references or leaf-sibling links, whereby each entry's in-order neighbors are identifiable from the stored links;
(e) at least one of:
(i) an insertion pipeline configured to splice a new price level record at a parent location determined from one or both in-order neighbor links, using a bounded number of reference writes, independent of the number of price levels stored in the tree, the new price level record becomes an entry in the balanced search tree, and then rebalancing along a single root-to-leaf path via local transforms, each local transform touching a constant number of entries;
(ii) a deletion pipeline configured to replace a designated entry with an in-order neighbor identified via a stored in-order neighbor link of the designated entry, using a bounded number of reference writes, independent of the number of price levels stored in the tree, the designated entry is removed from the balanced search tree, and then rebalancing along a single root-to-leaf path via local transforms, each local transform touching a constant number of entries;
wherein the rebalancing restores a balance invariant of the balanced search tree.

17. The accelerator circuit of claim 16, wherein the tree logic implements an embedding/quotient-morphism balanced search tree with constant-size local transforms that preserve in-order sequence.

18. The accelerator circuit of claim 16, further comprising extrema registers storing best-ask and best-bid references.

19. The accelerator circuit of claim 16, wherein the descriptor memory is multi-banked and burst- or cache-line aligned to provide single-cycle or few-cycle fetches of price level records and their references to the insertion pipeline or the deletion pipeline.

20. The accelerator circuit of claim 16, further comprising a coherency module to perform read-modify-write updates of child, parent, predecessor, and successor references with hazard detection for concurrent tree operations.

21. The accelerator circuit of claim 16, further comprising a host interface to receive price level update messages and to emit top-of-book or depth snapshots computed solely from the price level records.

22. The accelerator circuit of claim 16, wherein, when the accelerator circuit comprises the insertion pipeline, comparators in the insertion pipeline are parameterized by tick size and base price.

23. The accelerator circuit of claim 16, wherein the accelerator circuit is implemented in reconfigurable logic or application-specific logic.

24. A computer-implemented method of maintaining price level metadata for an electronic order book, the method comprising:
(a) providing a plurality of fixed-size addressable positions in contiguous storage for storing price level records, each record storing at least a price and an aggregate quantity;
(b) representing the price level records as entries in a balanced search tree keyed by price using references into the contiguous storage, whereby the price level records are maintained in price-sorted order;
(c) locating a price level record by price via comparison-guided descent from a root of the balanced search tree;
(d) maintaining in-order neighbor links among the records, implemented as predecessor and successor references in record-per-node trees or as leaf-sibling links in page-based multi-way trees, whereby each entry's in-order neighbors are identifiable from the stored links;
(e) performing at least one neighbor-aware update operation, the neighbor-aware update operation comprising at least one of:
(i) a neighbor-aware insertion by splicing a new price level record at a parent location determined from one or both in-order neighbor links, using a bounded number of reference writes, independent of the number of price levels stored in the tree, the new price level record becomes an entry in the balanced search tree, and then rebalancing along a single root-to-leaf path via local transforms, each local transform touching a constant number of entries;
(ii) a neighbor-aware deletion by replacing a designated entry with an in-order neighbor identified via a stored in-order neighbor link of the designated entry, using a bounded number of reference writes, independent of the number of price levels stored in the tree, the designated entry is removed from the balanced search tree, and then rebalancing along a single root-to-leaf path via local transforms, each local transform touching a constant number of entries;
wherein the rebalancing restores a balance invariant of the balanced search tree.

25. The method of claim 24, wherein the balanced search tree is an embedding/quotient-morphism balanced search tree with constant-size local transforms that preserve in-order sequence.

26. The method of claim 24, further comprising maintaining best-ask and best-bid references for constant-time retrieval.

27. The method of claim 24, further comprising coalescing updates to an existing price level by adjusting the aggregate quantity of a corresponding price level record.

28. A non-transitory machine-readable medium comprising machine-executable instructions which, when loaded into target circuitry, configure the target circuitry to:
(a) provide a plurality of fixed-size addressable positions in contiguous storage for storing price level records, each record storing at least a price and an aggregate quantity;
(b) represent the price level records as entries of a balanced search tree keyed by price using references into the contiguous storage, whereby the price level records are maintained in price-sorted order;
(c) locate a price level record by price via comparison-guided descent from a root of the balanced search tree;
(d) maintain in-order neighbor links among the entries, implemented as predecessor and successor references in record-per-node trees or as leaf-sibling links in page-based multi-way trees, whereby each entry's in-order neighbors are identifiable from the stored links;
(e) perform at least one neighbor-aware update operation selected from:
(i) a neighbor-aware insertion by splicing a new price level record at a parent location determined from one or both in-order neighbor links, using a bounded number of reference writes, independent of the number of price levels stored in the tree, the new price level record becomes an entry in the balanced search tree, and then rebalancing along a single root-to-leaf path via local transforms, each local transform touching a constant number of entries;
(ii) a neighbor-aware deletion by replacing a designated entry with an in-order neighbor identified via a stored in-order neighbor link of the designated entry, using a bounded number of reference writes, independent of the number of price levels stored in the tree, the designated entry is removed from the balanced search tree, and then rebalancing along a single root-to-leaf path via local transforms, each local transform touching a constant number of entries;
wherein the rebalancing restores a balance invariant of the balanced search tree.

29. The medium of claim 28, wherein the machine-executable instructions further configure the target circuitry to implement the contiguous storage with multi-banked organization and interleaved addressing on a record index, such that dependent fields of a single price level record are fetchable in parallel when they map to distinct banks.

30. The medium of claim 28, wherein each said reference write is performed by a single machine-word store or by a single atomic compare-and-swap operation.
